(19) United States
(12) Patent Application Publication
(10) Pub. No.: US 2023/0261252 A1
(43) Pub. Date: Aug. 17, 2023

(54) INORGANIC SOLID ELECTROLYTE-CONTAINING COMPOSITION, SHEET FOR ALL-SOLID STATE SECONDARY BATTERY, AND ALL-SOLID STATE SECONDARY BATTERY, AND MANUFACTURING METHODS FOR SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Koji YASUDA, Kanagawa (JP); Shota Ol, Kanagawa (JP); Yo Kushida, Kanagawa (JP)

(73) Assignee: FUJIFILM Corporation, Tokyo (JP)

(21) Appl. No.: 18/304,318

(22) Filed: Apr. 20, 2023

Related U.S. Application Data
(63) Continuation of application No. PCT/JP2021/047666, filed on Dec. 22, 2021.

(30) Foreign Application Priority Data
Feb. 25, 2020 (JP) 2020-217232
Feb. 5, 2021 (JP) 2021-017430
Nov. 15, 2021 (JP) 2021-185885

(51) Int. Cl. H01M 10/056

(52) U.S. Cl. CPC H01M 10/056; H01M 2300/0091

(57) ABSTRACT

There is provided an inorganic solid electrolyte-containing composition containing an inorganic solid electrolyte, a polymer binder, and a dispersion medium, in which the polymer binder includes a polymer having a tensile permanent strain of less than 50% in a stress-strain curve obtained by repeating pulling and restoration once and includes a polymer binder in which the adsorption rate with respect to the inorganic solid electrolyte in the dispersion medium is less than 60%. There are also provided a sheet for an all-solid state secondary battery and an all-solid state secondary battery, in which this inorganic solid electrolyte-containing composition is used, and manufacturing methods for a sheet for an all-solid state secondary battery, and an all-solid state secondary battery.

### CROSS-REFERENCE TO RELATED APPLICATIONS

This application is a Continuation of PCT International Application No. PCT/JP2021/047666 filed on Dec. 22, 2021, which claims priority under 35 U.S.C. § 119 (a) to Japanese Patent Application No. 2020-217232 filed in Japan on Dec. 25, 2020, Japanese Patent Application No. 2021-017430 filed in Japan on Feb. 5, 2021, and Japanese Patent Application No. 2021-185885 filed in Japan on Nov. 15, 2021. Each of the above applications is hereby expressly incorporated by reference, in its entirety, into the present application.

### BACKGROUND OF THE INVENTION

### 1. Field of the Invention

The present invention relates to an inorganic solid electrolyte-containing composition, a sheet for an all-solid state secondary battery, and an all-solid state secondary battery, and manufacturing methods for a sheet for an all-solid state secondary battery and an all-solid state secondary battery.

### 2. Description of the Related Art

In an all-solid state secondary battery, all of a negative electrode, an electrolyte, and a positive electrode consist of solid, and the all-solid state secondary battery can greatly improve safety and reliability, which are said to be problems to be solved in a secondary battery in which an organic electrolytic solution is used. It is also said to be capable of extending the battery life. Furthermore, an all-solid state secondary battery can be provided with a structure in which the electrode and the electrolyte are directly disposed in series. As a result, it is possible to increase the energy density to be high as compared with a secondary battery in which an organic electrolytic solution is used, and thus the application to electric vehicles, large-sized storage batteries, and the like is anticipated.

In such an all-solid state secondary battery, examples of substances that form constitutional layers (a solid electrolyte layer, a negative electrode active material layer, a positive electrode active material layer, and the like) include an inorganic solid electrolyte and an active material. In recent years, this inorganic solid electrolyte, particularly an oxide-based inorganic solid electrolyte or a sulfide-based inorganic solid electrolyte has attracted attention as an electrolyte material having a high ion conductivity comparable to that of the organic electrolytic solution.

As the material that forms a constitutional layer (a constitutional layer forming material) of an all-solid state secondary battery, a material containing the above-described inorganic solid electrolyte and the like has been proposed. For example, WO2017/030154A discloses a solid electrolyte composition containing a block polymer and an inorganic solid electrolyte having an ion conductivity of a metal belonging to Group 1 or Group 2 of the periodic table, where the block polymer contains at least one kind of block consisting of a repeating unit having at least one kind of functional group having affinity to an electrode active material or an inorganic solid electrolyte. In addition, JP5617725B discloses a slurry that contains a block copolymer having a segment A containing a structural unit of a vinyl monomer having an acid component, a segment B containing a structural unit of a (meth)acrylic acid alkyl ester monomer, and a segment C containing a structural unit of a vinyl monomer having a glass transition temperature of 80° C. or higher, the block copolymer being such that a content proportion of the segment C is 20% to 50% by mass, and contains an electrode active material.

### SUMMARY OF THE INVENTION

Constitutional layers of an all-solid state secondary battery are formed of solid particles (an inorganic solid electrolyte, an active material, a conductive auxiliary agent, and the like), and thus the interfacial contact state between solid particles is restricted, interface resistance tends to increase (ion conductivity tends to decrease), and a sufficient adhesive force between solid particles cannot be obtained. This increase in interface resistance (increase in battery resistance) causes not only a decrease in ion conductivity but also a deterioration in cycle characteristics. In addition, since the adhesive force between the solid particles is not sufficient, the cycle characteristics further deteriorate.

The increase in resistance, which causes a decrease in battery performance, is due to not only the interfacial contact state between solid particles but also the non-uniform presence (the arrangement) of solid particles in the constitutional layer, as well as the surface flatness of the constitutional layer. As a result, in a case where a constitutional layer is formed of a constitutional layer forming material, the constitutional layer forming material is required to have not only the dispersibility of the solid particles immediately after preparation but also characteristics (dispersion stability) that stably maintains the dispersibility of the solid particles immediately after preparation, and characteristics (handleability) that makes it possible to form a good coating film having a suitable viscosity and thus having good fluidity.

However, WO2017/030154A and JP5617725B have not carried out examinations based on such a viewpoint. Moreover, in recent years, research and development for improving the performance and the practical application of electric vehicles have progressed rapidly, and the demand for battery performance (for example, conductivity and cycle characteristics) required for an all-solid state secondary battery has become higher.

An object of the present invention is to provide an inorganic solid electrolyte-containing composition excellent in dispersion stability and handleability, where the inorganic solid electrolyte-containing composition is capable of realizing the suppression of the further increase in battery resistance and the excellent cycle characteristics in a case of being used as a constitutional layer forming material of an all-solid state secondary battery. In addition, another object of the present invention is to provide a sheet for an all-solid state secondary battery and an all-solid state secondary battery, and manufacturing methods for a sheet for an all-solid state secondary battery and an all-solid state secondary battery, in which the above inorganic solid electrolyte-containing composition is used.

As a result of repeated studies focusing on a polymer binder that is used in combination with solid particles such as an inorganic solid electrolyte and a dispersion medium, the inventors of the present invention found that in a case where a polymer binder that exhibits a low adsorption rate of less than 60% with respect to the inorganic solid electrolyte in a dispersion medium is formed by containing a polymer having a tensile permanent strain of less than 50% in a stress-strain curve obtained by repeating pulling and restoration once, it is possible to firmly adhere the solid particles to each other while ensuring a sufficient interfacial contact state between the solid particles, while maintaining excellent dispersion stability and excellent handleability of the composition in the constitutional layer. As a result, it was found that by using this inorganic solid electrolyte-containing composition as a constitutional layer forming material, it is possible to form a constitutional layer in which solid particles are firmly bound to each other, while suppressing the increase in interface resistance between solid particles, and it is possible to manufacture an all-solid state secondary battery that is capable of realizing the suppression of the increase in battery resistance and the excellent cycle characteristics.

The present invention has been completed through further studies based on these findings.

That is, the above problems have been solved by the following means.

<1> An inorganic solid electrolyte-containing composition comprising:

an inorganic solid electrolyte having an ion conductivity of a metal belonging to Group 1 or Group 2 in the periodic table;

a polymer binder PB; and

a dispersion medium,

in which the polymer binder PB includes a polymer P1 having a tensile permanent strain of less than 50% in a stress-strain curve obtained by repeating pulling and restoration once and includes a polymer binder PB1 having an adsorption rate of less than 60% with respect to the inorganic solid electrolyte in the dispersion medium.

<2> The inorganic solid electrolyte-containing composition according to <1>, in which the tensile permanent strain is 25% or less.

<3> The inorganic solid electrolyte-containing composition according to <1> or <2>, in which the polymer P1 has a breaking elongation of 400% or more.

<4> The inorganic solid electrolyte-containing composition according to any one of <1> to <3>, in which the polymer P1 contains a constitutional component having a functional group selected from the following group (a) of functional groups,

<the group (a) of functional groups>

a hydroxy group, an amino group, a carboxy group, a sulfo group, a phosphate group, a phosphonate group, a sulfanyl group, an ether bond, an imino group, an ester bond, an amide bond, a urethane bond, a thiocarbamate bond, a urea bond, a thiourea bond, a heterocyclic group, an aryl group, a carboxylic acid anhydride group, a fluoroalkyl group, a siloxane group, a carbonate bond, and a ketone bond.

<5> The inorganic solid electrolyte-containing composition according to <4>, in which a content of the constitutional component in the polymer P1 is 0.1% to 20% by mass.

<6> The inorganic solid electrolyte-containing composition according to any one of <1> to <5>, in which the polymer P1 is a block polymer.

<7> The inorganic solid electrolyte-containing composition according to any one of <1> to <6>, in which the polymer P1 contains a constitutional component derived from a (meth)acrylic acid ester compound.

<8> The inorganic solid electrolyte-containing composition according to any one of <1> to <7>, in which the polymer P1 is a block polymer having at least a segment A containing a constitutional component derived from a vinyl compound or (meth)acrylic acid ester compound having a glass transition temperature of 50° C. or higher and a segment B containing a constitutional component derived from a (meth)acrylic acid ester compound having a glass transition temperature of 15° C. or lower.

<9> The inorganic solid electrolyte-containing composition according to any one of <1> to <8>, in which the polymer binder PB further includes a chain polymerization polymer binder PB3 consisting of a (meth)acrylic polymer.

<10> The inorganic solid electrolyte-containing composition according to any one of <1> to <9>, further comprising an active material.

<11> The inorganic solid electrolyte-containing composition according to any one of <1> to <10>, further comprising a conductive auxiliary agent.

<12> The inorganic solid electrolyte-containing composition according to any one of <1> to <11>, in which the inorganic solid electrolyte is a sulfide-based inorganic solid electrolyte.

<13> A sheet for an all-solid state secondary battery, comprising a layer formed of the inorganic solid electrolyte-containing composition according to any one of <1> to <12>.

<14> An all-solid state secondary battery comprising, in the following order:

a positive electrode active material layer;

a solid electrolyte layer; and

a negative electrode active material layer,

in which at least one layer of the positive electrode active material layer, the solid electrolyte layer, or the negative electrode active material layer is a layer formed of the inorganic solid electrolyte-containing composition according to any one of <1> to <12>.

<15> A manufacturing method for a sheet for an all-solid state secondary battery, the manufacturing method comprising forming a film of the inorganic solid electrolyte-containing composition according to any one of <1> to <12>.

<16> A manufacturing method for an all-solid state secondary battery, the manufacturing method comprising manufacturing an all-solid state secondary battery through the manufacturing method according to <15>.

According to the present invention, it is possible to provide an inorganic solid electrolyte-containing composition excellent in dispersion stability and handleability, where the inorganic solid electrolyte-containing composition is capable of realizing the suppression of the further increase in battery resistance and the excellent cycle characteristics in a case of being used as a constitutional layer forming material of an all-solid state secondary battery. In addition, according to the present invention, it is possible to provide a sheet for an all-solid state secondary battery and an all-solid state secondary battery, which have a layer formed of the above inorganic solid electrolyte-containing composition. Further, according to the present invention, it is possible to provide manufacturing methods for a sheet for an all-solid state secondary battery and an all-solid state secondary battery, in which the above inorganic solid electrolyte-containing composition is used.

The above-described and other characteristics and advantages of the present invention will be further clarified by the following description with appropriate reference to the accompanying drawing.

### BRIEF DESCRIPTION OF THE DRAWINGS

FIG. 1 is a vertical cross-sectional view schematically illustrating an all-solid state secondary battery according to a preferred embodiment of the present invention.

FIG. 2 is a vertical cross-sectional view schematically illustrating a coin-type all-solid state secondary battery prepared in Examples.

FIG. 3 is a view showing an example of a stress-strain curve obtained in a measurement of a tensile permanent strain.

### DESCRIPTION OF THE PREFERRED EMBODIMENTS

In the present invention, a numerical value range indicated using “to” means a range including numerical values before and after the “to” as the lower limit value and the upper limit value. In a case where a plurality of numerical value ranges are set and described for the content, physical properties, and the like of a component in the present invention, the upper limit value and the lower limit value, which form each of the numerical value ranges, are not limited to a specific combination described before and after “to” as a specific numerical value range and can be set to a numerical value range obtained by appropriately combining the upper limit value and the lower limit value of each numerical value range.

In the present invention, the expression of a compound (for example, in a case where a compound is represented by an expression in which “compound” is attached to the end) refers to not only the compound itself but also a salt or an ion thereof. In addition, this expression also refers to a derivative obtained by modifying a part of the compound, for example, by introducing a substituent into the compound within a range where the effect of the present invention is not impaired.

In the present invention, (meth)acryl means one or both of acryl and methacryl. The same applies to (meth)acrylate.

In the present invention, a substituent, a linking group, or the like (hereinafter, referred to as a substituent or the like), which is not specified regarding whether to be substituted or unsubstituted, may have an appropriate substituent. Accordingly, even in a case where a YYY group is simply described in the present invention, this YYY group includes not only an aspect not having a substituent but also an aspect having a substituent. The same shall be applied to a compound that is not specified regarding whether to be substituted or unsubstituted. Examples of the preferred substituent include a substituent Z described later.

In the present invention, in a case where a plurality of substituents or the like represented by a specific reference numeral are present or a plurality of substituents or the like are simultaneously or alternatively defined, the respective substituents or the like may be the same or different from each other. In addition, unless specified otherwise, in a case where a plurality of substituents or the like are adjacent to each other, the substituents may be linked or fused to each other to constitute (form) a ring.

In the present invention, the polymer means a polymer; however, it has the same meaning as a so-called polymeric compound. Further, a polymer binder (also simply referred to as a binder) means a binder composed of a polymer and includes a polymer itself and a binder formed by containing a polymer.

[Inorganic Solid Electrolyte-Containing Composition]

The inorganic solid electrolyte-containing composition according to the embodiment of the present invention contains an inorganic solid electrolyte having an ion conductivity of a metal belonging to Group 1 or Group 2 in the periodic table; a polymer binder PB; and a dispersion medium.

As will be described later, the polymer binder PB contains one or two or more low adsorption binders PB1 that exhibit an adsorption rate of less than 60% with respect to the inorganic solid electrolyte in the dispersion medium contained in the inorganic solid electrolyte-containing composition. It suffices that this low adsorption binder PB1 is present in the inorganic solid electrolyte-containing composition (in the dispersion medium), and the existence state thereof or the like is not particularly limited. For example, the low adsorption binder PB1 may not adsorb to the inorganic solid electrolyte in the inorganic solid electrolyte-containing composition; however, it is preferable to have a function of adsorbing to solid particles and dispersing the solid particles in the dispersion medium.

In the inorganic solid electrolyte-containing composition, the low adsorption binder PB1 may have or may not have a function of causing solid particles to bind to each other. However, at least in a layer formed of an inorganic solid electrolyte-containing composition, the low adsorption binder PB1 has a function (functions as a binding agent) of causing solid particles of the inorganic solid electrolyte (as well as a co-existable active material, conductive auxiliary agent, and the like) or the like to bind to each other (for example, between solid particles of the inorganic solid electrolyte, between solid particles of the inorganic solid electrolyte and the active material, or between solid particles of the active material). Further, it may function as a binding agent that binds a collector to solid particles.

The inorganic solid electrolyte-containing composition according to the embodiment of the present invention is preferably a slurry in which the inorganic solid electrolyte is dispersed in a dispersion medium.

The inorganic solid electrolyte-containing composition according to the embodiment of the present invention is excellent in dispersion stability and handleability. In a case where this inorganic solid electrolyte-containing composition is used as a constitutional layer forming material, it is possible to realize a sheet for an all-solid state secondary battery, which has a low-resistance constitutional layer in which solid particles firmly bound, and furthermore, an all-solid state secondary battery that has low resistance and excellent cycle characteristics as well. In addition, in the aspect in which the active material layer formed on the collector is formed of the inorganic solid electrolyte-containing composition according to the embodiment of the present invention, it is also possible to realize firm adhesiveness between the collector and the active material layer and thus it is possible to achieve a further improvement of the cycle characteristics.

Although the details of the reason for the above are not yet clear, they are conceived to be as follows. That is, it is conceived that the low adsorption binder PB1 that exhibits an adsorption rate of less than 60% with respect to an inorganic solid electrolyte does not excessively adsorb to an inorganic solid electrolyte in the inorganic solid electrolyte-containing composition and can suppress the reaggregation, sedimentation, or the like of the inorganic solid electrolyte not only immediately after the preparation of the inorganic solid electrolyte-containing composition but also even after a lapse of time. As a result, a high degree of dispersibility immediately after preparation can be stably maintained (dispersion stability is excellent), and an excessive increase in viscosity can also be suppressed, whereby good fluidity is exhibited (handleability is excellent).

In a case of forming a constitutional layer using the inorganic solid electrolyte-containing composition according to the embodiment of the present invention, which exhibits such excellent dispersion stability and fluidity, the direct contact between the solid particles in the constitutional layer can be achieved, which makes it possible to construct a sufficient conduction path. On the other hand, even at the time of forming a film of the inorganic solid electrolyte-containing composition (for example, at the time of applying the inorganic solid electrolyte-containing composition and at the time of drying), it is possible to suppress the aggregation, sedimentation, and the like of solid particles and make the arrangement of the solid particles in the constitutional layer uniform. Moreover, the inorganic solid electrolyte-containing composition becomes to have proper fluidity (leveling) at the time of forming a film of the inorganic solid electrolyte-containing composition, particularly at the time of coating, and thus the surface roughness of unevenness due to insufficient fluidity or excessive fluidity as well as the surface roughness or the like due to clogging in the ejection unit at the time of coating does not occur, whereby the constitutional layer has a good surface property (the surface property of the coated surface is excellent). As a result, it is possible to suppress an increase in the interface resistance between the solid particles as well as the resistance of the constitutional layer. Moreover, since the low adsorption binder PB1 contains a polymer having a tensile permanent strain of less than 50%, as will be described later, it is possible to cause solid particles to bind to each other, in the constitutional layer, with a binding force sufficiently firm against external stresses such as vibration and bending as well as expansion and contraction of the constitutional layer due to charging and discharging.

In this way, the inorganic solid electrolyte-containing composition according to the embodiment of the present invention makes it possible to form a low-resistance constitutional layer to which solid particles are firmly bound. In addition, in an all-solid state secondary battery including such a constitutional layer, a firm binding state of the solid particles is conceived to be maintained even after repeating charging and discharging since an overcurrent is difficult to be generated at the time of charging and discharging, and the deterioration of the solid particles can be prevented. Therefore, it is possible to realize an all-solid state secondary battery that has excellent cycle characteristics and exhibits high conductivity (ion conductivity, electron conductivity, or the like) without causing a significant decrease in battery characteristics even after repeating charging and discharging.

In a case of forming an active material layer on a collector using the inorganic solid electrolyte-containing composition according to the embodiment of the present invention, which exhibits excellent dispersion stability and excellent handleability, it is possible to realize firm adhesion between the collector and the active material. Therefore, the all-solid state secondary battery in which the active material layer is formed on the collector with the inorganic solid electrolyte-containing composition according to the embodiment of the present invention also reinforces the adhesiveness between the collector and the active material, and thus it is possible to achieve the further improvement of the cycle characteristics and the conductivity.

The inorganic solid electrolyte-containing composition according to the embodiment of the present invention is preferably used as a material (a constitutional layer forming material) for forming a solid electrolyte layer or an active material layer, where the material is for a sheet for an all-solid state secondary battery (including an electrode sheet for an all-solid state secondary battery) or an all-solid state secondary battery. In particular, it can be preferably used as a material for forming a negative electrode sheet for an all-solid state secondary battery or a material for forming a negative electrode active material layer, which contains a negative electrode active material having a large expansion and contraction due to charging and discharging, and high cycle characteristics and high conductivity can be achieved in this aspect as well.

The inorganic solid electrolyte-containing composition according to the embodiment of the present invention is preferably a non-aqueous composition. In the present invention, the non-aqueous composition includes not only an aspect including no watery moisture but also an aspect where the moisture content (also referred to as the “watery moisture content”) is preferably 500 ppm or less. In the non-aqueous composition, the moisture content is more preferably 200 ppm or less, still more preferably 100 ppm or less, and particularly preferably 50 ppm or less. In a case where the inorganic solid electrolyte-containing composition is a non-aqueous composition, it is possible to suppress the deterioration of the inorganic solid electrolyte. The water content refers to the water amount (the mass proportion to the inorganic solid electrolyte-containing composition) in the inorganic solid electrolyte-containing composition, and specifically, it is a value determined by filtration through a 0.02 μm membrane filter and then by Karl Fischer titration.

The inorganic solid electrolyte-containing composition according to the embodiment of the present invention includes an aspect including not only an inorganic solid electrolyte but also an active material, as well as a conductive auxiliary agent or the like (the composition in this aspect is referred to as the “electrode composition”).

Hereinafter, components that are contained and components that can be contained in the inorganic solid electrolyte-containing composition according to the embodiment of the present invention will be described.

<Inorganic Solid Electrolyte>

The inorganic solid electrolyte-containing composition according to the embodiment of the present invention contains an inorganic solid electrolyte.

In the present invention, the inorganic solid electrolyte is an inorganic solid electrolyte, and the solid electrolyte refers to a solid-form electrolyte capable of migrating ions therein. The inorganic solid electrolyte is clearly distinguished from the organic solid electrolyte (the polymeric electrolyte such as polyethylene oxide (PEO) or the organic electrolyte salt such as lithium bis(trifluoromethanesulfonyl)imide (LiTFSI)) since it does not include any organic substance as a principal ion-conductive material. In addition, the inorganic solid electrolyte is solid in a steady state and thus, typically, is not dissociated or liberated into cations and anions. Due to this fact, the inorganic solid electrolyte is also clearly distinguished from inorganic electrolyte salts of which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has an ion conductivity of a metal belonging to Group 1 or Group 2 in the periodic table and generally does not have electron conductivity. In a case where the all-solid state secondary battery according to the embodiment of the present invention is a lithium ion battery, the inorganic solid electrolyte preferably has a lithium ion conductivity.

As the inorganic solid electrolyte, a solid electrolyte material that is typically used for an all-solid state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based inorganic solid electrolyte. The sulfide-based inorganic solid electrolytes are preferably used from the viewpoint that it is possible to form a more favorable interface between the active material and the inorganic solid electrolyte.

(i) Sulfide-based inorganic solid electrolyte The sulfide-based inorganic solid electrolyte is preferably an electrolyte that contains a sulfur atom, has an ion conductivity of a metal belonging to Group 1 or Group 2 in the periodic table, and has electron-insulating properties. The sulfide-based inorganic solid electrolytes are preferably inorganic solid electrolytes which contain, as elements, at least Li, S, and P and have a lithium ion conductivity, but the sulfide-based inorganic solid electrolytes may also include elements other than Li, S, and P depending on the purposes or cases.

Examples of the sulfide-based inorganic solid electrolyte include a lithium ion-conductive inorganic solid electrolyte satisfying the composition represented by Formula (S1).

Lₐ₁M_{b1}P_{c1}S_{d1}Aₑ₁ (S1)

In the formula, L represents an element selected from Li, Na, or K and is preferably Li. M represents an element selected from B, Zn, Sn, Si, Cu, Ga, Sb, Al, or Ge. A represents an element selected from I, Br, Cl, or F. a1 to e1 represent the compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios between the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two or more raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio of Li₂S to P₂S₅ in Li—P—S-based glass and Li—P—S-based glass ceramic is preferably 60:40 to 90:10 and more preferably 68:32 to 78:22 in terms of the molar ratio, Li₂S:P₂S₅. In a case where the ratio between Li₂S and P₂S₅ is set in the above-described range, it is possible to increase a lithium ion conductivity. Specifically, the lithium ion conductivity can be preferably set to 1×10⁻⁴ S/cm or more and more preferably set to 1×10³ S/cm or more. The upper limit is not particularly limited but practically 1×10¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, and Li₁₀GeP₂S₁₂. The mixing ratio between the individual raw materials does not matter. Examples of the method of synthesizing a sulfide-based inorganic solid electrolyte material using the above-described raw material compositions include an amorphization method. Examples of the amorphization method include a mechanical milling method, a solution method, and a melting quenching method. This is because treatments at a normal temperature are possible, and it is possible to simplify manufacturing steps.

(ii) Oxide-Based Inorganic Solid Electrolyte

The oxide-based inorganic solid electrolyte is preferably an electrolyte that contains an oxygen atom, has an ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit is not particularly limited; however, it is practically 1×10⁻¹ S/cm or less.

Specific examples of the compound include LiₓₐLa_{ya}TiO₃ (LLT) [xa satisfies 0.3≤xa≤0.7, and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn. xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{xx}_{zc}O_{nc} (M^{cc} is one or more elements selected from C, S, Al, Si, Ga, Ge, In, and Sn. xc satisfies 0<xc≤5, yc satisfies 0<yc≤1, zc satisfies 0<zc≤1, and nc satisfies 0<nc≤6); Li_{xd}(Al, Ga)_{yd}(Ti, Ge)_{zd}Si_{ad}P_{md}O_{nd} (xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13.); Li₍₃₋₂ₓₑ₎M^{ee}ₓₑD^{ee}O (xe represents a number 0 or more and 0.1 or less, and M^{ee} represents a divalent metal atom. D^{ee} represents a halogen atom or a combination of two or more halogen atoms); Li_{xf}Si_{yf}O_{Zf} (xf satisfies 1≤xf≤5, yf satisfies 0<yf≤3, zf satisfies 1≤zf≤10); Li_{xg}S_{yg}O_{zg} (xg satisfies 1≤xg≤3, yg satisfies 0<yg≤2, zg satisfies 1≤zg≤10); Li₃BO₃; Li₃BO₃—Li₂SO₄; Li₂O—B₂O₃—P₂O₅; Li₂O—SiO₂; Li₆BaLa₂Ta₂O₁₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yh}(Al, Ga)ₓₕ(Ti, Ge)₂₋ₓₕSi_{yh}P_{3-yh}O₁₂ (xh satisfies 0≤xh≤1, and yh satisfies 0≤yh≤1); and Li₇La₃Zr₂O₁₂ (LLZ) having a garnet-type crystal structure.

In addition, a phosphorus compound containing Li, P, or O is also desirable. Examples thereof include lithium phosphate (Li₃PO₄); LiPON in which a part of oxygen atoms in lithium phosphate are substituted with a nitrogen element; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Further, it is also possible to preferably use LiA¹ON (A¹ is one or more elements selected from Si, B, Ge, Al, C, and Ga).

(iii) Halide-Based Inorganic Solid Electrolyte

The halide-based inorganic solid electrolyte is preferably a compound that contains a halogen atom, has an ion conductivity of a metal belonging to Group 1 or Group 2 in the periodic table, and has electron-insulating properties.

The halide-based inorganic solid electrolyte is not particularly limited; however, examples thereof include LiCl, LiBr, LiI, and compounds such as Li₃YBr₆ or Li₃YCl₆ described in ADVANCED MATERIALS, 2018, 30, 1803075. In particular, Li₃YBr₆ or Li₃YCl₆ is preferable.

(iv) Hydride-Based Inorganic Solid Electrolyte

The hydride-based inorganic solid electrolyte is preferably a compound that contains a hydrogen atom, has an ion conductivity of a metal belonging to Group 1 or Group 2 in the periodic table, and has electron-insulating properties.

The hydride-based inorganic solid electrolyte is not particularly limited; however, examples thereof include LiBH₄, Li₄(BH₄)₃I, and 3LiBH₄—LiCl.

The inorganic solid electrolyte is preferably particulate. In this case, the particle diameter (the volume average particle diameter) of the inorganic solid electrolyte is not particularly limited; however, it is preferably 0.01 μm or more and more preferably 0.1 μm or more. The upper limit is preferably 100 μm or less and more preferably 50 μm or less.

The particle diameter of the inorganic solid electrolyte is measured according to the following procedure. Using water (heptane in a case where the inorganic solid electrolyte is unstable in water), the inorganic solid electrolyte particles are diluted in a 20 mL sample bottle to prepare 1% by mass of a dispersion liquid. The diluted dispersion liquid sample is irradiated with 1 kHz ultrasonic waves for 10 minutes and is then immediately used for testing. Data collection is carried out 50 times using this dispersion liquid sample, a laser diffraction/scattering-type particle size distribution analyzer LA-920 (product name, manufactured by Horiba Ltd.), and a quartz cell for measurement at a temperature of 25° C. to obtain the volume average particle diameter. Other detailed conditions and the like can be found in Japanese Industrial Standards (JIS) Z8828: 2013 “Particle Diameter Analysis-Dynamic Light Scattering” as necessary. Five samples per level are prepared and measured, and the average values thereof are employed.

One kind of inorganic solid electrolyte may be contained, or two or more kinds thereof may be contained.

The content of the inorganic solid electrolyte in the inorganic solid electrolyte-containing composition is not particularly limited. However, in terms of the binding property as well as in terms of dispersibility, it is preferably 50% by mass or more, more preferably 70% by mass or more, and still more preferably 90% by mass or more, in 100% by mass of the solid content. From the same viewpoint, the upper limit thereof is preferably 99.9% by mass or less, more preferably 99.5% by mass or less, and particularly preferably 99% by mass or less.

However, in a case where the inorganic solid electrolyte-containing composition contains an active material described later, regarding the content of the inorganic solid electrolyte in the inorganic solid electrolyte-containing composition, the total content of the active material and the inorganic solid electrolyte is preferably in the above-described range.

In the present invention, the solid content (solid component) refers to components that neither volatilize nor evaporate and disappear in a case where the inorganic solid electrolyte-containing composition is subjected to drying treatment at 150° C. for 6 hours in a nitrogen atmosphere at a pressure of 1 mmHg. Typically, the solid content refers to a component other than a dispersion medium described later.

<Polymer Binder PB>

The inorganic solid electrolyte-containing composition according to the embodiment of the present invention contains the polymer binder PB. The polymer binder PB contained in the inorganic solid electrolyte-containing composition according to the embodiment of the present invention contains a polymer P1 described later in which the tensile permanent strain is less than 50% and contains one or two or more polymer binders (low adsorption binders) PB1 in which the adsorption rate with respect to the inorganic solid electrolyte in the composition is less than 60%.

In addition, the polymer binder PB contained in the inorganic solid electrolyte-containing composition may contain one or two or more polymer binders other than the low adsorption binder PB1. The polymer binder other than the low adsorption binder PB1 is not particularly limited as long as it is a polymer binder that does not satisfy at least one of the tensile permanent strain of the polymer or the adsorption rate of the binder, and examples thereof include a particulate binder (preferably particulate binder in which the adsorption rate with respect to the inorganic solid electrolyte in the composition is 60% or more) PB2 described later, a chain polymerization polymer binder PB3, and a high adsorption binder in which the adsorption rate with respect to the inorganic solid electrolyte in the composition is 60% or more. The tensile permanent strain of the polymer constituting the particulate binder PB2, the chain polymerization polymer binder PB3, the high adsorption binder, or the like is not particularly limited; however, it is preferable to be not measurable or 50% or more.

(Low Adsorption Binder PB1)

The adsorption rate exhibited by the low adsorption binder PB1 is a value measured by using the inorganic solid electrolyte and the dispersion medium contained in the inorganic solid electrolyte-containing composition, and it is an indicator that indicates the degree of adsorption of a binder to an inorganic solid electrolyte in the dispersion medium. Here, the adsorption of the binder to the inorganic solid electrolyte includes not only physical adsorption but also chemical adsorption (adsorption by chemical bond formation, adsorption by transfer of electrons, or the like).

In a case where the inorganic solid electrolyte-containing composition contains a plurality of kinds of inorganic solid electrolytes, the adsorption rate is defined as an adsorption rate with respect to the inorganic solid electrolyte having the same composition (kind and content) as the composition of the inorganic solid electrolyte in the inorganic solid electrolyte-containing composition. Similarly, in a case where the inorganic solid electrolyte-containing composition contains a plurality of kinds of dispersion media, the adsorption rate is measured by using a dispersion medium having the same composition (the kind and the content) as the dispersion media in the inorganic solid electrolyte-containing composition. In addition, in a case where a plurality of kinds of low adsorption binders PB1 are used, the adsorption rate of the plurality of kinds of low adsorption binders PB1 is defined similarly as in the case of the inorganic solid electrolyte-containing composition or the like.

In the present invention, the adsorption rate of the low adsorption binder PB1 is a value calculated according to the method described in Examples.

In the present invention, the adsorption rate with respect to the inorganic solid electrolyte is appropriately set depending on the kind (the structure and the composition of the polymer chain) of polymer P1 that forms the low adsorption binder PB1, the kind or content of the functional group selected from the group (a) of functional groups described later, the form of the low adsorption binder PB1 (the amount dissolved in the dispersion medium).

The adsorption rate of the polymer binder other than the low adsorption binder PB1 shall be also a value calculated according to the same method as that of the low adsorption binder PB1.

The adsorption rate of the low adsorption binder PB1 is less than 60%. In a case where the low adsorption binder PB1 exhibits the above-described adsorption rate, excessive adsorption to the inorganic solid electrolyte is suppressed, and thus it is possible to increase the dispersion stability and handleability (also referred to as dispersion characteristics) of the inorganic solid electrolyte-containing composition. The adsorption rate is preferably 40% or less, more preferably 30% or less, still more preferably 20% or less, and particularly preferably 10% or less, in that dispersion characteristics can be achieved at a higher level. On the other hand, the lower limit of the adsorption rate is not particularly limited and may be 0%. The lower limit of the adsorption rate is preferably small from the viewpoint of dispersion characteristics; however, on the other hand, it is preferably 0.1% or more and more preferably 1% or more from the viewpoint of improving the binding property of the inorganic solid electrolyte.

In a case where the inorganic solid electrolyte-containing composition according to the embodiment of the present invention contains an active material described later, the adsorption rate of the low adsorption binder PB1 to the active material is not particularly limited.

Examples of the preferred characteristics of the low adsorption binder PB1 include a characteristic (solubility) of being dissolved in a dispersion medium contained in the inorganic solid electrolyte-containing composition. It is preferable that the low adsorption binder PB1 in the inorganic solid electrolyte-containing composition generally is present in a state of being dissolved in a dispersion medium in the inorganic solid electrolyte-containing composition, which depends on the content thereof. This makes it possible for the low adsorption binder PB1 to stably exhibit a function of dispersing solid particles in a dispersion medium and enhance the dispersion characteristics of the inorganic solid electrolyte-containing composition.

In the present invention, the description that a low adsorption binder PB1 is dissolved in a dispersion medium in an inorganic solid electrolyte-containing composition is not limited to an aspect in which the entire low adsorption binder PB1 is dissolved in the dispersion medium, and for example, a part of the low adsorption binder PB1 may be present in an insoluble form in the inorganic solid electrolyte-containing composition as long as the following solubility in a dispersion medium is 50% or more.

The measuring method for solubility is as follows. That is, 0.1 g of the low adsorption binder as a measurement target is precisely weighed, and the precisely weighed mass is defined as W0. Next, the precisely weighed low adsorption binder and 10 g of a dispersion medium are put into a container and mixed with a mix rotor (model number: VMR-5, manufactured by AS ONE Corporation) at 25° C. and 100 rpm for 48 hours. Then, the insoluble substances are filtered from the solution, the obtained solid is subjected to vacuum drying at 120° C. for 3 hours, and the mass W1 of the insoluble substances is precisely weighed. From the precisely weighed W0 and W1, the solubility (%) in the dispersion medium is calculated according to the following expression.

Solubility (%)=(W0−W1)/W0×100

In a case where the low adsorption binder PB1 has a particle shape (in a case where it does not exhibit solubility in the dispersion medium contained in the inorganic solid electrolyte-containing composition), the shape thereof is not particularly limited and may be a flat shape, an amorphous shape, or the like; however, a spherical shape or a granular shape is preferable. In this case, in the inorganic solid electrolyte-containing composition, the average particle diameter of the particle-shaped low adsorption binder is not particularly limited; however, it is preferably 1 nm or more, more preferably 10 nm or more, and still more preferably 30 nm or more. The upper limit value thereof is preferably 5 μm or less and more preferably 1 μm or less. The average particle diameter of the low adsorption binder can be measured using the same method as that of the particle diameter of the inorganic solid electrolyte. The average particle diameter of the low adsorption binder can be adjusted, for example, by the kind of dispersion medium, the composition of the binder forming polymer, and the like.

—Polymer P1 Contained in Low Adsorption Binder PB1—

The low adsorption binder PB1 is formed by containing the polymer P1 in which the tensile permanent strain described below is less than 50%. The polymer (which is also referred to as a binder forming polymer and forms the low adsorption binder PB1) P1 contained in the low adsorption binder PB1 is the polymer P1 that imparts the above-described adsorption rate with respect to the inorganic solid electrolyte to the low adsorption binder PB1 and has a tensile permanent strain of less than 50% in a stress-strain curve obtained by repeating pulling and restoration once. In a case where the polymer P1 having a tensile permanent strain of less than 50% is contained in the polymer binder PB1, as described above, it is possible to firmly adhere (bind) the solid particles to each other in a state where a sufficient conduction path is constructed and form a firm constitutional layer with high conductivity (low resistance) while maintaining the effect of improving the excellent dispersion stability and handleability of the low adsorption binder PB1.

From the viewpoint of maintaining dispersion stability and handleability and further improving conductivity and adhesiveness, the tensile permanent strain of the binder forming polymer P1 is preferably 40% or less, more preferably 25% or less, still more preferably 20% or less, and particularly preferably 15% or less. On the other hand, the lower limit of the tensile permanent strain is not particularly limited; however, it is preferably as small as possible, and it is practically 0%.

The tensile permanent strain of the binder forming polymer P1 is a value calculated from a stress-strain curve, where the stress-strain curve is created by subjecting a test piece formed of the binder forming polymer to each of pulling to a predetermined elongation and restoration, and specifically, it shall be a value measured (calculated) according to the method described in Examples.

In the present invention, the tensile permanent strain can be appropriately set depending on the kind (the structure and composition of the polymer chain) of the binder forming polymer P1 or the bonding mode of the main chain, the glass transition temperature of the binder forming polymer P1, the molecular weight distribution, the stereoregularity, and the like. As for a preferred adjustment method therefor, the tensile permanent strain can be reduced in a case where a block polymer is used as the binder forming polymer P1 and the content of the block having a high glass transition temperature is reduced, and in a case where the molecular weight distribution of the block polymer is narrowed.

The tensile permanent strain of the polymer that forms a polymer binder other than the low adsorption binder PB1 shall be also a value calculated according to the same method as that of the binder forming polymer P1.

The binder forming polymer P1 may be any polymer as long as it exhibits a tensile permanent strain in the above-described range, and other physical properties or characteristics are not particularly limited.

In the present invention, the binder forming polymer P1 preferably has a breaking elongation of 100% or more. In a case where the low adsorption binder PB1 contains the binder forming polymer P1 exhibiting breaking elongation of 100% or more, a firm binding force is maintained against the external stress as well as the expansion and contraction of the constitutional layer due to charging and discharging, whereby adhesiveness (binding property) can be further improved. From the viewpoint that the adhesiveness can be further improved while maintaining dispersion stability, handleability, and conductivity, the breaking elongation of the binder forming polymer P1 is preferably 200% or more, more preferably 400% or more, still more preferably 600% or more. On the other hand, the upper limit of breaking elongation is not particularly limited and is practically 5,000%, and from the viewpoint of maintaining dispersion stability and handleability, it can be set to 3,000% or less, where it is preferably 2,000% or less and more preferably 1,000% or less. The breaking elongation is a value measured (calculated) according to the method described in Example.

In the present invention, the breaking elongation can be appropriately set depending on the kind (the structure and composition of the polymer chain) of the binder forming polymer P1 or the bonding mode of the main chain, the glass transition temperature of the binder forming polymer P1, the molecular weight distribution, the stereoregularity, and the like.

The mass average molecular weight of the binder forming polymer P1 is also not particularly limited and is appropriately set in consideration of the above-described tensile permanent strain. The mass average molecular weight of the binder forming polymer is, for example, preferably 15,000 or more, more preferably 30,000 or more, still more preferably 50,000 or more. The upper limit thereof is practically 5,000,000 or less, preferably 4,000,000 or less, more preferably 3,000,000 or less, still more preferably 1,000,000 or less, and particularly preferably 500,000 or less.

—Measurement of Molecular Weight—

In the present invention, unless specified otherwise, the molecular weight of the polymer (polymer chain) refers to a mass average molecular weight in terms of standard polystyrene conversion according to gel permeation chromatography (GPC). The measuring method thereof includes, basically, a method under Conditions 1 or Conditions 2 (preferential) described below. However, depending on the kind of polymer a suitable eluant may be appropriately selected and used.

(Conditions 1)
Column: Connect two TOSOH TSKgel Super AWM-H (product name, manufactured by Tosoh Corporation)
Carrier: 10 mM LiBr/N-methylpyrrolidone
Measurement temperature: 40° C.
Carrier flow rate: 1.0 ml/min
Sample concentration: 0.1% by mass
Detector: refractive index (RI) detector

(Condition 2)
Column: A column obtained by connecting TOSOH TSKgel Super HZM-H, TOSOH TSKgel Super HZ4000, and TOSOH TSKgel Super HZ2000 (all of which are product names, manufactured by Tosoh Corporation)
Carrier: tetrahydrofuran
Measurement temperature: 40° C.
Carrier flow rate: 1.0 ml/min
Sample concentration: 0.1% by mass
Detector: refractive index (RI) detector

The binder forming polymer P1 may be a non-crosslinked polymer or may be a crosslinked polymer. In addition, in a case where the crosslinking of the polymer progresses due to heating or voltage application, the molecular weight may be higher than the above-described molecular weight. It is preferable that the mass average molecular weight of the binder forming polymer falls within the above-described range at the start of use of an all-solid state secondary battery.

The watery moisture concentration of the binder forming polymer P1 (the low adsorption binder PB1) is preferably 100 ppm (mass basis) or less. Further, as this low adsorption binder, a binder forming polymer may be crystallized and dried, or a dispersion liquid of a binder forming polymer may be used as it is.

The kind, composition, and the like of the binder forming polymer P1 are not particularly limited as long as the above-described tensile permanent strain is satisfied, and various kinds of polymers as polymers for a binder of an all-solid state secondary battery can be appropriately used by taking into consideration of the adsorption rate or the like of the low adsorption binder PB1.

The binder forming polymer P1 is not particularly limited in the bonding mode (arrangement) of the constitutional components that constitute the main chain thereof, regardless of the polymer species, and it may be any one of a random polymer, an alternating polymer, a block polymer, a graft polymer, or the like. A block polymer is preferable from the viewpoint that a tensile permanent strain in the above-described range is easily exhibited.

In the present invention, a main chain of the polymer refers to a linear molecular chain in which all the molecular chains that constitute the polymer other than the main chain can be conceived as a branched chain or a pendant group with respect to the main chain. Although it depends on the mass average molecular weight of the branched chain regarded as a branched chain or pendant group, the longest chain among the molecular chains that constitute the polymer is typically the main chain. In this case, a terminal group at the polymer terminal is not included in the main chain. In addition, side chains of the polymer refer to branched chains other than the main chain and include a short chain and a long chain. The terminal group of the polymer is not particularly limited, and an appropriate group can be adopted according to a polymerization method or the like. Examples thereof include a hydrogen atom, an alkyl group, an aryl group, a hydroxy group, and a residue of a polymerization initiator.

The number of blocks (segments) that forms a block polymer is not particularly limited as long as it is 2 or more, and it can be set to 2 to 5, where it is preferably 2 or 3.

In a case of assuming that blocks that form a block polymer are denoted by A, B, and C, which are different from each other, examples of the block polymer include an AB type (a polymer in which one block A and one block B are bonded to form one polymer chain (main chain)), an ABA type (a polymer in which two blocks A are bonded to both ends of one block B to form one polymer chain (main chain)), and an ABC type (a polymer in which one block A, one block B, and one block C are bonded in this order to form one polymer chain (main chain)). Among them, an AB type or an ABA type is preferable, and an ABA type is more preferable, from the viewpoint of the tensile permanent strain.

In the present invention, each of the blocks A, B, and C may be a block consisting of one kind of constitutional component or may be a block having two or more kinds of constitutional components. In a case where two or more kinds of the constitutional components are contained, the bonding mode (arrangement) of each of the constitutional components is not particularly limited and may be any one of random bonding, alternating bonding, block bonding, or the like, where random bonding is preferable. The content of each of the constitutional components in the block having two or more constitutional components is appropriately set, for example, depending on the glass transition temperature that is preferably desired for each block.

In the present invention, appropriate blocks can be employed as the blocks A, B, and C, and for example, in a case of focusing on the glass transition temperature, the block A is preferably a block that exhibits a glass transition temperature higher than that of the block B from the viewpoint that the tensile permanent strain can be easily set in the above-described range. In addition, in a case of focusing on the constitutional components constituting the block, all of them are block such as a block containing a constitutional component having a specific functional group, a block containing a constitutional component derived from a (meth)acrylic acid ester compound (preferably a compound having no specific functional group), and a block containing a constitutional component derived from a vinyl compound (preferably a compound having no specific functional group), which will be described later. Among the above, in terms of the effect of improving the adhesiveness of the solid particles, the block A is preferably a block containing a constitutional component derived from a vinyl compound or a (meth)acrylic acid ester compound, which has no specific functional group, or a block containing a constitutional component derived from a vinyl compound or (meth)acrylic acid ester compound having a glass transition temperature of 50° C. or higher, and it is more preferably a block containing a constitutional component derived from a vinyl compound or (meth)acrylic acid ester compound having no specific functional group and having a glass transition temperature of 50° C. or higher. In terms of the effect of improving the adhesiveness of the solid particles, the block B is preferably a block having a constitutional component having a functional group or a block containing a constitutional component derived from a vinyl compound or a (meth)acrylic acid ester compound (each of which is preferably a compound having no specific functional group), more preferably a block containing a constitutional component having a functional group or a block containing a constitutional component derived from a (meth)acrylic acid ester compound having a glass transition temperature of 15° C. or lower, and still more preferably a block containing a constitutional component having a functional group and a constitutional component derived from a (meth)acrylic acid ester compound having a glass transition temperature of 15° C. or lower. The combination of the block A and the block B is not particularly limited; however, a combination between the above-described preferred blocks is preferable from the viewpoint that the tensile permanent strain within the above-described range is exhibited and thus the effect of improving the adhesiveness of the solid particles are excellent.

Examples of the block C include other blocks that correspond to neither the block A nor the block B, which include, for example, a block that contains a constitutional component derived from a compound having a glass transition temperature of more than 15° C. and less than 50° C. and does not contain a constitutional component derived from a vinyl compound or (meth)acrylic acid ester compound having a glass transition temperature of 50° C. or higher and a constitutional component derived from a (meth)acrylic acid ester compound having a glass transition temperature of 15° C. or lower.

The glass transition temperature of the block A is not particularly limited. However, it is preferably higher than that of the block B as described above. For example, in terms of the tensile permanent strain, it is preferably 30° C. or higher, more preferably 50° C. or higher, still more preferably 70° C. or higher, and particularly preferably 100° C. or higher, and it can also be set to 120° C. or higher. The upper limit of the glass transition temperature is practically 300° C., and it can be set to, for example, 200° C., where it is preferably 150° C. or lower. In addition, the mass average molecular weight of the block A is not particularly limited and can be appropriately set.

The glass transition temperature of the block B is not particularly limited; however, it can be set to, for example, 25° C. or lower in terms of the tensile permanent strain, where it is preferably 15° C. or lower, more preferably 0° C. or lower, still more preferably −20° C. or lower, and particularly preferably −40° C. or lower. It is practical that the lower limit of the glass transition temperature is −150° C. It can be set to, for example, −100° C., and it is preferably −70° C. or higher. In addition, the mass average molecular weight of the block B is not particularly limited and can be appropriately set.

The glass transition temperature of the block C is not particularly limited; however, it can be set to a temperature that exceeds the glass transition temperature of the block A and is lower than the glass transition temperature of the block A.

In the present invention, the glass transition temperature of the compound and the glass transition temperature of the block both have the same meaning as the respective glass transition temperatures of a polymer consisting of the corresponding compound or a polymer consisting of the corresponding block, and they shall be glass transition temperatures that are measured according to the following measuring method.

That is, the glass transition temperature of a compound shall be a glass transition temperature measured for a homopolymer consisting of a constitutional component derived from the corresponding compound. The glass transition temperature of a block shall be a corresponding glass transition temperature among the glass transition temperatures of a block polymer containing the corresponding block. For example, a higher glass transition temperature in the two glass transition temperatures measured for the AB type block polymer is defined as a glass transition temperature of any block that is assumed to exhibit a higher glass transition temperature. It is noted that in a case where the glass transition temperature of the block in the AB type block polymer cannot be measured (for example, the peak intensity is too small to be specified), a value calculated from the following expression shall be adopted.

Tg_{S}=(Tg^{C1}×W^{C1})+(Tg^{C2}×W^{C2})+ . . . +(Tg^{Cn}×W^{Cn}) Expression:

In the expression, Tg^{S} indicates the glass transition temperature (° C.) of the block,

Tg^{C1}, Tg^{C2}, . . . , Tg^{Cn} indicate the glass transition temperatures (° C.) of the respective compounds from which constitutional components C1 and C2 to Cn constituting the corresponding blocks are derived, and

W^{C1}, W^{C2}, . . . , W^{Cn} indicate the contents (% by mass) of respective compounds, from which constitutional components C1 and C2 to Cn constituting the corresponding blocks are derived, in the corresponding blocks.

The glass transition temperatures of the homopolymer and the block polymer are measured under the following conditions using a differential scanning calorimeter (manufactured by SII Crystal Technology Inc., DSC7000) using a dried sample of each polymer. The measurement is carried out twice for the same sample, and the result of the second measurement is employed.
Atmosphere in measurement room: Nitrogen (50 mL/min)
Temperature rising rate: 5° C./min
Measurement start temperature: −100° C.
Measurement end temperature: 200° C.
Sample pan: aluminum pan
Mass of measurement sample: 5 mg
Calculation of Tg: Tg is calculated by rounding off the decimal point of the intermediate temperature between the descent start point and the descent end point of the DSC chart.

The glass transition temperature Tg of the block can be adjusted depending on the composition of the block (the kind and content of the constitutional component) and the like.

An appropriate group such as a hydrogen atom, a chain transfer agent residue, an initiator residue, or the like is introduced into the terminal group of the block polymer by a polymerization method, a polymerization termination method, or the like.

A method of synthesizing the block polymer is not particularly limited, and a known method can be employed. Examples thereof include a living radical polymerization method. Examples of the living radical polymerization method include an atomic transfer radical polymerization method (an ATRP method), a reversible addition-fragmentation chain transfer polymerization method (a RAFT method), and a nitroxide-mediated polymerization method (an NMP method)

The chemical structure, composition, and the like of the binder forming polymer P1 are not particularly limited as long as the above-described characteristics are exhibited; however, the binder forming polymer P1 preferably has the following constitutional component.

——Constitutional Component Having Functional Group——

The binder forming polymer P1 preferably contains one or two or more kinds of constitutional components having a functional group (including a bond) selected from the following group (a) of functional groups, and it more preferably contains the block A or B together with a vinyl compound or (meth)acrylic acid ester compound (which has no specific functional group), which will be described later. The constitutional component having a functional group further reinforces the adsorptive force and the adhesive force of the low adsorption binder PB1 with respect to the solid particles. The functional group may be introduced into any constitutional component that forms the binder forming polymer. It suffices that this constitutional component has at least one (one kind of) functional group, and, in general, it preferably has 1 to 3 kinds of functional groups.

The functional group may be incorporated into the main chain or the side chain of the polymer. In a case of being incorporated into the side chain, it has a linking group that bonds a functional group to the main chain. The linking group is not particularly limited; however, examples thereof include a linking group described later.

<Group (a) of Functional Groups>

A hydroxy group, an amino group, a carboxy group, a sulfo group, a phosphate group, a phosphonate group, a sulfanyl group, an ether bond (—O—), an imino group (═NR or —NR—), an ester bond (—CO—O—), an amide bond (—CO—NR—), a urethane bond (—NR—CO—O—), a thiocarbamate bond (—NR—CS—O—, —NR—CO—S—, or —NR—CS—S—), a urea bond (—NR—CO—NR—), a thiourea bond (—NR—CS—NR—), a heterocyclic group, an aryl group, a carboxylic acid anhydride group, a fluoroalkyl group, a siloxane group, a carbonate bond (—O—CO—O—), and a ketone bond (—CO—)

Each of the amino group, the sulfo group, the phosphate group (the phosphoryl group), the phosphonate group, the heterocyclic group, and the aryl group, which are included in the group (a) of functional groups, is not particularly limited; however, it has the same meaning as the corresponding group of the substituent Z described later. However, the amino group more preferably has 0 to 12 carbon atoms, still more preferably 0 to 6 carbon atoms, and particularly preferably 0 to 2 carbon atoms. In a case where a ring structure contains an amino group, an ether bond, an imino group (—NR—), an ester bond, an amide bond, a urethane bond, a urea bond, or the like, it is classified as a heterocycle. A group that can adopt a salt, such as a hydroxy group, an amino group, a carboxy group, a sulfo group, a phosphate group, a phosphonate group, or a sulfanyl group, may form a salt. Examples of the salt include various metal salts and a salt of ammonium or amine.

In each bond such as an ether bond (—O—), a bond to which parentheses are attached means a bond represented by a chemical formula in the parentheses. A terminal group bonded to this group is not particularly limited. Examples thereof include groups selected from the substituent Z described later, which include, for example, an alkyl group. R in each bond represents a hydrogen atom or a substituent, and it is preferably a hydrogen atom. The substituent is not particularly limited. It is selected from a substituent Z described later, and an alkyl group is preferable. It is noted although an ether group is included in a carboxy group, a hydroxy group, and the like, —O— included in these groups is not regarded as the ether group. The same applies to the thioether group. In addition, in a case of a ketone bond as well, a carbonyl group included in an ester bond and the like is not regarded as the ketone bond.

The carboxylic acid anhydride group is not particularly limited; however, it includes a group obtained by removing one or more hydrogen atoms from a dicarboxylic acid anhydride and a constitutional component itself obtained by copolymerizing a polymerizable dicarboxylic acid anhydride, as well as a structure in which the dicarboxylic acid anhydride is ring-opened by a reaction with a hydroxyl group of water or alcohol or with an amino group. The group obtained by removing one or more hydrogen atoms from a dicarboxylic acid anhydride is preferably a group obtained by removing one or more hydrogen atoms from a cyclic dicarboxylic acid anhydride. Examples the dicarboxylic acid anhydride include acyclic dicarboxylic acid anhydrides such as acetic acid anhydride, propionic acid anhydride, and benzoic acid anhydride; and cyclic dicarboxylic acid anhydrides such as maleic acid anhydride, phthalic acid anhydride, fumaric acid anhydride, succinic acid anhydride, and itaconic acid anhydride. The polymerizable dicarboxylic acid anhydride is not particularly limited; however, examples thereof include a dicarboxylic acid anhydride having an unsaturated bond in the molecule, and a polymerizable cyclic dicarboxylic acid anhydride is preferable. Specific examples thereof include maleic acid anhydride and itaconic acid anhydride. The carboxylic acid anhydride group derived from a cyclic dicarboxylic acid anhydride also corresponds to a heterocyclic group; however, it is classified as a carboxylic acid anhydride group in the present invention.

The fluoroalkyl group is a group obtained by substituting at least one hydrogen atom of an alkyl group or cycloalkyl group with a fluorine atom, and it preferably has 1 to 20 carbon atoms, more preferably 2 to 15 carbon atoms, and still more preferably 3 to 10 carbon atoms. Regarding the number of fluorine atoms on the carbon atom, a part of the hydrogen atoms may be substituted, or all the hydrogen atoms may be substituted (a perfluoroalkyl group).

The siloxane group is not particularly limited, and it is preferably, for example, a group having a structure represented by —(SiR₂—O)ₙ—. R is as described above; however, an alkyl group or an aryl group is preferable. The repetition number n is preferably an integer of 1 to 100, more preferably an integer of 5 to 50, and still more preferably an integer of 10 to 30.

In terms of the adsorptivity (adhesiveness) to solid particles as well as in terms of dispersion characteristics, the functional group is preferably a carboxy group or a hydroxy group and more preferably a hydroxy group.

In the sequential polymerization polymer, each bond such as an ester bond is indicated by being divided into an —CO— group, an —O— group, or the like in a case where the chemical structure of the polymer is indicated according to a constitutional component derived from a raw material compound. As a result, in the present invention, the constitutional components having these bonds are regarded as constitutional components derived from the carboxylic acid compound or constitutional components derived from the isocyanate compound regardless of the notation of the polymer, and they do not include constitutional components derived from the polyol or polyamine compound.

In addition, in the chain polymerization polymer, each bond such as an ester bond (excluding an ester bond that forms a carboxy group) or a constitutional component having an aryl group means a constitutional component in which each bond is not directly bonded to an atom that constitutes the main chain of the chain polymerization polymer, and it does not include, for example, a constitutional component derived from a (meth)acrylic acid alkyl ester or a constitutional component derived from a styrene compound.

In the constitutional component having a functional group, the partial structure to be incorporated into the main chain is not univocally determined depending on the polymer species of the binder forming polymer described later and is appropriately selected. For example, in a case of a chain polymerization polymer, a carbon-carbon bond can be mentioned.

The linking group that links the partial structure to be incorporated into the main chain to the functional group is not particularly limited. However, examples thereof include an alkylene group (preferably having 1 to 12 carbon atoms, more preferably 1 to 6 carbon atoms, and still more preferably having 1 to 3 carbon atoms), an alkenylene group (preferably having 2 to 6 carbon atoms and more preferably having 2 or 3 carbon atoms), an arylene group (preferably having 6 to 24 carbon atoms and more preferably having 6 to 10 carbon atoms), an oxygen atom, a sulfur atom, an imino group (—NR^{N}—: R^{N} represents a hydrogen atom, an alkyl group having 1 to 6 carbon atoms or an aryl group having 6 to 10 carbon atoms), a carbonyl group, a phosphate linking group (—O—P(OH)(O)—O—), a phosphonate linking group (—P(OH)(O)—O—), and a group involved in the combination thereof. The linking group is preferably a group composed of a combination of an alkylene group, an arylene group, a carbonyl group, an oxygen atom, a sulfur atom, and an imino group, and more preferably a group obtained by combining containing a —CO—O— group or a —CO—N(R^{N})— group (here, R^{N} is as described above) and an alkylene group or an arylene group.

In the present invention, the number of atoms that constitute the linking group is preferably 1 to 36, more preferably 1 to 24, still more preferably 1 to 12, and particularly preferably 1 to 6. The number of linking atoms of the linking group is preferably 12 or less, more preferably 10 or less, and particularly preferably 8 or less. The lower limit thereof is 1 or more. The number of linking atoms refers to the minimum number of atoms linking predetermined structural parts. For example, in a case of —C(═O)—O—CH₂—CH₂—, the number of atoms that constitute the linking group is 9; however, the number of linking atoms is 4.

Each of the partial structure to be incorporated into the main chain and the linking group may have or may not have a substituent other than the functional group. Examples of the substituent that may be contained include a group other than the above-described functional group, which is selected from the substituent Z.

The glass transition temperature of the constitutional component having a functional group is not particularly limited; however, it is preferably 15° C. or lower.

Preferred examples of the constitutional component having a functional group include a (meth)acrylic compound (M1) described later, a compound into which a functional group is introduced into a vinyl compound (M2) or the like, and a constitutional component derived from a dicarboxylic acid anhydride. It is noted that a method of introducing a functional group into a polymer will be described later.

——Constitutional Component Derived from (Meth)Acrylic Acid Ester Compound——

In a case where the binder forming polymer P1 is a chain polymerization polymer described later, it preferably contains one or two or more kinds of constitutional components derived from the (meth)acrylic acid ester compound (M1).

Examples of the (meth)acrylic compound (M1) include a (meth)acrylic acid ester compound, a (meth)acrylamide compound, and a (meth)acrylonitrile compound. Among them, a (meth)acrylic acid ester compound is preferable. Examples of the (meth)acrylic acid ester compound include a (meth)acrylic acid alkyl ester compound and a (meth)acrylic acid aryl ester compound, where a (meth)acrylic acid alkyl ester compound is preferable.

The glass transition temperature of this constitutional component is not particularly limited. However, in a case where the constitutional component is incorporated into the block polymer, the glass transition temperature is appropriately set depending on each block, and it is, for example, set to 50° C. or higher or 15° C. or lower.

The alkyl group that constitutes the (meth)acrylic acid alkyl ester compound may be any one of a linear chain, a branched chain, or a cyclic form, and it is appropriately set in consideration of the glass transition temperature of the constitutional component and the like. The number of carbon atoms of the alkyl group is not particularly limited. However, it can be set to, for example, 1 to 24, and is appropriately set in consideration of the glass transition temperature of the constitutional component and the adhesiveness of the polymer binder to the solid particles. It is preferably a short-chain alkyl group having 1 to 4 carbon atoms or a cyclic alkyl group having 3 to 20 carbon atoms (preferably 6 to 15), for example, in a case where the glass transition temperature of the constitutional component is set to 50° C. or higher. On the other hand, it is preferably an alkyl group having 1 to 20 carbon atoms and more preferably a long-chain alkyl group, in a case where the glass transition temperature of the constitutional component is set to 15° C. or lower. The number of carbon atoms of the long-chain alkyl group is more preferably 4 to 16 and still more preferably 6 to 14. The number of carbon atoms of the aryl group that constitutes the aryl ester is not particularly limited; however, it can be set to, for example, 6 to 24, and it is preferably 6 to 10 and more preferably 6. In the (meth)acrylamide compound, the nitrogen atom of the amide group may be substituted with an alkyl group or an aryl group.

It is preferable that the (meth)acrylic compound (M1) does not have the above-described functional group.

(Constitutional Component Derived from (Meth)Acrylic Acid Ester Compound Having Glass Transition Temperature of 50° C. or Higher)

The (meth)acrylic acid ester compound having a glass transition temperature of 50° C. or higher is preferably a constitutional component derived from a compound having a glass transition temperature of 50° C. or higher among the (meth)acrylic compounds (M1). In terms of the tensile permanent strain, the glass transition temperature of the (meth)acrylic acid ester compound from which this constitutional component is derived is preferably 80° C. or higher, more preferably 100° C. or higher, still more preferably 110° C. or higher, and particularly preferably 130° C. or higher. The upper limit of the glass transition temperature is practically 300° C., and it can be set to, for example, 200° C.

Examples of the compound having a glass transition temperature is 50° C. or higher include (meth)acrylic acid short-chain alkyl ester compounds such as methyl methacrylate, ethyl methacrylate, benzyl methacrylate, and t-butyl methacrylate; and (meth)acrylic acid cyclic alkyl ester compounds such as cyclohexyl methacrylate, isobornyl (meth)acrylate (isobornyl (meth)acrylate), adamantyl (meth)acrylate, dicyclopentanyl (meth)acrylate, dicyclopentenyl (meth)acrylate, and dicyclopentenyloxyethyl (meth)acrylate. Examples thereof further include (meth)acrylamide compounds such as (meth)acrylamide, N-isopropyl (meth)acrylamide, dimethyl (meth)acrylamide, and t-butyl (meth)acrylamide, phenyl (meth)acrylate, and (meth)acrylonitrile compound.

(Constitutional Component Derived from (Meth)Acrylic Acid Ester Compound Having Glass Transition Temperature of 15° C. or Lower)

The (meth)acrylic acid ester compound having a glass transition temperature of 15° C. or lower is preferably a constitutional component derived from a compound having a glass transition temperature of 15° C. or lower among the (meth)acrylic compounds (M1). In terms of the tensile permanent strain, the glass transition temperature of the (meth)acrylic acid ester compound from which this constitutional component is derived is preferably 0° C. or lower, more preferably −15° C. or lower, and still more preferably −30° C. or lower. The lower limit of the glass transition temperature is practically −150° C., and it can be set to, for example, −100° C.

Examples of the compound having a glass transition temperature of 15° C. or lower include (meth)acrylic acid alkyl ester compounds such as methyl acrylate, ethyl acrylate, propyl acrylate, butyl acrylate, hexyl (meth)acrylate, octyl (meth)acrylate, ethyl hexyl (meth)acrylate, decyl (meth)acrylate, dodecyl (meth)acrylate, and tetradecyl (meth)acrylate. In addition, examples thereof include (meth)acrylic acid hydroxyalkyl compounds such as hydroxyethyl (meth)acrylate, hydroxypropyl (meth)acrylate, and hydroxybutyl (meth)acrylate, and 2-(meth)acryloyloxyethyl succinic acid, and examples thereof further include (meth)acrylic acid ester compounds of polyalkylene glycols, such as polyethylene glycol (meth)acrylate and polypropylene glycol (meth)acrylate.

——Constitutional Components Derived from Vinyl Compound——

In a case where the binder forming polymer P1 is a chain polymerization polymer described later, one of the preferred aspects thereof is an aspect in which one or two or more kinds of constitutional components derived from the vinyl compound (M2) are contained.

The vinyl compound (M2) is not particularly limited. However, examples thereof include aromatic vinyl compounds such as a styrene compound, a vinyl naphthalene compound, a vinyl carbazole compound, a vinyl imidazole compound, and a vinyl pyridine compound as well as an allyl compound, a vinyl ether compound, and a vinyl ester compound (for example, a vinyl acetate compound). Examples of the vinyl compound include the “vinyl-based monomer” disclosed in JP2015-88486A.

The glass transition temperature of this constitutional component is not particularly limited. However, in a case where the constitutional component is incorporated into the block polymer, the glass transition temperature is appropriately set depending on each block, and it is, for example, set to 50° C. or higher or 15° C. or lower.

Examples of the vinyl compound having a glass transition temperature of 50° C. or higher include a styrene compound, a vinyl naphthalene compound, a vinyl carbazole compound, a vinyl pyridine compound, a vinyl imidazole compound, and N-vinyl caprolactam. On the other hand, examples of the vinyl compound having a glass transition temperature of 15° C. or lower include vinyl acetate and a vinyl ether compound.

Each of the (meth)acrylic compound and the vinyl compound may have a substituent. The substituent is not particularly limited, and examples thereof include a group selected from the substituent Z described later.

The binder forming polymer may have one kind or two or more kinds of each of the above-described constitutional components.

Preferred examples of the binder forming polymer P1 that exhibits a tensile permanent strain in the above-described range include a polymer having, in the main chain, a polymerized chain of at least one kind of bond selected from a urethane bond, a urea bond, an amide bond, an imide bond, an ester bond, an ether bond, or a carbonate bond, or a polymerized chain of carbon-carbon double bonds.

The above bond is not particularly limited as long as it is contained in the main chain of the polymer, and it may have any aspect in which it is contained in the constitutional component (the repeating unit) and/or an aspect in which it is contained as a bond that connects different constitutional components to each other. Further, the above-described bond contained in the main chain is not limited to one kind, it may be 2 or more kinds, and it is preferably 1 to 6 kinds and more preferably 1 to 4 kinds. In this case, the bonding mode of the main chain is not particularly limited. The main chain may randomly have two or more kinds of bonds and may be a main chain that is segmented to a segment having a specific bond and a segment having another bond.

Examples of the polymer having, among the above bonds, a urethane bond, a urea bond, an amide bond, an imide bond, an ester bond, an ester bond, or a carbonate bond in the main chain include sequential polymerization (polycondensation, polyaddition, or addition condensation) polymers, such as polyurethane, polyurea, polyamide, polyimide, polyester, polyether, and polycarbonate, and copolymers thereof. The copolymer may be a block copolymer having each of the above polymers as a segment, or a random copolymer in which each constitutional component that constitutes two or more polymers among the above polymers is randomly bonded.

Examples of the polymer having a polymerized chain of carbon-carbon double bonds in the main chain include chain polymerization polymers such as a fluoropolymer (a fluorine-containing polymer), a hydrocarbon polymer, a vinyl polymer, and a (meth)acrylic polymer. The polymerization modes of these chain polymerization polymers are not particularly limited, and the polymerization may be any one of a block copolymer, an alternating copolymer, or a random copolymer. However, a block copolymer is preferable from the viewpoint that a tensile permanent strain in the above-described range can be exhibited.

As the binder forming polymer P1, each of the above-described polymers can be appropriately selected. However, a polymer having a polymerized chain of carbon-carbon double bonds in the main chain is preferable, and a chain polymerization polymer is more preferable, where a (meth)acrylic polymer, a fluoropolymer, or a vinyl polymer is preferable, and a (meth)acrylic polymer is more preferable, from the viewpoint that resistance and cycle characteristics can be further improved while maintaining dispersion stability and handleability.

Examples of the (meth)acrylic polymer suitable as the binder forming polymer P1 include a copolymer containing a constitutional component derived from the (meth)acrylic compound (M1), preferably a constitutional component or the like having a functional group, where it is a polymer consisting of a copolymer containing 50% by mass or more of a constitutional component derived from a (meth)acrylic compound. Here, in a case where the constitutional component or the like having a functional group is a constitutional component derived from a (meth)acrylic acid compound or a (meth)acrylic compound, the content of the constitutional component having a functional group is included for calculation in the content of the constitutional component derived from a (meth)acrylic compound. The (meth)acrylic polymer is also preferably a copolymer containing a constitutional component derived from a vinyl compound. In this case, the content of the constitutional component derived from the vinyl compound, in the polymer, is 50% by mass or less, and it is preferably 3% to 40% by mass and preferably 3% to 30% by mass.

Examples of the vinyl polymer suitable as the binder forming polymer P1 include a copolymer containing a constitutional component derived from the vinyl compound (M2), preferably a constitutional component or the like having a functional group, where it is a polymer consisting of a copolymer containing 50% by mass or more of a constitutional component derived from a vinyl compound. Here, in a case where the constitutional component or the like having a functional group is a constitutional component derived from the vinyl compound, the content of the constitutional component having a functional group is included for calculation in the content of the constitutional component derived from the vinyl compound. Further, the vinyl polymer is also preferably a copolymer containing a constitutional component derived from a (meth)acrylic compound. In this case, the content of the constitutional component derived from the (meth)acrylic compound, in the polymer, is less than 50% by mass, and it is, for example, preferably 0% to 40% by mass and more preferably 0% to 30% by mass.

Examples of the fluoropolymer suitable as the binder forming polymer P1 include a (co)polymer of a polymerizable compound (a fluorine-containing polymerizable compound) containing a fluorine atom. Further, the fluoropolymer is also preferably a copolymer containing a constitutional component having a functional group, a constitutional component derived from a (meth)acrylic compound, a constitutional component derived from a vinyl compound, or the like.

The fluorine-containing polymerizable compound is not particularly limited, and examples thereof include a compound that is generally used in a fluoropolymer. For example, it refers to a compound in which a fluorine atom is bonded to a carbon-carbon double bond directly or through a linking group. The linking group is not particularly limited; however, examples thereof include a linking group in the above-described constitutional component having a functional group. Examples of the fluorine-containing polymerizable compound include fluorinated vinyl compounds such as vinylidene fluoride (VDF), hexafluoropropylene (HFP), tetrafluoroethylene (TFE), trifluoroethylene, monofluoroethylene, and chlorotrifluoroethylene, and perfluoroalkyl ether compounds such as trifluoromethyl vinyl ether and pentafluoroethyl vinyl ether.

Examples of the fluoropolymer include polytetrafluoroethylene (PTFE), polyvinylidene difluoride (PVdF), a copolymer of polyvinylidene difluoride and hexafluoropropylene (PVdF-HFP), and a copolymer (PVdF-HFP-TFE) of polyvinylidene difluoride, hexafluoropropylene, and tetrafluoroethylene. The content of each of the constitutional components in the fluoropolymer is appropriately determined in consideration of the glass transition temperature, tensile permanent strain, and the like. For example, in PVdF-HFP, the copolymerization ratio [PVdF:HFP] (mass ratio) of PVdF to HFP is not particularly limited; however, it is preferably 9:1 to 5:5. In PVdF-HFP-TFE, the copolymerization ratio [PVdF:HFP:TFE] (mass ratio) of PVdF, HFP, and TFE is not particularly limited; however, it is preferably 20 to 60:10 to 40:5 to 30.

Examples of the hydrocarbon polymer suitable as the binder forming polymer P1 include polyethylene, polypropylene, natural rubber, polybutadiene, polyisoprene, polystyrene, a polystyrene butadiene copolymer, a styrene-based thermoplastic elastomer, polybutylene, an acrylonitrile butadiene copolymer, and hydrogen-added (hydrogenated) polymers thereof. The styrene-based thermoplastic elastomer or the hydride thereof is not particularly limited. However, examples thereof include a styrene-ethylene-butylene-styrene block copolymer (SEBS), a styrene-isoprene-styrene block copolymer (SIS), a hydrogenated SIS, a styrene-butadiene-styrene block copolymer (SBS), a hydrogenated SBS, a styrene-ethylene-ethylene-propylene-styrene block copolymer (SEEPS), a styrene-ethylene-propylene-styrene block copolymer (SEPS), a styrene-butadiene rubber (SBR), a hydrogenated a styrene-butadiene rubber (HSBR), and furthermore, a random copolymer corresponding to each of the above-described block copolymers such as SEBS. In the present invention, the hydrocarbon polymer preferably has no unsaturated group (for example, a 1,2-butadiene constitutional component) that is bonded to the main chain from the viewpoint that the formation of chemical crosslink can be suppressed.

The (meth)acrylic compound (M1) and the vinyl compound (M2) are preferably a compound represented by Formula (b-1). In a case where this compound has a functional group selected from the group (a) of functional groups, it corresponds to the above-described compound from which a constitutional component having a functional group is derived.

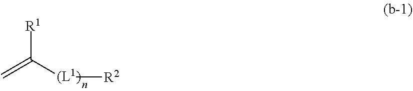

In the formula, R¹ represents a hydrogen atom, a hydroxy group, a cyano group, a halogen atom, an alkyl group (preferably having 1 to 24 carbon atoms, more preferably 1 to 12 carbon atoms, and particularly preferably 1 to 6 carbon atoms), an alkenyl group (preferably having 2 to 24 carbon atoms, more preferably 2 to 12 carbon atoms, and particularly preferably 2 to 6 carbon atoms), an alkynyl group (preferably having 2 to 24 carbon atoms, more preferably 2 to 12 carbon atoms, and particularly preferably 2 to 6 carbon atoms), or an aryl group (preferably having 6 to 22 carbon atoms and more preferably 6 to 14 carbon atoms). Among the above, a hydrogen atom or an alkyl group is preferable, and a hydrogen atom or a methyl group is more preferable.

R² represents a hydrogen atom or a substituent. The substituent that can be adopted as R² is not particularly limited. However, examples thereof include an alkyl group (preferably a linear chain although it may be a branched chain), an alkenyl group (preferably having 2 to 12 carbon atoms, more preferably 2 to 6 carbon atoms, and particularly preferably 2 or 3 carbon atoms), an aryl group (preferably having 6 to 22 carbon atoms and more preferably 6 to 14 carbon atoms), an aralkyl group (preferably having 7 to 23 carbon atoms and more preferably 7 to 15 carbon atoms), and a cyano group. The number of carbon atoms of the alkyl group has the same meaning as the number of carbon atoms of the alkyl group that constitutes the (meth)acrylic acid alkyl ester compound, and the same applies to the preferred range thereof.

L¹ is a linking group and is not particularly limited; however, examples thereof include a linking group in the above-described constitutional component having a functional group. However, L¹ is particularly preferably a —CO—O— group.

n is 0 or 1 and preferably 1. However, in a case where-(L¹)ₙ-R² represents one kind of substituent (for example, an alkyl group), n is set to 0, and R² is set to a substituent (an alkyl group).

In Formula (b-1), the carbon atom which forms a polymerizable group and to which RI is not bonded is represented as an unsubstituted carbon atom (H₂C═); however, it may have a substituent. The substituent is not particularly limited; however, examples thereof include the above group that can be adopted as R¹.

In addition, the group which may adopt a substituent such as an alkyl group, an aryl group, an alkylene group, or an arylene group may have a substituent within a range where the effect of the present invention is not impaired. The substituent is not particularly limited, and examples thereof include a group selected from the substituent Z described later, where specific examples thereof include a halogen atom.

The content of each constitutional component in the binder forming polymer P1 is not particularly limited, is determined by appropriately considering the tensile permanent strain, adsorption rate, and the like of the entire polymer, and is set, for example, in the following range.

The content of each constitutional component in the binder forming polymer P1 is set, for example, in the following range such that the total content of all the constitutional components is 100% by mass. It is noted that in a case where two or more kinds of constitutional components corresponding to the specific constitutional components are contained, the content of the specific constitutional component is the total content of the two or more kinds of the constitutional components.

The content of the constitutional component having the above functional group in the binder forming polymer P1 is not particularly limited as long as the adsorption rate of the low adsorption binder PB1 with respect to the inorganic solid electrolyte can be suppressed to be less than 60%. It is preferably 0.1% to 50% by mass, more preferably 0.1% to 20% by mass, still more preferably 0.5% to 20% by mass, and particularly preferably 1% to 10% by mass, for example, from the viewpoint that the tensile permanent strain can be set in the above-described range while improving the dispersion characteristics of the solid particles. However, the content of the constitutional component having a carboxy group is preferably less than 10% by mass, more preferably 0.1% to 5% by mass, and still more preferably 0.2% to 3% by mass.

The constitutional component having a functional group is preferably contained in a segment containing the above-described constitutional component derived from a (meth)acrylic acid ester compound having a glass transition temperature of 15° C. or lower, and the content in this case is also set in the above-described range.

The total content of the constitutional component derived from a (meth)acrylic compound, in the binder forming polymer P1, is not particularly limited and is appropriately determined. It is 50% by mass or more, where it is preferably 50% to 100% by mass, more preferably 65% to 100% by mass, and still more preferably 80% to 100% by mass, for example, in a case where the binder forming polymer P1 is a (meth)acrylic polymer.

Among the constitutional components derived from the (meth)acrylic compound, the content of the constitutional component derived from a (meth)acrylic acid ester compound, in the binder forming polymer P1, is not particularly limited and is appropriately determined in consideration of the total content and the like. It is 30% by mass or more, where it is preferably 40% to 100% by mass, more preferably 60% to 100% by mass, and still more preferably 75% to 100% by mass, for example, in a case where the binder forming polymer P1 is a (meth)acrylic polymer.

Among the constitutional components derived from the (meth)acrylic acid ester compound, the content of a constitutional component derived from a (meth)acrylic acid ester compound having a glass transition temperature of 50° C. or higher, in the binder forming polymer P1, is not particularly limited, and it is appropriately determined in consideration of the tensile permanent strain, the adsorption rate, the total content of the constitutional components derived from the (meth)acrylic acid ester compound, and the like. It is preferably 3% to 50% by mass, more preferably 5% to 40% by mass, and still more preferably 10% to 30% by mass, for example, in a case where the binder forming polymer P1 is a (meth)acrylic polymer. It is preferably 0% to 50% by mass and more preferably 10% to 30% by mass in a case where the binder forming polymer P1 is another chain polymerization polymer. In a segment containing a constitutional component derived from a vinyl compound or (meth)acrylic acid ester compound having a glass transition temperature of 50° C. or higher, the content of a constitutional component derived from a (meth)acrylic acid ester compound having a glass transition temperature of 50° C. or higher is appropriately set in consideration of the content in the binder forming polymer P1 and the like. For example, it can be set to 0% to 100% by mass in all the constitutional components constituting the segment, where it is preferably 50% to 100% by mass.

In addition, the content of a constitutional component derived from a (meth)acrylic acid ester compound having a glass transition temperature of 15° C. or lower, in the binder forming polymer P1, is not particularly limited, and it is appropriately determined in consideration of the tensile permanent strain, the adsorption rate, the total content of the constitutional components derived from the (meth)acrylic acid ester compound, and the like. It is preferably 50% to 97% by mass, more preferably 60% to 95% by mass, and still more preferably 70% to 90% by mass, for example, in a case where the binder forming polymer P1 is a (meth)acrylic polymer. It is preferably 50% to 100% by mass and more preferably 70% to 90% by mass in a case where the binder forming polymer P1 is another chain polymerization polymer. In a segment containing a constitutional component derived from a (meth)acrylic acid ester compound having a glass transition temperature of 15° C. or lower, the content of a constitutional component derived from a (meth)acrylic acid ester compound having a glass transition temperature of 15° C. or lower is appropriately set in consideration of the content in the binder forming polymer P1 and the like. For example, it can be set to 0% to 100% by mass in all the constitutional components constituting the segment, where it is preferably 50% to 100% by mass.

The total content of the constitutional component derived from a vinyl compound, in the binder forming polymer P1, is not particularly limited and is appropriately determined. It is 50% by mass or more, where it is preferably 50% to 100% by mass, more preferably 60% to 100% by mass, and still more preferably 75% to 100% by mass, for example, in a case where the binder forming polymer P1 is a vinyl polymer. It is less than 50% by mass in a case where the binder forming polymer P1 is another chain polymerization polymer.

Among the constitutional components derived from the vinyl compound, the content of the constitutional component derived from a vinyl compound having a glass transition temperature of 50° C. or higher, in the binder forming polymer P1, is not particularly limited, and it is appropriately determined in consideration of the tensile permanent strain, the adsorption rate, the total content of the constitutional components derived from the vinyl compound, and the like. It is preferably 5% to 40% by mass, more preferably 10% to 30% by mass, and still more preferably 15% to 20% by mass, for example, in a case where the binder forming polymer P1 is a vinyl polymer or a hydrocarbon polymer. It is preferably 0% to 50% by mass and more preferably 10% to 30% by mass in a case where the binder forming polymer P1 is another chain polymerization polymer.

In a case where the binder forming polymer P1 is a block polymer, the content of each block in the binder forming polymer is not particularly limited and is appropriately determined in consideration of the tensile permanent strain, the adsorption rate, the (total) content, and the like.

The content of a block having a high glass transition temperature in the binder forming polymer, the block being, for example, a segment A containing a constitutional component derived from a vinyl compound or (meth)acrylic acid ester compound having a glass transition temperature of 50° C. or higher, is preferably 3% to 50% by mass, more preferably 5% to 40% by mass, and still more preferably 10% to 30% by mass, in terms of the tensile permanent strain and the adsorption rate. In a case where the block polymer contains two or more blocks A (for example, an ABA type block polymer), the content of the block A shall be the total content of the two or more blocks A. In this case, the ratio between the contents of the two blocks A is appropriately set, and it can be set, for example, 1:5 to 5:1 (mass ratio).

On the other hand, the content of a block having a lower glass transition temperature in the binder forming polymer, the block being, for example, a segment B containing a constitutional component derived from a (meth)acrylic acid ester compound having a glass transition temperature of 15° C. or lower, is preferably 50% to 97% by mass, more preferably 60% to 95% by mass, and still more preferably 70% to 90% by mass, in terms of the tensile permanent strain and the adsorption rate. The content of the block B shall be also the total content in a case where two or more blocks B are included. In this case, the ratio between the contents of the two blocks B is appropriately set and can be set in the same range as the ratio between the contents of the two blocks A.

In a case where the block polymer has another block corresponding to neither the block A nor the block B, for example, the block C described above, the content of this block in the binder forming polymer is not particularly limited and it can be set to, for example, 30% by mass or less.

The binder forming polymer P1 may have a substituent. The substituent is not particularly limited; however, examples thereof preferably include a group selected from the following substituent Z.

The binder forming polymer P1 can be synthesized with a known method by selecting a raw material compound depending on the kind of bond of the main chain and subjecting the raw material compound to polyaddition, polycondensation, chain polymerization, or the like.

—Substituent Z—

The examples are an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, and 1-carboxymethyl), an alkenyl group (preferably an alkenyl group having 2 to 20 carbon atoms, such as vinyl, allyl, and oleyl), an alkynyl group (preferably an alkynyl group having 2 to 20 carbon atoms, for example, ethynyl, butadienyl, and phenylethynyl), a cycloalkyl group (preferably a cycloalkyl group having 3 to 20 carbon atoms, such as cyclopropyl, cyclopentyl, cyclohexyl, and 4-methylcyclohexyl; in the present specification, the alkyl group generally has a meaning including a cycloalkyl group therein in a case of being referred to; however, it will be described separately here), an aryl group (preferably an aryl group having 6 to 26 carbon atoms, such as phenyl, 1-naphthyl, 4-methoxyphenyl, 2-chlorophenyl, and 3-methylphenyl), an aralkyl group (preferably an aralkyl group having 7 to 23 carbon atoms, for example, benzyl or phenethyl), and a heterocyclic group (preferably a heterocyclic group having 2 to 20 carbon atoms and more preferably a 5- or 6-membered heterocyclic group having at least one oxygen atom, one sulfur atom, or one nitrogen atom. The heterocyclic group includes an aromatic heterocyclic group and an aliphatic heterocyclic group. Examples thereof include a tetrahydropyran ring group, a tetrahydrofuran ring group, a 2-pyridyl group, a 4-pyridyl group, a 2-imidazolyl group, a 2-benzimidazolyl group, a 2-thiazolyl group, a 2-oxazolyl group, or a pyrrolidone group); an alkoxy group (preferably an alkoxy group having 1 to 20 carbon atoms, for example, a methoxy group, an ethoxy group, an isopropyloxy group, or a benzyloxy group); an aryloxy group (preferably an aryloxy group having 6 to 26 carbon atoms, for example, a phenoxy group, a 1-naphthyloxy group, a 3-methylphenoxy group, or a 4-methoxyphenoxy group); a heterocyclic oxy group (a group in which an —O— group is bonded to the above-described heterocyclic group), an alkoxycarbonyl group (preferably an alkoxycarbonyl group having 2 to 20 carbon atoms, for example, an ethoxycarbonyl group, a 2-ethylhexyloxycarbonyl group, or a dodecyloxycarbonyl group); an aryloxycarbonyl group (preferably an aryloxycarbonyl group having 6 to 26 carbon atoms, for example, a phenoxycarbonyl group, a 1-naphthyloxycarbonyl group, a 3-methylphenoxycarbonyl group, or a 4-methoxyphenoxycarbonyl group); a heterocyclic oxycarbonyl group (a group in which a —O—CO— group is bonded to the above-described heterocyclic group); an amino group (preferably an amino group having 0 to 20 carbon atoms, an alkylamino group, or an arylamino group, for example, an amino (—NH₂) group, an N,N-dimethylamino group, an N,N-diethylamino group, an N-ethylamino group, or an anilino group); a sulfamoyl group (preferably a sulfamoyl group having 0 to 20 carbon atoms, for example, an N,N-dimethylsulfamoyl group or an N-phenylsufamoyl group); an acyl group (an alkylcarbonyl group, an alkenylcarbonyl group, an alkynylcarbonyl group, an arylcarbonlyl group, or a heterocyclic carbonyl group, preferably an acyl group having 1 to 20 carbon atoms, for example, an acetyl group, a propionyl group, a butyryl group, an octanoyl group, a hexadecanoyl group, an acryloyl group, a methacryloyl group, a crotonoyl group, a benzoyl group, a naphthoyl group, or a nicotinoyl group); an acyloxy group (an alkylcarbonyloxy group, an alkenylcarbonyloxy group, an alkynylcarbonyloxy group, or a heterocyclic carbonyloxy group, preferably an acyloxy group having 1 to 20 carbon atoms, for example, an acetyloxy group, a propionyloxy group, a butyryloxy group, an octanoyloxy group, a hexadecanoyloxy group, an acryloyloxy group, a methacryloyloxy group, a crotonoyloxy group, or a nicotinoyloxy group); an aryloyloxy group (preferably an aryloyloxy group having 7 to 23 carbon atoms, for example, a benzoyloxy group or a naphthoyloxy group); a carbamoyl group (preferably a carbamoyl group having 1 to 20 carbon atoms, for example, an N,N-dimethylcarbamoyl group or an N-phenylcarbamoyl group); an acylamino group (preferably an acylamino group having 1 to 20 carbon atoms, for example, an acetylamino group or a benzoylamino group); an alkylthio group (preferably an alkylthio group having 1 to 20 carbon atoms, for example, a methylthio group, an ethylthio group, an isopropylthio group, or a benzylthio group); an arylthio group (preferably an arylthio group having 6 to 26 carbon atoms, for example, a phenylthio group, a 1-naphthylthio group, a 3-methylphenylthio group, or a 4-methoxyphenylthio group); a heterocyclic thio group (a group in which an —S— group is bonded to the above-described heterocyclic group), an alkylsulfonyl group (preferably an alkylsulfonyl group having 1 to 20 carbon atoms, for example, a methylsulfonyl group or an ethylsulfonyl group), an arylsulfonyl group (preferably an arylsulfonyl group having 6 to 22 carbon atoms, for example, a benzenesulfonyl group), an alkylsilyl group (preferably an alkylsilyl group having 1 to 20 carbon atoms, for example, a monomethylsilyl group, a dimethylsilyl group, a trimethylsilyl group, or a triethylsilyl group); an arylsilyl group (preferably an arylsilyl group having 6 to 42 carbon atoms, for example, a triphenylsilyl group), an alkoxysilyl group (preferably an alkoxysilyl group having 1 to 20 carbon atoms, for example, a monomethoxysilyl group, a dimethoxysilyl group, a trimethoxysilyl group, or a triethoxysilyl group), an aryloxysilyl group (preferably an aryloxysilyl group having 6 to 42 carbon atoms, for example, a triphenyloxysilyl group), a phosphoryl group (preferably a phosphate group having 0 to 20 carbon atoms, for example, —OP(═O)(RP)₂), a phosphonyl group (preferably a phosphonyl group having 0 to 20 carbon atoms, for example, —P(═O)(RP)₂), a phosphinyl group (preferably a phosphinyl group having 0 to 20 carbon atoms, for example, —P(RP)₂), a phosphonate group (preferably a phosphonate group having 0 to 20 carbon atoms, for example, —PO(ORW)₂), a sulfo group (a sulfonate group), a carboxy group, a hydroxy group, a sulfanyl group, a cyano group, and a halogen atom (for example, a fluorine atom, a chlorine atom, a bromine atom, or an iodine atom). RP represents a hydrogen atom or a substituent (preferably a group selected from the substituent Z).

In addition, each group exemplified in the substituent Z may be further substituted with the substituent Z.

The alkyl group, the alkylene group, the alkenyl group, the alkenylene group, the alkynyl group, the alkynylene group, and/or the like may be cyclic or chained, may be linear or branched.

Specific examples of the binder forming polymer P1 include polymers synthesized in Examples; however, the present invention is not limited thereto.

The binder forming polymer, which is contained in the polymer binder, may be one kind or two or more kinds. In addition, the polymer binder may contain another polymer as long as the action of the binder forming polymer is not impaired. As another polymer, a polymer that is generally used as a binder for an all-solid state secondary battery can be used without particular limitation.

The total content of the binder PB in the inorganic solid electrolyte-containing composition is not particularly limited. However, in terms of dispersion stability and handleability, as well as resistance reduction and cycle characteristics, it is preferably 0.1% to 10.0% by mass, more preferably 0.2% to 5.0% by mass, and still more preferably 0.3% to 4.0% by mass. On the other hand, for the same reason as above, it is preferably 0.1% to 10.0% by mass, more preferably 0.3% to 8% by mass, and still more preferably 0.5% to 7% by mass, with respect to 100% by mass of the solid content.

In the present invention, the mass ratio [(the mass of the inorganic solid electrolyte+the mass of the active material)/(the total mass of the polymer binder PB)] of the total mass (in terms of the total amount) of the inorganic solid electrolyte and the active material to the total mass of the polymer binder PB in the solid content of 100% by mass is preferably in a range of 1,000 to 1. Furthermore, this ratio is more preferably 500 to 2 and still more preferably 100 to 10.

In a case where the inorganic solid electrolyte-containing composition contains a binder other than the low adsorption binder PB1, the content (solid content mass) of the low adsorption binder PB1 described above may be high as compared with the total content (solid content mass) of binders other than the low adsorption binder PB1: however, it is preferably the same or low as compared with the total content thereof. This makes it possible to reinforce the binding property and the like without impairing the excellent dispersion stability and excellent handleability in a case where the binder other than the low adsorption binder PB1 is particularly the particulate binder PB2. On the other hand, in a case where the binder other than the low adsorption binder PB1 includes the polymer binder PB3 consisting of a chain polymerization polymer (excluding the above-described polymer having a tensile permanent strain of less than 50%), it is possible to further reinforce the dispersion stability as well as the ion conductivity and the cycle characteristics while maintaining the adhesiveness. The difference (in terms of absolute value) between the content of the low adsorption binder PB1 and the total content of the binder other than the low adsorption binder is not particularly limited, and it can be set to, for example, 0% to 8% by mass, more preferably 0% to 4% by mass, and still more preferably 0% to 2% by mass. In addition, the ratio between the contents of the low adsorption binder PB1 and the binder other than the low adsorption binder (content of low adsorption binder/total content of binder other than low adsorption binder) is not particularly limited. However, it is, for example, preferably 0.01 to 10, more preferably 0.02 to 5, still more preferably 0.03 to 2.0, particularly preferably 0.04 to 1.0, and most preferably 0.05 to 0.2.

In a case where the binder other than low adsorption binder contains a plurality of binder species such as a polymer binder containing a polymer in which the tensile permanent strain is not measurable or 50% or more, a high adsorption binder, a particulate binder PB2, and a polymer binder PB3 consisting of a chain polymerization polymer, the content of each binder species, the difference (in terms of absolute value) in content between each binder species and the low adsorption binder, and the ratio between the contents of each binder species and the low adsorption binder PB1 are each appropriately determined, and they can be set to, for example, those of the binder other than the low adsorption binder in the above-described range. However, the ratio between the contents of the low adsorption binder PB1 and the particle binder PB2 (content of low adsorption binder PB1/content of particle binder PB2) is preferably 0.01 to 10, more preferably 0.02 to 5, and still more preferably 0.05 to 3.0.

(Particulate Binder PB2)

In addition to the above-described low adsorption binder PB1, the inorganic solid electrolyte-containing composition according to the embodiment of the present invention preferably contains, as the polymer binder PB, one or two or more particle-shaped polymer binders PB2 (particulate binders) that are insoluble in a dispersion medium in the composition. The shape of this particulate binder is not particularly limited and may be a flat shape, an amorphous shape, or the like; however, a spherical shape or a granular shape is preferable. The average particle diameter of the particulate binder is preferably 1 to 1,000 nm, more preferably 10 to 800 nm, still more preferably 20 to 500 nm, and particularly preferably 40 to 300 nm. The particle diameter can be measured using the same method as that of the average particle diameter of the inorganic solid electrolyte.

The particulate binder PB2 is preferably a particulate binder of which the adsorption rate is 60% or more with respect to the inorganic solid electrolyte. The adsorption rate with respect to the active material is appropriately determined. The polymer P2 that forms the particulate binder can be appropriately selected from the sequential polymerization polymer, the chain polymerization polymer, and the like, and it is preferably a random polymer. The tensile permanent strain of this polymer is not particularly limited; however, it is preferable to be not measurable or 50% or more.

In a case where the inorganic solid electrolyte-containing composition contains a particulate binder PB2, the effect of improving the dispersion stability and the handleability due to the binder forming polymer P1 is not impaired, and the binding property of the solid particles can be reinforced while an increase in interface resistance is suppressed. This makes it possible to further increase the cycle characteristics of the all-solid state secondary battery, and preferably it is possible to realize still lower resistance.

As the particulate binder PB2, various particulate binders that are used in the manufacture of an all-solid state secondary battery can be used without particular limitation. Examples thereof include a particulate binder consisting of the sequential polymerization polymer or the chain polymerization polymer, which are described later, and specific examples thereof include polymer Lx-1, which is synthesized in Example. In addition, other examples thereof include the binders disclosed in JP2015-088486A and WO2018/020827A.

The sequential polymerization polymer is not particularly limited; however, examples thereof include polyurethane, polyurea, polyamide, polyimide, polyester, and polycarbonate. The chain polymerization polymer is not particularly limited; however, examples thereof include chain polymerization polymers (examples thereof include those exemplified later) such as a fluoropolymer (a fluorine-based copolymer), a hydrocarbon polymer, a vinyl polymer, and a (meth)acrylic polymer.

The content of the particulate binder in the inorganic solid electrolyte-containing composition is not particularly limited. However, it is preferably 0.02% to 5.0% by mass, more preferably 0.05% to 3.0% by mass, and still more preferably 0.1% to 2.0% by mass, in the solid content of 100% by mass, from the viewpoint that dispersion stability and handleability are improved and furthermore, the binding property is exhibited. It is noted that the content of the particulate binder is appropriately set within the above-described range; however, it is preferably a content at which the particulate binder is not dissolved in the inorganic solid electrolyte-containing composition in consideration of the solubility of the particulate binder.

(Polymer Binder PB3 Consisting of Chain Polymerization Polymer)

The inorganic solid electrolyte-containing composition according to the embodiment of the present invention preferably contains, as the polymer binder PB, one or two or more polymer binders (may be referred to as chain polymerization polymer binders) PB3 consisting of a chain polymerization polymer in addition to the low adsorption binder PB1 described above. In a case where the inorganic solid electrolyte-containing composition contains the chain polymerization polymer binder PB3, it is possible to further improve the dispersion stability and the handleability without impairing adhesiveness, and it is possible to further improve the cycle characteristics and the ion conductivity.

The chain polymerization polymer binder PB3 may be insoluble in a dispersion medium in the composition; however, it is preferably soluble. In addition, in the chain polymerization polymer binder, the adsorption rate with respect to the inorganic solid electrolyte is preferably less than 60%, and the preferred range thereof is the same as that of the above-described binder forming polymer having a tensile permanent strain of less than 50%. The adsorption rate with respect to the active material is appropriately determined. Each adsorption rate can be measured according to the above-described method.

The chain polymerization polymer P3 that forms the chain polymerization polymer binder PB3 is not particularly limited; however, preferred examples thereof include a hydrocarbon polymer, a vinyl polymer, and a (meth)acrylic polymer. The polymerization mode of these chain polymerization polymers is not particularly limited. The chain polymerization polymer may be any one of a block copolymer, an alternating copolymer, or a random copolymer; however, it is preferably a random copolymer. The tensile permanent strain of the chain polymerization polymer is not particularly limited; however, it is preferable to be not measurable or 50% or more.

The chain polymerization polymer P3 may contain a constitutional component (a constitutional component having a functional group) having, for example, as a substituent, the functional group selected from the group (a) of functional groups, which is described in the binder forming polymer having a tensile permanent strain of less than 50%. The constitutional component having a functional group has a function of improving the adsorption rate of the chain polymerization polymer binder PB3 with respect to the inorganic solid electrolyte and may be any constitutional component that forms the chain polymerization polymer P3. The functional group may be incorporated into the main chain or the side chain of the chain polymerization polymer. In a case of being incorporated into the side chain, it has a linking group that bonds a functional group to the main chain. The linking group is not particularly limited; however, examples thereof include the above-described linking group that links the partial structure to be incorporated in the main chain to the functional group. The functional group contained in one constitutional component may be one kind or two or more kinds, and in a case where two or more kinds are contained, they may be or may not be bonded to each other.

The constitutional component having an ester bond (excluding an ester bond that forms a carboxy group) or an amide bond as a functional group means a constitutional component in which an ester bond or an amide bond is not directly bonded to an atom that constitutes the main chain, and it does not include, for example, a constitutional component derived from a (meth)acrylic acid alkyl ester.

The content (molar basis) of the constitutional component having the above functional group, in the polymer P3, is not particularly limited; however, it is preferably 0.01% to 70% by more, preferably 1% to 20% by mole, and still more preferably 3% to 10% by mole, in terms of the binding property of the solid particles. The content (mass basis) of the constitutional component having a functional group is not particularly limited; however, for the same reason as described above, it is in the same range as the content of the constitutional component having a functional group in the binder forming polymer P1. However, a particularly preferred range is 0.5% to 5% by mass.

Examples of the introduction method for a functional group include a method of carrying out copolymerization by reacting a compound from which a constitutional component is derived with a compound containing a functional group (a) (synthesizing a compound from which a constitutional component having a functional group is derived) at the time of polymerizing a chain polymerization polymer. In addition, other examples thereof include a method of introducing a functional group into a polymer terminal by carrying out polymerization with an initiator or chain transfer agent containing a functional group as well as a method of introducing a functional group into a side chain or a terminal by a polymeric reaction. A commercially available chain polymerization polymer having a functional group can also be used.

—Vinyl Polymer Binder Consisting of Vinyl Polymer—

The vinyl polymer that forms the vinyl polymer binder is not particularly limited, and it includes, for example, a vinyl polymer suitable as the binder forming polymer P1 that forms the low adsorption binder PB1. Examples thereof include a polymer containing a vinyl-based monomer other than the (meth)acrylic compound described later, where the content of the vinyl-based monomer is, for example, 50% by mole or more or 50% by mass or more. Examples of the vinyl-based monomer include the vinyl compound described above. Specific examples of the vinyl polymer include polyvinyl alcohol, polyvinyl acetal, polyvinyl acetate, and a copolymer containing these.

It is also preferable that this vinyl polymer has a constitutional component derived from a (meth)acrylic compound in addition to the constitutional component derived from the vinyl-based monomer. The content of the constitutional component derived from the vinyl-based monomer is preferably the same as the content of the constitutional component derived from the (meth)acrylic compound (M1) in the (meth)acrylic polymer. The content of the constitutional component derived from the (meth)acrylic compound in the polymer is not particularly limited as long as it is less than 50% by mass; however, it is preferably 0% to 30% by mass.

—(Meth)Acrylic Polymer Binder Consisting of (Meth)Acrylic Polymer—

The (meth)acrylic polymer that forms the (meth)acrylic polymer binder is not particularly limited, and examples thereof include a (meth)acrylic polymer suitable as the binder forming polymer P1 that forms the low adsorption binder PB1. For example, a polymer obtained by copolymerizing at least one (meth)acrylic compound (M4) selected from a (meth)acrylic acid compound, a (meth)acrylic acid ester compound, a (meth)acrylamide compound, or a (meth)acrylonitrile compound is preferable. This (meth)acrylic compound (M4) is the same as the above-described (meth)acrylic compound (M1) except that it includes a (meth)acrylic acid compound. Further, a (meth)acrylic polymer consisting of a copolymer of the (meth)acrylic compound (M4) and the other polymerizable compound (M3) is also preferable. Examples of the (meth)acrylic acid ester compound include a (meth)acrylic acid alkyl ester compound, and the carbon number thereof is not particularly limited; however, it can be set to, for example, 1 to 24, and it is preferably 3 to 20, more preferably 4 to 16, and still more preferably 6 to 14. In addition, two or more kinds of (meth)acrylic acid alkyl ester compounds can also be used, which includes, for example, a combination of a (meth)acrylic acid ester compound having the above-described single-chain or cyclic alkyl group and a (meth)acrylic acid ester compound having the above-described alkyl group and a combination of a (meth)acrylic acid ester compound having the above-described alkyl group and an acrylamide compound. The other polymerizable compound (M3) is not particularly limited, and examples thereof include vinyl compounds such as a styrene compound, a vinyl naphthalene compound, a vinyl carbazole compound, an allyl compound, a vinyl ether compound, a vinyl ester compound, a dialkyl itaconate compound, and an unsaturated carboxylic acid anhydride. Examples of the vinyl compound include the “vinyl-based monomer” disclosed in JP2015-88486A.

The content of a constitutional component derived from a (meth)acrylic compound in the (meth)acrylic polymer is preferably the same as the content of the constitutional component derived from the (meth)acrylic compound (M1) in the (meth)acrylic polymer. In addition, the content of the other polymerizable compound (M3) in the (meth)acrylic polymer is not particularly limited; however, it can be, for example, less than 50% by mole or less than 50% by mass.

The content of the chain polymerization polymer binder PB3 in the inorganic solid electrolyte-containing composition is not particularly limited. However, it is preferably 0.02% to 15.0% by mass, more preferably 0.05% to 10.0% by mass, and still more preferably 0.1% to 7.0% by mass, in the solid content of 100% by mass, in that dispersion stability, handleability, and the adhesiveness of the collector can be improved in a well-balanced manner.

(Combination of Polymer Binder PB)

As described above, it suffices that the polymer binder PB contained in the inorganic solid electrolyte-containing composition according to the embodiment of the present invention contains at least one kind of low adsorption binder, and the polymer binder PB1 may contain two or more kinds thereof.

Examples of the aspect in which the polymer binder includes the low adsorption binder PB1 include an aspect in which the low adsorption binder PB1 is contained alone, an aspect in which two or more kinds of low adsorption binders PB1 are contained, an aspect in which one or two or more low adsorption binders PB1 and a particulate binder PB2 are contained, and furthermore, an aspect in which a chain polymerization polymer binder PB3 is further contained in each of the aspects. An aspect in which one or two or more low adsorption binders PB1 and one or two or more chain polymerization polymer binders PB3 are included is preferable. In each of the above-described aspects, the specific combination of the respective polymer binders is not particularly limited, and it is preferably a combination between preferred polymer binders of the respective polymer binders.

In the present invention, it suffices that the chain polymerization polymer binder PB3 included in the polymer binder PB is at least one of a hydrocarbon polymer binder, a vinyl polymer binder, or a (meth)acrylic polymer binder, where a (meth)acrylic polymer binder is preferable.

<Dispersion Medium>

The inorganic solid electrolyte-containing composition according to the embodiment of the present invention contains a dispersion medium for dispersing or dissolving each of the above components.

It suffices that the dispersion medium is an organic compound that is in a liquid state in the use environment, examples thereof include various organic solvents, and specific examples thereof include an alcohol compound, an ether compound, an amide compound, an amine compound, a ketone compound, an aromatic compound, an aliphatic compound, a nitrile compound, and an ester compound.

The dispersion medium may be a non-polar dispersion medium (a hydrophobic dispersion medium) or a polar dispersion medium (a hydrophilic dispersion medium); however, a non-polar dispersion medium is preferable from the viewpoint that excellent dispersibility can be exhibited. The non-polar dispersion medium generally refers to a dispersion medium having a property of a low affinity to water; however, in the present invention, examples thereof include an ester compound, a ketone compound, an ether compound, an aromatic compound, and an aliphatic compound. Among them, preferred examples thereof include a ketone compound, an aliphatic compound, and an ester compound.

Examples of the alcohol compound include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of the ether compound include an alkylene glycol (diethylene glycol, triethylene glycol, polyethylene glycol, dipropylene glycol, or the like), an alkylene glycol monoalkyl ether (ethylene glycol monomethyl ether, ethylene glycol monobutyl ether, diethylene glycol monomethyl ether, propylene glycol monomethyl ether, dipropylene glycol monomethyl ether, tripropylene glycol monomethyl ether, diethylene glycol monobutyl ether, or the like), alkylene glycol dialkyl ether (ethylene glycol dimethyl ether or the like), a dialkyl ether (dimethyl ether, diethyl ether, diisopropyl ether, dibutyl ether, or the like), and a cyclic ether (tetrahydrofuran, dioxane (including 1,2-, 1,3- or 1,4-isomer), or the like).

Examples of the amide compound include N,N-dimethylformamide, N-methyl-2-pyrrolidone, 2-pyrrolidinone, 1,3-dimethyl-2-imidazolidinone, F-caprolactam, formamide, N-methylformamide, acetamide, N-methylacetamide, N,N-dimethylacetamide, N-methylpropanamide, and hexamethylphosphoric triamide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic compound include benzene, toluene, xylene, and perfluorotoluene.

Examples of the aliphatic compound include hexane, heptane, octane, nonane, decane, dodecane, cyclohexane, methylcyclohexane, ethylcyclohexane, cycloheptane, cyclooctane, decalin, paraffin, gasoline, naphtha, kerosene, and light oil.

Examples of the nitrile compound include acetonitrile, propionitrile, and isobutyronitrile.

Examples of the ester compound include ethyl acetate, propyl acetate, butyl acetate, ethyl butyrate, propyl butyrate, isopropyl butyrate, butyl butyrate, isobutyl butyrate, butyl pentanoate, pentyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among them, an ether compound, a ketone compound, an aromatic compound, an aliphatic compound, or an ester compound is preferable, and an ester compound, a ketone compound, an aromatic compound, or an ether compound is more preferable.

The number of carbon atoms of the compound that constitutes the dispersion medium is not particularly limited, and it is preferably 2 to 30, more preferably 4 to 20, still more preferably 6 to 15, and particularly preferably 7 to 12.

The dispersion medium preferably has a boiling point of 50° C. or higher and more preferably 70° C. or higher at normal pressure (1 atm). The upper limit thereof is preferably 250° C. or lower and more preferably 220° C. or lower.

It suffices that the inorganic solid electrolyte-containing composition according to the embodiment of the present invention contains at least one kind of dispersion medium, and it may contain two or more kinds thereof. Examples of the example thereof in which two or more kinds of dispersion media are contained include mixed xylene (a mixture of o-xylene, p-xylene, m-xylene, and ethylbenzene).

In the present invention, the content of the dispersion medium in the inorganic solid electrolyte-containing composition is not particularly limited and can be appropriately set. For example, in the inorganic solid electrolyte-containing composition, it is preferably 20% to 80% by mass, more preferably 30% to 70% by mass, and particularly preferably 40% to 60% by mass.

<Active Material>

The inorganic solid electrolyte-containing composition according to the embodiment of the present invention preferably contains an active material capable of intercalating and deintercalating an ion of a metal belonging to Group 1 or Group 2 of the periodic table. Examples of such active materials include a positive electrode active material and a negative electrode active material, which will be described later.

In the present invention, the inorganic solid electrolyte-containing composition containing an active material (a positive electrode active material or a negative electrode active material) may be referred to as an electrode composition (a positive electrode composition or a negative electrode composition).

(Positive Electrode Active Material)

The positive electrode active material is an active material capable of intercalating and deintercalating an ion of a metal belonging to Group 1 or Group 2 of the periodic table, and it is preferably one capable of reversibly intercalating and deintercalating a lithium ion. The above-described material is not particularly limited as long as the material has the above-described characteristics and may be a transition metal oxide, an organic substance, or an element, which is capable of being complexed with Li, such as sulfur or the like by disassembling the battery.

Among the above, as the positive electrode active material, transition metal oxides are preferably used, and transition metal oxides having a transition metal element M^{a} (one or more elements selected from Co, Ni, Fe, Mn, Cu, and V) are more preferable. In addition, an element M^{b} (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The mixing amount thereof is preferably 0% to 30% by mole of the amount (100% by mole) of the transition metal element M^{a}. It is more preferable that the transition metal oxide is synthesized by mixing the above components such that a molar ratio Li/M^{a} is 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), and lithium-containing transition metal silicate compounds (ME).

Specific examples of the transition metal oxides having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄(LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON type vanadium phosphate salt such as Li₃V₂(PO₄)₃(lithium vanadium phosphate).

Examples of the lithium-containing transition metal halogenated phosphoric acid compound (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

The shape of the positive electrode active material is not particularly limited but is preferably a particle shape. The particle diameter (the volume average particle diameter) of the positive electrode active material is not particularly limited. For example, it can be set to 0.1 to 50 μm. The particle diameter of the positive electrode active material particle can be measured using the same method as that of the particle diameter of the inorganic solid electrolyte. In order to allow the positive electrode active material to have a predetermined particle diameter, a general pulverizer or classifier is used. For example, a mortar, a ball mill, a sand mill, a vibration ball mill, a satellite ball mill, a planetary ball mill, a swirling air flow jet mill, or a sieve is suitably used. During pulverization, it is also possible to carry out wet-type pulverization in which water or a dispersion medium such as methanol is made to be present together. In order to provide the desired particle diameter, classification is preferably carried out. The classification is not particularly limited and can be carried out using a sieve, a wind power classifier, or the like. Both the dry-type classification and the wet-type classification can be carried out.

A positive electrode active material obtained using a baking method may be used after being washed with water, an acidic aqueous solution, an alkaline aqueous solution, or an organic solvent.

The positive electrode active material may be used singly, or two or more thereof may be used in combination.

The content of the positive electrode active material in the inorganic solid electrolyte-containing composition is not particularly limited; however, it is preferably 10% to 97% by mass, more preferably 30% to 95% by mass, still more preferably 40% to 93% by mass, and particularly preferably 50% to 90% by mass, in 100% by mass of the solid content.

(Negative Electrode Active Material)

The negative electrode active material is an active material capable of intercalating and deintercalating an ion of a metal belonging to Group 1 or Group 2 of the periodic table, and it is preferably one capable of reversibly intercalating and deintercalating a lithium ion. The material is not particularly limited as long as it has the above-described characteristics, and examples thereof include a carbonaceous material, a metal oxide, a metal composite oxide, a lithium single body, a lithium alloy, and a negative electrode active material that is capable of forming an alloy (capable of being alloyed) with lithium. Among the above, a carbonaceous material, a metal composite oxide, or a lithium single body is preferably used from the viewpoint of reliability. An active material that is capable of being alloyed with lithium is preferable since the capacity of the all-solid state secondary battery can be increased.

The carbonaceous material that is used as the negative electrode active material is a material substantially consisting of carbon. Examples thereof include petroleum pitch, carbon black such as acetylene black (AB), graphite (natural graphite, artificial graphite such as vapor-grown graphite), and carbonaceous material obtained by baking a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the surface spacing, density, and crystallite size described in JP1987-22066A (JP-S62-22066A), JP1990-6856A (JP-H2-6856A), and JP1991-45473A (JP-H3-45473A). The carbonaceous material is not necessarily a single material and, for example, may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element that can be used as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element (collectively referred to as “metal composite oxide), and an oxide of a metalloid element (a metalloid oxide). The oxides are more preferably noncrystalline oxides, and preferred examples thereof include chalcogenides which are reaction products between metal elements and elements in Group 16 of the periodic table. In the present invention, the metalloid element refers to an element having intermediate properties between those of a metal element and a non-metal element. Typically, the metalloid elements include six elements including boron, silicon, germanium, arsenic, antimony, and tellurium, and further include three elements including selenium, polonium, and astatine. In addition, “noncrystalline” represents an oxide having a broad scattering band with an apex in a range of 20° to 40° in terms of 20 value in a case of being measured by an X-ray diffraction method using CuKα rays, and the oxide may have a crystalline diffraction line. The highest intensity in a crystalline diffraction line observed in a range of 40° to 70° in terms of 20 value is preferably 100 times or less and more preferably 5 times or less with respect to the intensity of a diffraction line at the apex in a broad scattering band observed in a range of 20° to 40° in terms of 20 value, and it is particularly preferable that the oxide does not have a crystalline diffraction line.

In the compound group consisting of the noncrystalline oxides and the chalcogenides, noncrystalline oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Group 13 (IIIB) to Group 15 (VB) in the periodic table or chalcogenides are particularly preferable. Specific examples of the preferred noncrystalline oxide and chalcogenide preferably include Ga₂O₃, GeO, PbO, PbO₂, Pb₂O₃, Pb₂O₄, Pb₃O₄, Sb₂O₃, Sb₂O₄, Sb₂OBi₂O₃, Sb₂O₈Si₂O₃, Sb₂O₅, Bi₂O₃, Bi₂O₄, GeS, PbS, PbS₂, Sb₂S₃, and Sb₂S₅.

Suitable examples of the negative electrode active material which can be used in combination with a noncrystalline oxide containing Sn, Si, or Ge as a major component include a carbonaceous material capable of intercalating and/or deintercalating lithium ions or lithium metal, a lithium single body, a lithium alloy, and a negative electrode active material that is capable of being alloyed with lithium.

It is preferable that an oxide of a metal or a metalloid element, in particular, a metal (composite) oxide and the chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄Ti₅O₁₂ (lithium titanium oxide [LTO]) is preferable since the volume variation during the intercalation and deintercalation of lithium ions is small, and thus the high-speed charging and discharging characteristics are excellent, and the deterioration of electrodes is suppressed, whereby it is possible to improve the life of the lithium ion secondary battery.

The lithium alloy as the negative electrode active material is not particularly limited as long as it is typically used as a negative electrode active material for a secondary battery, and examples thereof include a lithium aluminum alloy, and specifically, a lithium aluminum alloy, using lithium as a base metal, to which 10% by mass of aluminum is added.

The negative electrode active material capable of forming an alloy with lithium is not particularly limited as long as it is typically used as a negative electrode active material for a secondary battery. Such an active material has a large expansion and contraction due to charging and discharging of the all-solid state secondary battery and accelerates the deterioration of the cycle characteristics. However, since the inorganic solid electrolyte-containing composition according to the embodiment of the present invention contains the polymer binder described above, and thus it is possible to suppress the deterioration of the cycle characteristics. Examples of such an active material include a (negative electrode) active material (an alloy or the like) having a silicon element or a tin element and a metal such as Al or In, a negative electrode active material (a silicon element-containing active material) having a silicon element capable of exhibiting higher battery capacity is preferable, and a silicon element-containing active material in which the content of the silicon element is 50% by mole or more with respect to all the constitutional elements is more preferable.

In general, a negative electrode including the negative electrode active material (for example, a Si negative electrode including a silicon element-containing active material or an Sn negative electrode containing an active material containing a tin element) can intercalate a larger amount of Li ions than a carbon negative electrode (for example, graphite or acetylene black). That is, the amount of Li ions intercalated per unit mass increases. As a result, the battery capacity (the energy density) can be increased. As a result, there is an advantage in that the battery driving duration can be extended.

Examples of the silicon element-containing active material include a silicon-containing alloy (for example, LaSi₂, VSi₂, La—Si, Gd—Si, or Ni—Si) including a silicon material such as Si or SiOx (0<x≤1) and titanium, vanadium, chromium, manganese, nickel, copper, lanthanum, or the like or a structured active material thereof (for example, LaSi₂/Si), and an active material such as SnSiO₃ or SnSiS₃ including silicon element and tin element. In addition, since SiOx itself can be used as a negative electrode active material (a metalloid oxide) and Si is produced along with the operation of an all-solid state secondary battery, SiOx can be used as a negative electrode active material (or a precursor material thereof) capable of being alloyed with lithium.

Examples of the negative electrode active material including the tin element include Sn, SnO, SnO₂, SnS, SnS₂, and the above-described active material including silicon element and tin element. In addition, a composite oxide with lithium oxide, for example, Li₂SnO₂ can also be used.

In the present invention, the above-described negative electrode active material can be used without any particular limitation. From the viewpoint of battery capacity, a preferred aspect as the negative electrode active material is a negative electrode active material that is capable of being alloyed with lithium. Among them, the silicon material or the silicon-containing alloy (the alloy containing a silicon element) described above is more preferable, and it is still more preferable to include a negative electrode active material containing silicon (Si) or a silicon-containing alloy.

The chemical formulae of the compounds obtained by the above baking method can be calculated using an inductively coupled plasma (ICP) emission spectroscopy as a measuring method from the mass difference of powder before and after baking as a convenient method.

The shape of the negative electrode active material is not particularly limited but is preferably a particle shape. The particle diameter (the volume average particle diameter) of the negative electrode active material is not particularly limited; however, it is preferably 0.1 to 60 m. The particle diameter of the negative electrode active material particle can be measured using the same method as that of the particle diameter of the inorganic solid electrolyte. In order to obtain the predetermined particle diameter, a general pulverizer or classifier is used as in the case of the positive electrode active material.

The negative electrode active material may be used singly, or two or more negative electrode active materials may be used in combination.

The content of the negative electrode active material in the inorganic solid electrolyte-containing composition is not particularly limited, and it is preferably 10% to 90% by mass, more preferably 20% to 85% by mass, still more preferably 30% to 80% by mass, and even still more preferably 40% to 75% by mass, in 100% by mass of the solid content.

In the present invention, in a case where a negative electrode active material layer is formed by charging a secondary battery, ions of a metal belonging to Group 1 or Group 2 in the periodic table, generated in the all-solid state secondary battery, can be used instead of the negative electrode active material. By bonding the ions to electrons and precipitating a metal, a negative electrode active material layer can be formed.

(Coating of Active Material)

The surfaces of the positive electrode active material and the negative electrode active material may be subjected to surface coating with another metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, the surface of the electrode containing the positive electrode active material or negative electrode active material may be subjected to a surface treatment with sulfur or phosphorus.

Further, the particle surface of the positive electrode active material or negative electrode active material may be subjected to a surface treatment with an actinic ray or an active gas (plasma or the like) before and after the surface coating.

<Conductive Auxiliary Agent>

The inorganic solid electrolyte-containing composition according to the embodiment of the present invention preferably contains a conductive auxiliary agent, and for example, it is preferable that the silicon atom-containing active material as the negative electrode active material is used in combination with a conductive auxiliary agent.

The conductive auxiliary agent is not particularly limited, and conductive auxiliary agents that are known as ordinary conductive auxiliary agents can be used. It may be, for example, graphite such as natural graphite and artificial graphite, carbon black such as acetylene black, Ketjen black, and furnace black, amorphous carbon such as needle cokes, carbon fibers such as a vapor-grown carbon fiber and a carbon nanotube, or a carbonaceous material such as graphene or fullerene, which are electron-conductive materials, and it may be also a metal powder or metal fiber of copper, nickel, or the like. A conductive polymer such as polyaniline, polypyrrole, polythiophene, polyacetylene, or a polyphenylene derivative may also be used.

In the present invention, in a case where the active material is used in combination with the conductive auxiliary agent, among the above-described conductive auxiliary agents, a conductive auxiliary agent that does not intercalate and deintercalate ions (preferably Li ions) of a metal belonging to Group 1 or Group 2 in the periodic table and does not function as an active material at the time when a battery has been charged and discharged is classified as the conductive auxiliary agent. Therefore, among the conductive auxiliary agents, a conductive auxiliary agent that can function as the active material in the active material layer at the time when a battery has been charged and discharged is classified as an active material but not as a conductive auxiliary agent. Whether or not the conductive auxiliary agent functions as the active material at the time when a battery is charged and discharged is not unambiguously determined but is determined by the combination with the active material.

One kind of conductive auxiliary agent may be contained, or two or more kinds thereof may be contained.

The shape of the conductive auxiliary agent is not particularly limited but is preferably a particle shape.

In a case where the inorganic solid electrolyte-containing composition according to the embodiment of the present invention contains a conductive auxiliary agent, the content of the conductive auxiliary agent in the inorganic solid electrolyte-containing composition is preferably 0% to 10% by mass in 100% by mass of the solid content.

<Lithium Salt>

The inorganic solid electrolyte-containing composition according to the embodiment of the present invention preferably contains a lithium salt (a supporting electrolyte) as well.

Generally, the lithium salt is preferably a lithium salt that is used for this kind of product and is not particularly limited. For example, lithium salts described in paragraphs 0082 to 0085 of JP2015-088486A are preferable.

In a case where the inorganic solid electrolyte-containing composition according to the embodiment of the present invention contains a lithium salt, the content of the lithium salt is preferably 0.1 parts by mass or more and more preferably 5 parts by mass or more with respect to 100 parts by mass of the solid electrolyte. The upper limit thereof is preferably 50 parts by mass or less and more preferably 20 parts by mass or less.

<Dispersing Agent>

Since the above-described low adsorption binder PB1 functions as a dispersing agent as well, the inorganic solid electrolyte-containing composition according to the embodiment of the present invention may not contain a dispersing agent other than this low adsorption binder PB1; however, it may contain a dispersing agent. As the dispersing agent, a dispersing agent that is generally used for an all-solid state secondary battery can be appropriately selected and used. Generally, a compound intended for particle adsorption and steric repulsion and/or electrostatic repulsion is suitably used.

<Other Additives>

As components other than the respective components described above, the inorganic solid electrolyte-containing composition according to the embodiment of the present invention may appropriately contain an ionic liquid, a thickener, a crosslinking agent (an agent causing a crosslinking reaction by radical polymerization, condensation polymerization, or ring-opening polymerization), a polymerization initiator (an agent that generates an acid or a radical by heat or light), an antifoaming agent, a leveling agent, a dehydrating agent, or an antioxidant. The ionic liquid is contained in order to further improve the ion conductivity, and the known one in the related art can be used without particular limitation. In addition, a polymer other than the binder forming polymer described above, a typically used binding agent, or the like may be contained.

(Preparation of Inorganic Solid Electrolyte-Containing Composition)

The inorganic solid electrolyte-containing composition according to the embodiment of the present invention can be prepared by mixing an inorganic solid electrolyte, the above-described polymer binder PB, a dispersion medium, preferably, a conductive auxiliary agent, and further appropriately a lithium salt, and any other optional components, as a mixture and preferably as a slurry by using, for example, various mixers that are used generally. In a case of an electrode composition, an active material is further mixed.

The mixing method is not particularly limited, and it can be carried out using a known mixer such as a ball mill, a beads mill, a planetary mixer, a blade mixer, a roll mill, a kneader, a disc mill, a self-rotation type mixer, or a narrow gap type disperser. Each component may be mixed collectively or may be mixed sequentially. A mixing environment is not particularly limited; however, examples thereof include a dry air environment and an inert gas environment.

In addition, the mixing conditions are not particularly limited and are appropriately set.

[Sheet for all-Solid State Secondary Battery]

A sheet for an all-solid state secondary battery according to the embodiment of the present invention is a sheet-shaped molded body with which a constitutional layer of an all-solid state secondary battery can be formed, and it includes various aspects depending on use applications thereof. Examples of thereof include a sheet that is preferably used in a solid electrolyte layer (also referred to as a solid electrolyte sheet for an all-solid state secondary battery) and a sheet that is preferably used in an electrode or a laminate of an electrode and a solid electrolyte layer (an electrode sheet for an all-solid state secondary battery). In the present invention, the variety of sheets described above will be collectively referred to as a sheet for an all-solid state secondary battery.

In the present invention, each layer that constitutes a sheet for an all-solid state secondary battery may have a monolayer structure or a multilayer structure.

In the sheet for an all-solid state secondary battery, the solid electrolyte layer or the active material layer on the base material is formed of the inorganic solid electrolyte-containing composition according to the embodiment of the present invention. As a result, in a case where this sheet for an all-solid state secondary battery is used as a solid electrolyte layer of an all-solid state secondary battery by appropriately peeling the base material therefrom or used as an electrode (a laminate of a collector and an active material layer) as it is, the cycle characteristics and the conductivity (the lower resistance) of the all-solid state secondary battery can be improved.

It suffices that the solid electrolyte sheet for an all-solid state secondary battery according to the embodiment of the present invention is a sheet having a solid electrolyte layer, and it may be a sheet in which a solid electrolyte layer is formed on a base material or may be a sheet (a sheet from which the base material has been peeled off) that is formed of a solid electrolyte layer without including a base material. The solid electrolyte sheet for an all-solid state secondary battery may include another layer in addition to the solid electrolyte layer. Examples of the other layer include a protective layer (a stripping sheet), a collector, and a coating layer. Examples of the solid electrolyte sheet for an all-solid state secondary battery according to the embodiment of the present invention include a sheet including a layer formed of the inorganic solid electrolyte-containing composition according to the embodiment of the present invention, a typical solid electrolyte layer, and a protective layer on a base material in this order. The solid electrolyte layer included in the solid electrolyte sheet for an all-solid state secondary battery is formed of the inorganic solid electrolyte-containing composition according to the embodiment of the present invention. The content of each component in the solid electrolyte layer is not particularly limited; however, it preferably has the same as the content of each component in the solid content of the inorganic solid electrolyte-containing composition according to the embodiment of the present invention. The layer thickness of each layer that constitutes the solid electrolyte sheet for an all-solid state secondary battery is the same as the layer thickness of each layer described later in the all-solid state secondary battery.

The base material is not particularly limited as long as it can support the solid electrolyte layer, and examples thereof include a sheet body (plate-shaped body) formed of materials described later regarding the collector, an organic material, an inorganic material, or the like. Examples of the organic material include various polymers, and specific examples thereof include polyethylene terephthalate, polypropylene, polyethylene, and cellulose. Examples of the inorganic materials include glass and ceramic.

It suffices that an electrode sheet for an all-solid state secondary battery according to the embodiment of the present invention (simply also referred to as an “electrode sheet”) is an electrode sheet including an active material layer, and it may be a sheet in which an active material layer is formed on a base material (collector) or may be a sheet (a sheet from which the base material has been peeled off) that is formed of an active material layer without including a base material. The electrode sheet is typically a sheet including the collector and the active material layer, and examples of an aspect thereof include an aspect including the collector, the active material layer, and the solid electrolyte layer in this order and an aspect including the collector, the active material layer, the solid electrolyte layer, and the active material layer in this order. The solid electrolyte layer and the active material layer included in the electrode sheet are preferably formed of the inorganic solid electrolyte-containing composition according to the embodiment of the present invention. The content of each component in this solid electrolyte layer or active material layer is not particularly limited; however, it preferably has the same meaning as the content of each component in the solid content of the inorganic solid electrolyte-containing composition (the electrode composition) according to the embodiment of the present invention. The layer thickness of each of the layers forming the electrode sheet according to the embodiment of the present invention is the same as the layer thickness of each of the layers described later regarding the all-solid state secondary battery. The electrode sheet may include the above-described other layer.

It is noted that in a case where the solid electrolyte layer or the active material layer is not formed of the inorganic solid electrolyte-containing composition according to the embodiment of the present invention, it is formed of a general constitutional layer forming material.

In the sheet for an all-solid state secondary battery according to the embodiment of the present invention, at least one layer of the solid electrolyte layer or the active material layer is formed of the inorganic solid electrolyte-containing composition according to the embodiment of the present invention, and a constitutional layer having a flat surface, where solid particles are firmly bound to each other, while suppressing the increase in interface resistance between solid particles is included. As a result, in a case where the sheet for an all-solid state secondary battery according to the embodiment of the present invention is used as a constitutional layer of the all-solid state secondary battery, it is possible to realize the lower resistance (the high conductivity) of the all-solid state secondary battery and excellent cycle characteristics. In particular, in the electrode sheet for an all-solid state secondary battery and the all-solid state secondary battery, in which the active material layer is formed of the inorganic solid electrolyte-containing composition according to the embodiment of the present invention, the active material layer and the collector exhibit firm adhesiveness, and thus it is possible to realize further improvement of the cycle characteristics. As a result, the sheet for an all-solid state secondary battery according to the embodiment of the present invention is suitably used as a sheet with which a constitutional layer of an all-solid state secondary battery can be formed.

In addition, since a constitutional layer in which solid particles are firmly bound can be formed, the sheet for an all-solid state secondary battery according to the embodiment of the present invention can be produced by industrial manufacturing in which external stress is likely to act, for example, by a roll-to-roll method having high productivity.

[Manufacturing Method for Sheet for all-Solid State Secondary Battery]

The manufacturing method for a sheet for an all-solid state secondary battery according to the embodiment of the present invention is not particularly limited, and the sheet can be manufactured by forming each of the above layers using the inorganic solid electrolyte-containing composition according to the embodiment of the present invention. Examples thereof include a method in which the film formation (the coating and drying) is carried out preferably on a base material or a collector (another layer may be interposed) to form a layer (a coated and dried layer) consisting of an inorganic solid electrolyte-containing composition. This method makes it possible to produce a sheet for an all-solid state secondary battery having a base material or a collector and having a coated and dried layer. In particular, in a case where a film of the inorganic solid electrolyte-containing composition according to the embodiment of the present invention is formed on a collector to produce a sheet for an all-solid state secondary battery, it is possible to reinforce the adhesion between the collector and the active material layer. Here, the coated and dried layer refers to a layer formed by carrying out coating with the inorganic solid electrolyte-containing composition according to the embodiment of the present invention and drying the dispersion medium (that is, a layer formed using the inorganic solid electrolyte-containing composition according to the embodiment of the present invention and consisting of a composition obtained by removing the dispersion medium from the inorganic solid electrolyte-containing composition according to the embodiment of the present invention). In the active material layer and the coated and dried layer, the dispersion medium may remain within a range where the effect of the present invention is not impaired, and the residual amount thereof, for example, in each of the layers may be 3% by mass or lower.

In the manufacturing method for a sheet for an all-solid state secondary battery according to the embodiment of the present invention, each of the steps such as coating and drying will be described in the following manufacturing method for an all-solid state secondary battery.

In the manufacturing method for a sheet for an all-solid state secondary battery according to the embodiment of the present invention, the coated and dried layer obtained as described above can be pressurized. The pressurizing condition and the like will be described later in the section of the manufacturing method for an all-solid state secondary battery.

In addition, in the manufacturing method for a sheet for an all-solid state secondary battery according to the embodiment of the present invention, the base material, the protective layer (particularly stripping sheet), or the like can also be peeled off.

[All-Solid State Secondary Battery]

The all-solid state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The all-solid state secondary battery according to the embodiment of the present invention is not particularly limited in the configuration as long as it has a solid electrolyte layer between the positive electrode active material layer and the negative electrode active material layer, and for example, a known configuration for an all-solid state secondary battery can be employed. The positive electrode active material layer is preferably formed on a positive electrode collector to configure a positive electrode. The negative electrode active material layer is preferably formed on a negative electrode collector to configure a negative electrode.

In the present invention, each constitutional layer (including a collector and the like) that constitutes an all-solid state secondary battery may have a monolayer structure or a multilayer structure.

<Positive Electrode Active Material Layer, Solid Electrolyte Layer, and Negative Electrode Active Material Layer>

The solid electrolyte layer contains an inorganic solid electrolyte having an ion conductivity of a metal belonging to Group 1 or Group 2 in the periodic table, a polymer binder PB, any component described above, and the like within a range where the effect of the present invention is not impaired, and it generally does not contain a positive electrode active material and/or a negative electrode active material.

The positive electrode active material layer contains an inorganic solid electrolyte having an ion conductivity of a metal belonging to Group 1 or Group 2 in the periodic table, a polymer binder PB, a positive electrode active material, and any component described above or the like within a range where the effect of the present invention is not impaired.

The negative electrode active material layer contains an inorganic solid electrolyte having an ion conductivity of a metal belonging to Group 1 or Group 2 in the periodic table, a polymer binder PB, a negative electrode active material, and any component described above or the like within a range where the effect of the present invention is not impaired.

In the all-solid state secondary battery according to the embodiment of the present invention, at least one layer of the negative electrode active material layer, the positive electrode active material layer, or the solid electrolyte layer is formed of the inorganic solid electrolyte-containing composition according to the embodiment of the present invention, and at least one of the solid electrolyte layer, the negative electrode active material layer, or the positive electrode active material layer is preferably formed of the inorganic solid electrolyte-containing composition according to the embodiment of the present invention. An aspect in which all of the layers are formed of the inorganic solid electrolyte-containing composition according to the embodiment of the present invention is also one of the preferred aspects. In the present invention, forming the constitutional layer of the all-solid state secondary battery by using the inorganic solid electrolyte-containing composition according to the embodiment of the present invention includes an aspect in which the constitutional layer is formed by using the sheet for an all-solid state secondary battery according to the embodiment of the present invention (however, in a case where a layer other than the layer formed of the inorganic solid electrolyte-containing composition according to the embodiment of the present invention is provided, a sheet from which this layer is removed).

In the active material layer or the solid electrolyte layer formed of the inorganic solid electrolyte-containing composition according to the embodiment of the present invention, the kinds of components to be contained and the contents thereof are preferably the same as the solid content of the inorganic solid electrolyte-containing composition according to the embodiment of the present invention. In a case where the active material layer or the solid electrolyte layer is not formed of the inorganic solid electrolyte-containing composition according to the embodiment of the present invention, a known material in the related art can be used.

The thickness of each of the negative electrode active material layer, the solid electrolyte layer, and the positive electrode active material layer is not particularly limited. In a case of taking a dimension of a general all-solid state secondary battery into account, the thickness of each of the layers is preferably 10 to 1,000 μm and more preferably 20 μm or more and less than 500 μm. In the all-solid state secondary battery according to the embodiment of the present invention, the thickness of at least one layer of the positive electrode active material layer or the negative electrode active material layer is still more preferably 50 μm or more and less than 500 μm.

Each of the positive electrode active material layer and the negative electrode active material layer may include a collector on the side opposite to the solid electrolyte layer.

<Collector>

The positive electrode collector and the negative electrode collector are preferably an electron conductor.

In the present invention, either or both of the positive electrode collector and the negative electrode collector will also be simply referred to as the collector.

As a material that forms the positive electrode collector, not only aluminum, an aluminum alloy, stainless steel, nickel, or titanium but also a material (a material on which a thin film has been formed) obtained by treating the surface of aluminum or stainless steel with carbon, nickel, titanium, or silver is preferable. Among these, aluminum or an aluminum alloy is more preferable.

As a material that forms the negative electrode collector, aluminum, copper, a copper alloy, stainless steel, nickel, titanium, or the like, and further, a material obtained by treating the surface of aluminum, copper, a copper alloy, or stainless steel with carbon, nickel, titanium, or silver is preferable, and aluminum, copper, a copper alloy, or stainless steel is more preferable.

Regarding the shape of the collector, a film sheet shape is typically used; however, it is also possible to use shapes such as a net shape, a punched shape, a lath body, a porous body, a foaming body, and a molded body of a fiber group.

The thickness of the collector is not particularly limited; however, it is preferably 1 to 500 μm. In addition, protrusions and recesses are preferably provided on the surface of the collector by carrying out a surface treatment.

<Other Configurations>

In the present invention, a functional layer, a functional member, or the like may be appropriately interposed or disposed between or on the outside of the respective layers of the negative electrode collector, the negative electrode active material layer, the solid electrolyte layer, the positive electrode active material layer, and the positive electrode collector.

<Housing>

Depending on the use application, the all-solid state secondary battery according to the embodiment of the present invention may be used as the all-solid state secondary battery having the above-described structure as it is but is preferably sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

<Preferred Embodiment of all-Solid State Secondary Battery>

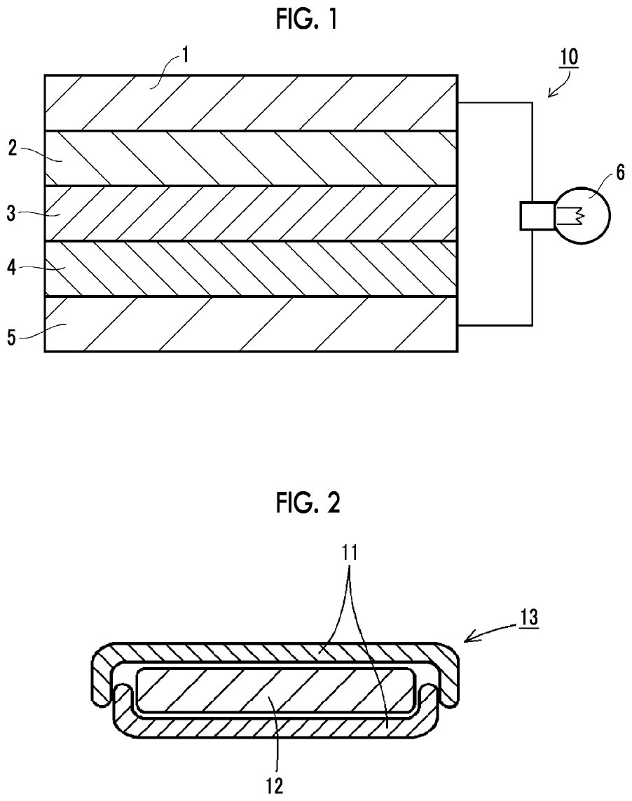

Hereinafter, the all-solid state secondary battery according to the preferred embodiment of the present invention will be described with reference to FIG. 1; however, the present invention is not limited thereto.

FIG. 1 is a cross-sectional view schematically illustrating an all-solid state secondary battery (a lithium ion secondary battery) according to a preferred embodiment of the present invention. In a case of being seen from the negative electrode side, an all-solid state secondary battery 10 of the present embodiment includes a negative electrode collector 1, a negative electrode active material layer 2, a solid electrolyte layer 3, a positive electrode active material layer 4, and a positive electrode collector 5 in this order. The respective layers are in contact with each other, and thus structures thereof are adjacent. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated in the negative electrode return to the positive electrode side, and electrons are supplied to an operation portion 6. In an example illustrated in the drawing, an electric bulb is employed as a model at the operation portion 6 and is lit by discharging.

In a case where the all-solid state secondary battery having a layer configuration illustrated in FIG. 1 is put into a 2032-type coin case (for example, see FIG. 2), the all-solid state secondary battery will be referred to as a laminate 12 for an all-solid state secondary battery, and a battery produced by putting this laminate 12 for an all-solid state secondary battery into a 2032-type coin case 11 will be referred to as a (coin type) all-solid state secondary battery 13, thereby referring to both batteries distinctively in some cases.

(Positive Electrode Active Material Layer, Solid Electrolyte Layer, and Negative Electrode Active Material Layer)

In the all-solid state secondary battery 10, all of the positive electrode active material layer, the solid electrolyte layer, and the negative electrode active material layer are formed of the inorganic solid electrolyte-containing composition of the embodiment of the present invention. This all-solid state secondary battery 10 can realize excellent battery performance, that is, excellent cycle characteristics with low resistance. The kinds of the inorganic solid electrolyte and the polymer binder which are contained in the positive electrode active material layer 4, the solid electrolyte layer 3, and the negative electrode active material layer 2 may be identical to or different from each other.

In the present invention, any one of the positive electrode active material layer and the negative electrode active material layer, or collectively both of them may be simply referred to as an active material layer or an electrode active material layer. In addition, any one of the positive electrode active material and the negative electrode active material, or collectively both of them may be simply referred to as an active material or an electrode active material.

In the all-solid state secondary battery 10, the negative electrode active material layer can be a lithium metal layer. Examples of the lithium metal layer include a layer formed by depositing or molding a lithium metal powder, a lithium foil, and a lithium vapor deposition film. The thickness of the lithium metal layer can be, for example, 1 to 500 μm regardless of the above thickness of the above negative electrode active material layer.

In a case where the all-solid state secondary battery 10 has a constitutional layer other than the constitutional layer formed of the inorganic solid electrolyte-containing composition according to the embodiment of the present invention, a layer formed of a known constitutional layer forming material can also be applied.

In the present invention, in a case where a constitutional layer is formed of the inorganic solid electrolyte-containing composition according to the embodiment of the present invention, it is possible to realize an all-solid state secondary battery having excellent cycle characteristics and having low resistance even in a case of being manufactured by a roll-to-roll method which is advantageous industrially.

(Collector)

The positive electrode collector 5 and the negative electrode collector 1 are as described above.

[Manufacture of all-Solid State Secondary Battery]

The all-solid state secondary battery can be manufactured by a conventional method. Specifically, the all-solid state secondary battery can be manufactured by forming each of the layers described above using the inorganic solid electrolyte-containing composition of the embodiment of the present invention or the like. Hereinafter, the manufacturing method therefor will be described in detail.

The all-solid state secondary battery according to the embodiment of the present invention can be manufactured by carrying out a method (a manufacturing method for a sheet for an all-solid state secondary battery according to the embodiment of the present invention) which includes (is carried out through) a step of coating an appropriate base material (for example, a metal foil which serves as a collector) with the inorganic solid electrolyte-containing composition according to the embodiment of the present invention and forming a coating film (forming a film).

For example, an inorganic solid electrolyte-containing composition containing a positive electrode active material is applied as a material for a positive electrode (a positive electrode composition) onto a metal foil which is a positive electrode collector, to form a positive electrode active material layer, thereby producing a positive electrode sheet for an all-solid state secondary battery. Next, the inorganic solid electrolyte-containing composition for forming a solid electrolyte layer is applied onto the positive electrode active material layer to form the solid electrolyte layer. Furthermore, an inorganic solid electrolyte-containing composition containing a negative electrode active material is applied as a material for a negative electrode (a negative electrode composition) onto the solid electrolyte layer, to form a negative electrode active material layer. A negative electrode collector (a metal foil) is overlaid on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can also be manufactured by enclosing the all-solid state secondary battery in a housing.

In addition, it is also possible to manufacture an all-solid state secondary battery by carrying out the forming method for each layer in reverse order to form a negative electrode active material layer, a solid electrolyte layer, and a positive electrode active material layer on a negative electrode collector as a base material and overlaying a positive electrode collector thereon.

As another method, the following method can be exemplified. That is, the positive electrode sheet for an all-solid state secondary battery is produced as described above. In addition, an inorganic solid electrolyte-containing composition containing a negative electrode active material is applied as a material for a negative electrode (a negative electrode composition) onto a metal foil which is a negative electrode collector, to form a negative electrode active material layer, thereby producing a negative electrode sheet for an all-solid state secondary battery. Next, a solid electrolyte layer is formed on the active material layer in any one of these sheets as described above. Furthermore, the other one of the positive electrode sheet for an all-solid state secondary battery and the negative electrode sheet for an all-solid state secondary battery is laminated on the solid electrolyte layer such that the solid electrolyte layer and the active material layer come into contact with each other. In this manner, an all-solid state secondary battery can be manufactured.

As still another method, for example, the following method can be used. That is, a positive electrode sheet for an all-solid state secondary battery and a negative electrode sheet for an all-solid state secondary battery are produced as described above. In addition, separately from the positive electrode sheet for an all-solid state secondary battery and the negative electrode sheet for an all-solid state secondary battery, an inorganic solid electrolyte-containing composition is applied onto a base material, thereby producing a solid electrolyte sheet for an all-solid state secondary battery consisting of a solid electrolyte layer. Furthermore, the positive electrode sheet for an all-solid state secondary battery and the negative electrode sheet for an all-solid state secondary battery are laminated with each other to sandwich the solid electrolyte layer that has been peeled off from the base material. In this manner, an all-solid state secondary battery can be manufactured.

Further, a positive electrode sheet for an all-solid state secondary battery, a negative electrode sheet for an all-solid state secondary battery, and a solid electrolyte sheet for an all-solid state secondary battery are produced as described above. Next, the positive electrode sheet for an all-solid state secondary battery or negative electrode sheet for an all-solid state secondary battery, and the solid electrolyte sheet for an all-solid state secondary battery are overlaid and pressurized into a state where the positive electrode active material layer or the negative electrode active material layer is brought into contact with the solid electrolyte layer. In this manner, the solid electrolyte layer is transferred to the positive electrode sheet for an all-solid state secondary battery or the negative electrode sheet for an all-solid state secondary battery. Then, the solid electrolyte layer from which the base material of the solid electrolyte sheet for an all-solid state secondary battery has been peeled off and the negative electrode sheet for an all-solid state secondary battery or positive electrode sheet for an all-solid state secondary battery are overlaid and pressurized (into a state where the negative electrode active material layer or positive electrode active material layer is brought into contact with the solid electrolyte layer). In this manner, an all-solid state secondary battery can be manufactured. The pressurizing method and the pressurizing conditions in this method are not particularly limited, and a method and pressurizing conditions described in the pressurization step, which will be described later, can be applied.

The solid electrolyte layer or the like can also be formed on the substrate or the active material layer, for example, by pressure-molding the inorganic solid electrolyte-containing composition or the like under a pressurizing condition described later, or the solid electrolyte or a sheet molded body of the active material.

In the above production method, it suffices that the inorganic solid electrolyte-containing composition according to the embodiment of the present invention is used in any one of the positive electrode composition, the inorganic solid electrolyte-containing composition, or the negative electrode composition. The inorganic solid electrolyte-containing composition according to the embodiment of the present invention is preferably used in the inorganic solid electrolyte-containing composition or at least one of the positive electrode composition or the negative electrode composition, or the inorganic solid electrolyte-containing composition according to the embodiment of the present invention can be used in any of the compositions.

In a case where the solid electrolyte layer or the active material layer is formed of a composition other than the inorganic solid electrolyte-containing composition according to the embodiment of the present invention, examples of the material thereof include a typically used composition. In addition, the negative electrode active material layer can also be formed by binding ions of a metal belonging to Group 1 or Group 2 in the periodic table, which are accumulated on a negative electrode collector during initialization described later or during charging for use, without forming the negative electrode active material layer during the manufacture of the all-solid state secondary battery to electrons and precipitating the ions on a negative electrode collector the like as a metal.

<Formation (Film Formation) of Each Layer>

The method of applying the inorganic solid electrolyte-containing composition is not particularly limited and can be appropriately selected. Examples thereof include coating (preferably wet-type coating), spray coating, spin coating, dip coating, slit coating, stripe coating, and bar coating.

In this case, the inorganic solid electrolyte-containing composition may be dried after being applied each time or may be dried after being applied multiple times. The drying temperature is not particularly limited. The lower limit is preferably 30° C. or higher, more preferably 60° C. or higher, and still more preferably 80° C. or higher. The upper limit thereof is preferably 300° C. or lower, more preferably 250° C. or lower, and still more preferably 200° C. or lower. In a case where the solid electrolyte composition is heated in the above-described temperature range, the dispersion medium can be removed to make the composition enter a solid state (coated and dried layer). This temperature range is preferable since the temperature is not excessively increased and each member of the all-solid state secondary battery is not impaired. As a result, excellent overall performance is exhibited in the all-solid state secondary battery, and it is possible to obtain a good binding property and a good ion conductivity.

After applying the inorganic solid electrolyte-containing composition, it is preferable to pressurize each layer or the all-solid state secondary battery after overlaying the constitutional layers or producing the all-solid state secondary battery. Examples of the pressurizing methods include a method using a hydraulic cylinder press machine. The pressurizing force is not particularly limited; however, it is generally preferably in a range of 5 to 1,500 MPa.

In addition, the applied inorganic solid electrolyte-containing composition may be heated at the same time with the pressurization. The heating temperature is not particularly limited but is generally in a range of 30° C. to 300° C. The press can also be applied at a temperature higher than the glass transition temperature of the inorganic solid electrolyte. It is also possible to carry out the press at a temperature higher than the glass transition temperature of the polymer contained in the polymer binder. However, in general, the temperature does not exceed the melting point of this polymer.

The pressurization may be carried out in a state where the coating solvent or dispersion medium has been dried in advance or in a state where the solvent or the dispersion medium remains.

The respective compositions may be applied at the same time, and the application, the drying, and the pressing may be carried out simultaneously and/or sequentially. Each of the compositions may be applied onto each of the separate base materials and then laminated by carrying out the transfer.

The atmosphere in the film forming method (coating, drying, and pressurization (under heating)) is not particularly limited and may be any one of the atmospheres such as an atmosphere of dry air (the dew point: −20° C. or lower), an atmosphere of atmospheric air, and an atmosphere of inert gas (for example, an argon gas, a helium gas, or a nitrogen gas).

The pressing time may be a short time (for example, within several hours) under the application of a high pressure or a long time (one day or longer) under the application of an intermediate pressure. In a case of members other than the sheet for an all-solid state secondary battery, for example, the all-solid state secondary battery, it is also possible to use a restraining device (screw fastening pressure or the like) of the all-solid state secondary battery in order to continuously apply an intermediate pressure.

The pressing pressure may be a pressure that is constant or varies with respect to a portion under pressure such as a sheet surface.

The pressing pressure can be variable depending on the area or the film thickness of the portion under pressure. In addition, the pressure can also be variable stepwise for the same portion.

A pressing surface may be flat or roughened.

<Initialization>

The all-solid state secondary battery manufactured as described above is preferably initialized after the manufacturing or before use. The initialization is not particularly limited, and it is possible to initialize the all-solid state secondary battery by, for example, carrying out initial charging and discharging in a state where the pressing pressure is increased and then releasing the pressure up to a pressure at which the all-solid state secondary battery is ordinarily used.

[Use Application of all-Solid State Secondary Battery]

The all-solid state secondary battery according to the embodiment of the present invention can be applied to a variety of usages. The application aspect thereof is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. Additionally, examples of consumer usages include automobiles (electric vehicles and the like), electric motor vehicles, motors, lighting equipment, toys, game devices, road conditioners, watches, strobes, cameras, medical devices (pacemakers, hearing aids, and shoulder massage devices, and the like). Furthermore, the all-solid state secondary battery can be used for a variety of military usages and universe usages. In addition, the all-solid state secondary battery can also be combined with a solar battery.

### EXAMPLES

Hereinafter, the present invention will be described in more detail based on Examples; however, the present invention is not limited thereto be interpreted. “Parts” and “%” that represent compositions in the following Examples are based on the mass unless particularly otherwise described. In the present invention, “room temperature” means 25° C.

### 1. Polymer Synthesis and Preparation of Binder Solution or Dispersion Liquid

Each of binder forming polymers shown by the following chemical formulae and shown in Table 1 was synthesized as follows to prepare a binder solution or a dispersion liquid.

### Synthesis Example S-1: Synthesis of Polymer S-1 and Preparation of Binder Solution S-1

0.75 g of cuprous chloride and 22.7 g of acetonitrile were added to a 200 mL three-necked flask to dissolve copper chloride, and nitrogen bubbling was carried out. 0.36 g of diethyl meso-2,5-dibromoadipate and 34.6 g of normal butyl acrylate subjected to nitrogen bubbling were added thereto, the temperature was raised to 80° C., 0.55 g of pentamethyl diethylenetriamine was subsequently added thereto, stirring was carried out at 80° C. under a nitrogen stream, and cooling was carried out at a time point when the monomer reaction rate exceeded 80% to stop the reaction.

The obtained reaction solution was added to 1.5 L of ice-cooled methanol to be purified by reprecipitation. The mixed solution was subjected to decantation, and the obtained polymer was washed with ice-cooled methanol. The above reprecipitation operation was repeated by carrying out dissolution in toluene until the amount of residual monomer was 1% by mass or less with respect to the polymer. After confirming that the amount of the residual monomer was 1% by mass or less with respect to the polymer, the polymer was dissolved in toluene, and methanol as a solvent was distilled off to obtain a first block polymer solution (adjusted to a solid content of 50%).

20.0 g (10.0 g of solid) of the first block polymer solution, 0.03 g of cuprous chloride, 6.0 g of acetonitrile, and 24.0 g of toluene were added to a 200 mL three-necked flask and dissolved. Further, 20.0 g of methyl methacrylate was added thereto, and the temperature was raised to 80° C. 0.05 g of pentamethyl diethylenetriamine was added thereto, stirring was carried out at 80° C. under a nitrogen stream, and the reaction rate was traced by a nuclear magnetic resonance spectrum (NMR) to adjust the reaction time so that the composition shown in Table 1 was obtained. The obtained reaction solution was added to 1 L of methanol to be purified by reprecipitation. The mixed solution was subjected to decantation, the polymer was dissolved in butyl butyrate, and methanol as a solvent was distilled off to obtain a block polymer solution.

In this way, a polymer S-1 (a (meth)acrylic polymer of the ABA type block copolymer) as the binder forming polymer P1 was synthesized, and then a binder solution S-1 (concentration: 10% by mass) consisting of this polymer was obtained.

### Synthesis Examples S-2 to S-13, S-16 to S-18, and T-4: Synthesis of Polymers S-2 to S-13, S-16 to S-18, and T-4, and Preparation of Binder Solutions S-2 to S-13, S-16 to S-18, and T-4)

Polymers S-2 to S-13, S-16 to S-18, and T-4 (all, (meth)acrylic polymers of the ABA type block copolymer) were synthesized in the same manner as in Synthesis Example S-1 to respectively obtain binder solutions S-2 to S-13, S-16 to S-18, and T-4, consisting of the respective polymers, except that in Synthesis Example S-1, a compound from which each constitutional component is derived was used so that each of the polymers S-2 to S-13, S-16 to S-18, and T-4 had the composition (the content of the constitutional component) shown in the following chemical formula and Table 1 and the polymerization reaction time was appropriately adjusted.

It is noted that in a case where a segment in each polymer contains two or more constitutional components, the bonding mode of these constitutional components is random bonding.

In addition, the constitutional component derived from the maleic acid anhydride monomethyl ether of the segment B in the polymer S-13 was formed by subjecting a cyclic dicarboxylic acid anhydride group to methyl esterification by a treatment after the polymerization reaction.

### Synthesis Example S-14: Synthesis of Polymer S-14 and Preparation of Binder Solution S-14

Specifically, 300 g of cyclohexane as a solvent and 0.3 mL of sec-butyl lithium (1.3 mol/L (M), manufactured by FUJIFILM Wako Pure Chemical Corporation) as a polymerization initiator were charged into a pressure-resistant container that had been subjected to nitrogen substitution and drying, and after raising the temperature to 50° C., 9.0 g of styrene was added thereto to carry out polymerization for 2 hours, 52.2 g of 1,3-butadiene was subsequently added thereto to carry out polymerization for 3 hours, and then 9.0 g of styrene was added thereto to carry out polymerization for 2 hours. The obtained solution was reprecipitated in methanol, and the obtained solid was dried to obtain a polymer. Then, in a pressure-resistant container, the entire amount of the polymer obtained above was dissolved in 400 parts by mass of cyclohexane, and then 5% by mass of palladium carbon (palladium carrying amount: 5% by mass) with respect to the polymer was added as a hydrogenation catalyst, and the mixture was subjected to a reaction under the conditions of a hydrogen pressure of 2 MPa and 150° C. for 10 hours. After allowing cooling and pressure release, palladium carbon was removed by filtration, the filtrate was concentrated, and further, vacuum drying was carried out to obtain a solid, which was subsequently dissolved in butyl butyrate.

In this manner, a polymer S-14 (a hydrocarbon polymer (SEBS) of the ABA type block copolymer) was synthesized to obtain a binder solution S-14 (concentration: 10% by mass) consisting of this polymer.

### Synthesis Example S-15: Synthesis of Polymer S-15 and Preparation of Binder Solution S-15

Specifically, 200 parts by mass of ion exchange water, 100 parts by mass of vinylidene fluoride, 58 parts by mass of hexafluoropropylene, and 24 parts by mass of tetrafluoroethylene were added to the autoclave, 1 part by mass of diisopropyl peroxydicarbonate was added, and the mixture was stirred at 45° C. for 10 hours. After completion of the polymerization, the precipitate was filtered and dried at 100° C. for 10 hours to obtain a polymer (binder) S-15.

In this way, a polymer S-15 (a fluoropolymer as a random copolymer) was synthesized, and this polymer was dissolved in butyl butyrate to obtain a binder solution S-15 (concentration: 10% by mass) consisting of the polymer S-15.

### Synthesis Example S-19: Synthesis of Polymer S-19 and Preparation of Binder Solution S-19

A polymer S-19 was synthesized in the same manner as in Synthesis Example S-1 to obtain a binder solution S-19 consisting of each polymer, except that in Synthesis Example S-1, 0.36 g of diethyl meso-2,5-dibromoadipate was changed to 0.20 g of ethyl 2-bromoisobutyrate, a compound from which each constitutional component was derived was used so that the polymer S-19 had the composition (the content of the constitutional component) shown in the following chemical formula and Table 1, and the polymerization reaction time was appropriately adjusted.

In this way, a polymer S-19 (a (meth)acrylic polymer of the AB type block copolymer) was synthesized, and then a binder solution S-19 (concentration: 10% by mass) consisting of this polymer was obtained.

### Synthesis Example T-1: Synthesis of Polymer T-1 and Preparation of Binder Dispersion Liquid T-1

3.7 g of polyethylene glycol (PEG200 (product name), number average molecular weight: 200, manufactured by FUJIFILM Wako Pure Chemical Corporation), 3.7 g of polytetramethylene ether glycol (number average molecular weight: 250, manufactured by SIGMA-Aldrich Co., LLC), and 4.1 g of NISSO-PB GI-1000 (product name, manufactured by NIPPON SODA Co., Ltd.) were added to a 300 mL three-necked flask and dissolved in 82.3 g of THE (tetrahydrofuran). To this solution, 9.3 g of diphenylmethane diisocyanate (manufactured by FUJIFILM Wako Pure Chemical Corporation) was added and stirred at 60° C. to be uniformly dissolved.

To the obtained solution, 65 mg of Neostan U-600 (product name, manufactured by Nitto Kasei Co., Ltd.) was added and stirred at 60° C. for 5 hours. 0.96 g of methanol was added to this solution to seal the polymer terminal, and the polymerization reaction was stopped to obtain a 20% by mass THF solution (a polymer solution) of a polymer T-1.

(Preparation of Binder Dispersion Liquid T-1)

15.00 g of the polymer solution obtained as above was diluted with 15.00 g of THF, 50.00 g of butyl butyrate was dropwise added thereto over 1 hour with stirring, concentration was carried out, and butyl butyrate was dropwise added thereto to adjust the concentration to be a concentration of 10%. In this way, a polymer T-1 (a urethane polymer) was synthesized, and then a dispersion liquid T-1 (concentration: 10% by mass) of a binder solution consisting of this polymer was obtained. The average particle diameter of the particulate binder in this dispersion liquid was 120 nm.

### Synthesis Example T-2: Synthesis of Polymer T-2 and Preparation of Binder Solution T-2

7.2 g of methyl methacrylate, 28.8 g of butyl acrylate, and 0.21 g of a polymerization initiator V-601 (product name, manufactured by FUJIFILM Wako Pure Chemical Corporation) were added to a 100 mL volumetric flask and dissolved in 27 g of butyl butyrate to prepare a monomer solution. To a 300 mL three-necked flask, 27 g of butyl butyrate was added and stirred at 80° C., and then the above monomer solution was dropwise added thereto over 2 hours. After completion of the dropwise addition, the temperature was raised to 90° C., and stirring was carried out for 2 hours to obtain a polymer solution (concentration: 40% by mass), which was subsequently diluted with butyl butyrate so that the concentration was 10%.

In this way, a polymer T-2 (a (meth)acrylic polymer as a random copolymer) was synthesized, and then a binder solution T-2 (concentration: 10% by mass) consisting of this polymer was obtained.

### Synthesis Example T-3: Synthesis of Polymer T-3 and Preparation of Binder Solution T-3

A polymer T-3 (a (meth)acrylic polymer as a random copolymer) was synthesized in the same manner as in Synthesis Example T-2 to obtain a binder solution T-3 consisting of this polymer, except that in Synthesis Example T-2, a compound from which each constitutional component is derived was used so that the polymer T-3 had the composition (the kind and the content of the constitutional component) shown in the following chemical formula and Table 1.

### Synthesis Example T-5: Synthesis of Polymer T-5 and Preparation of Binder Dispersion Liquid T-5

A polymer T-5 (a (meth)acrylic polymer of the AB type block copolymer) was synthesized in the same manner as in Synthesis Example S-1, and then a dispersion liquid T-5 (concentration: 10% by mass) of the binder consisting of this polymer was obtained, except that in Synthesis Example S-1, 0.36 g of diethyl meso-2,5-dibromoadipate was changed to 0.20 g of ethyl 2-bromoisobutyrate, acetonitrile was changed to dimethylformamide, and a compound from which each constitutional component was derived was used so that the polymer T-5 had the composition (the content of the constitutional component) shown in the following chemical formula and Table 1, and the polymerization reaction time was appropriately adjusted.

2. Synthesis of Particulate Binder Lx-1 and Preparation of Particulate Binder Dispersion Liquid Lx-1

### Synthesis Example Lx-1

To a 2 L three-necked flask equipped with a reflux condenser and a gas introduction cock, 7.2 g of a heptane solution of 40% by mass of the following macromonomer M-1, 12.4 g of methyl acrylate (MA), and 6.7 g of acrylic acid (AA), 207 g of heptane (manufactured by FUJIFILM Wako Pure Chemical Corporation), and 1.4 g of azoisobutyronitrile were added, nitrogen gas was introduced at a flow rate of 200 mL/min for 10 minutes, and then the temperature was raised to 100° C. A liquid (a liquid obtained by mixing 846 g of the heptane solution of 40% by mass of the macromonomer M-1, 222.8 g of methyl acrylate, 75.0 g of acrylic acid, 300.0 g of heptane, and 2.1 g of azoisobutyronitrile) prepared in a separate container was dropwise added thereto over 4 hours. After the dropwise addition was completed, 0.5 g of azoisobutyronitrile was added thereto. Thereafter, stirring was carried out at 100° C. for 2 hours, cooling was carried out to room temperature, and filtration was carried out to synthesize an acrylic polymer Lx-1 as a polymer that forms the particulate binder PB2, and a particulate binder dispersion liquid Lx-1 consisting of this acrylic polymer (concentration: 39.2% by mass) was prepared. The tensile permanent strain (according to the following method) of the acrylic polymer Lx-1 was not measurable. The average particle diameter of the particulate binder PB2 in this dispersion liquid was 180 nm, and the adsorption rate A_{SE} with respect to the inorganic solid electrolyte in butyl acetate was 86%.

### Synthesis Example of Macromonomer M-1

A self-condensate of 12-hydroxystearic acid (manufactured by FUJIFILM Wako Pure Chemical Corporation) (number average molecular weight in GPC polystyrene standard: 2,000) was reacted with glycidyl methacrylate (manufactured by Tokyo Chemical Industry Co., Ltd.) to form a macromonomer, which was subsequently polymerized with methyl methacrylate and glycidyl methacrylate (manufactured by Tokyo Chemical Industry Co., Ltd.) at a ratio of 1:0.99:0.01 (molar ratio) to obtain a polymer, with which acrylic acid (manufactured by FUJIFILM Wako Pure Chemical Corporation) was subsequently reacted to obtain a macromonomer M-1. The number average molecular weight of this macromonomer M-1 was 11,000.

### 3. Synthesis of Chain Polymerization Polymers SA-1 to SA-5 and Preparation of Chain Polymerization Binder Solutions SA-1 to SA-5

### Synthesis Example SA-1

To a 300 mL three-necked flask equipped with a reflux condenser and a gas introduction cock, 17.0 g of butyl butyrate was added, and nitrogen gas was introduced at a flow rate of 50 mL/min for 30 minutes, and then the temperature was raised to 80° C. A liquid prepared in a separate container (a liquid obtained by mixing, as monomers, 9.5 g of methyl methacrylate (manufactured by Fujifilm Wako Pure Chemical Corporation), 25.2 g of lauryl acrylate (manufactured by Fujifilm Wako Pure Chemical Corporation), 1.1 g of hydroxyethyl acrylate (manufactured by FUJIFILM Wako Pure Chemical Corporation), and 0.2 g of maleic acid anhydride (manufactured by FUJIFILM Wako Pure Chemical Corporation) with 10.0 g of butyl butyrate, and 0.04 g of a polymerization initiator V-601 (product name, manufactured by FUJIFILM Wako Pure Chemical Corporation)) was dropwise added thereto over 4 hours. Then, stirring was carried out at 80° C. for 2 hours, the temperature was raised to 90° C., stirring was further carried out for 2 hours, and then cooling was carried out to room temperature to stop the reaction. The obtained reaction solution was added to 1 L of methanol to be purified by reprecipitation. The mixed solution was subjected to decantation, the obtained polymer was washed with methanol, dissolved in butyl butyrate, and methanol as a solvent was distilled off to obtain a chain polymerization binder solution.

In this way, a chain polymerization polymer (a (meth)acrylic polymer of the random copolymer) SA-1 as the binder forming polymer P3 was synthesized, and then a solution SA-1 (concentration: 10% by mass) of a chain polymerization binder PB3 consisting of this polymer was obtained. The mass average molecular weight of the obtained chain polymerization polymer P3 was 400,000, and the tensile permanent strain (according to the following method) was not measurable.

### Synthesis Example SA-2

A chain polymerization polymer (a (meth)acrylic polymer of the random copolymer) SA-2 was synthesized in the same manner as in Synthesis Example SA-1, and then a chain polymerization binder solution SA-2 (concentration: 10% by mass) consisting of this polymer was obtained, except that in Synthesis Example SA-1, 28.6 g of lauryl acrylate (manufactured by Fujifilm Wako Pure Chemical Corporation), 0.2 g of maleic acid anhydride (manufactured by Fujifilm Wako Pure Chemical Corporation), and 7.2 g of t-butyl acrylate (manufactured by Fujifilm Wako Pure Chemical Corporation) were used as monomers. The mass average molecular weight of the obtained chain polymerization polymer was 360,000, and the tensile permanent strain (according to the following method) was not measurable.

### Synthesis Example SA-3

A chain polymerization polymer (a (meth)acrylic polymer of the random copolymer) SA-3 was synthesized in the same manner as in Synthesis Example SA-1, and then a chain polymerization binder solution SA-3 (concentration: 10% by mass) consisting of this polymer was obtained, except that in Synthesis Example SA-1, 30.4 g of lauryl acrylate (manufactured by Fujifilm Wako Pure Chemical Corporation), 0.2 g of maleic acid anhydride (manufactured by Fujifilm Wako Pure Chemical Corporation), and 5.4 g of N-tert-butyl acrylamide (manufactured by FUJIFILM Wako Pure Chemical Corporation) were used as monomers. The mass average molecular weight of the obtained chain polymerization polymer was 380,000, and the tensile permanent strain (according to the following method) was not measurable.

### Synthesis Example SA-4

A chain polymerization polymer (a (meth)acrylic polymer of the random copolymer) SA-4 was synthesized in the same manner as in Synthesis Example SA-1, and then a chain polymerization binder solution SA-4 (concentration: 10% by mass) consisting of this polymer was obtained, except that in Synthesis Example SA-1, 30.4 g of lauryl acrylate (manufactured by Fujifilm Wako Pure Chemical Corporation), 0.2 g of maleic acid anhydride (manufactured by Fujifilm Wako Pure Chemical Corporation), and 5.4 g of N-methyl methacrylamide (manufactured by Tokyo Chemical Industry Co., Ltd.) were used as monomers. The mass average molecular weight of the obtained chain polymerization polymer was 420,000, and the tensile permanent strain (according to the following method) was not measurable.

### Synthesis Example SA-5

A chain polymerization polymer (a (meth)acrylic polymer of the random copolymer) SA-5 was synthesized in the same manner as in Synthesis Example SA-1, and then a chain polymerization binder solution SA-5 (concentration: 10% by mass) consisting of this polymer was obtained, except that in Synthesis Example SA-1, 28.6 g of lauryl acrylate (manufactured by Fujifilm Wako Pure Chemical Corporation), 0.2 g of maleic acid anhydride (manufactured by Fujifilm Wako Pure Chemical Corporation), and 7.2 g of cyclohexyl acrylate (manufactured by Tokyo Chemical Industry Co., Ltd.) were used as monomers. The mass average molecular weight of the obtained chain polymerization polymer was 390,000, and the tensile permanent strain (according to the following method) was not measurable.

Each of the polymers synthesized is shown below. The number at the bottom right of each constitutional component indicates the content (% by mass). However, since polymers represented by the polymers S-2 to S-5 have the same constitutional components, except that the contents of the constitutional components are different from those of the polymer S-1, the chemical formulae thereof will be omitted. In addition, the chemical formulae of polymers represented by the polymers T-1 to T-3 will be omitted.

It is noted that in the chemical formulae of the following polymers, in a case where blocks are denoted by A and B, “A-block-B” is a notation based on the basic raw material nomenclature of the copolymer, and “-block-” indicates a block polymer consisting of a block of a constitutional component A and a block of a constitutional component B. In the following chemical formulae, Me represents a methyl group, and nBu represents a normal butyl group.

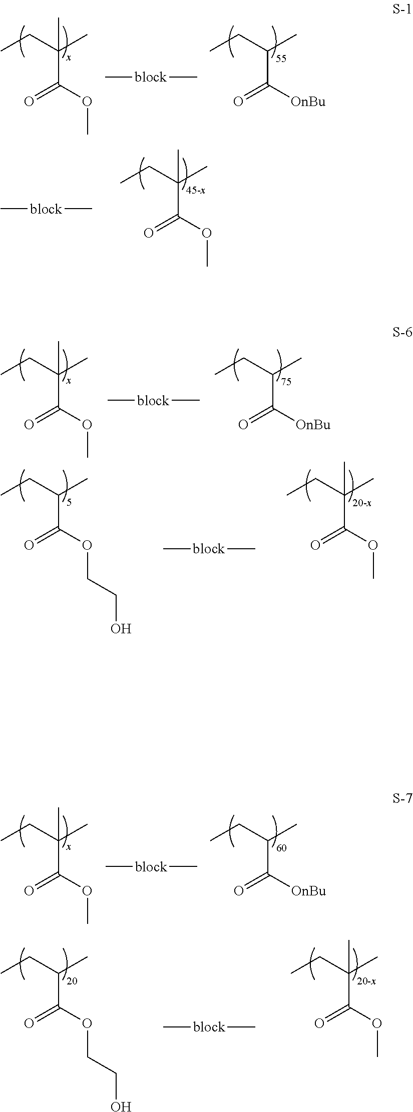

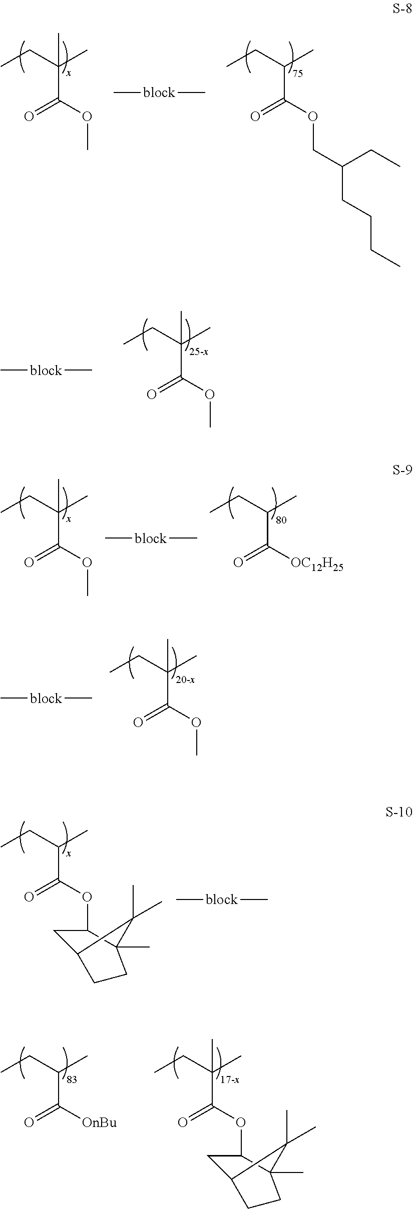

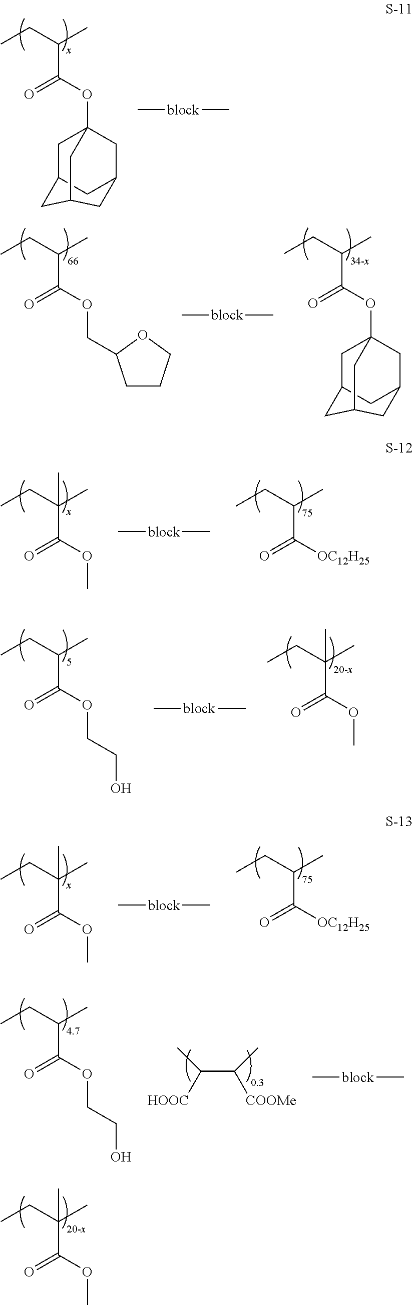

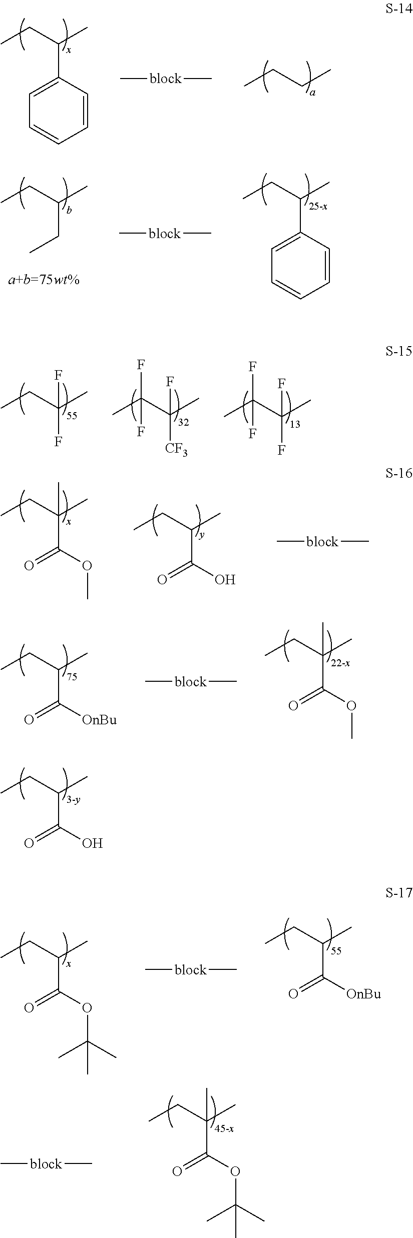

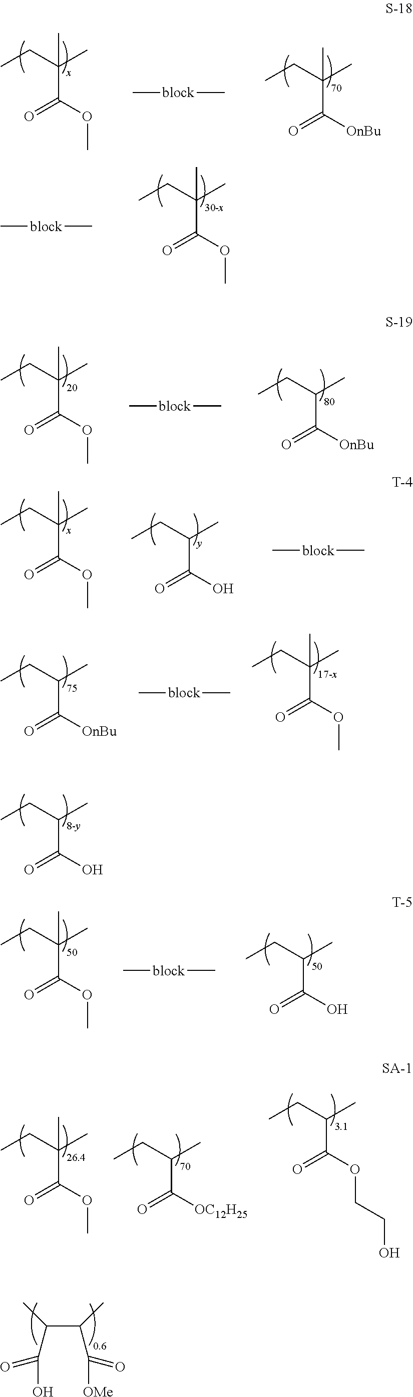

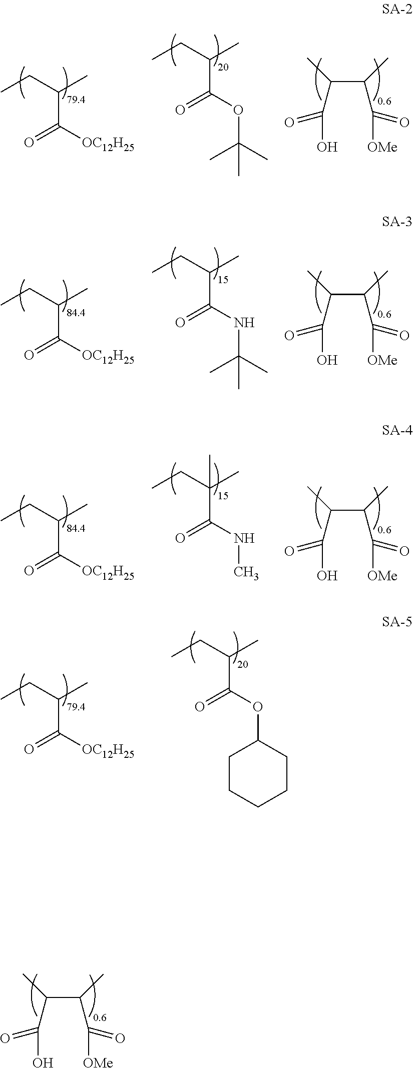

Table 1 shows the bonding mode, tensile permanent strain, breaking elongation, and mass average molecular weight of each segment of each synthesized polymer. The tensile permanent strain and the breaking elongation were measured according to the following methods, and the mass average molecular weight was calculated based on the above-described method. In addition, the glass transition temperature (denoted as “Tg” in Table 1) of each block of the compound from which the constitutional component was derived was measured according to the above-described measuring method, and the results are shown below or in Table 1.

It is noted that since the polymers S-15, T-2, and T-3 are random polymers and the glass transition temperature of each block cannot be measured, they are indicated by “-” in Table 1.

In addition, since strong film sticking occurred at room temperature and a self-supporting film could not be produced regarding the polymer T-2, and since film brittleness occurred at room temperature and a self-supporting film could not be produced (was broken by cutting) regarding the polymer T-5, the tensile permanent strain and the breaking elongation could not be measured. In Table 1, this is indicated by “-”.

Since the polymer T-1 is a polyurethane, the bonding mode column is indicated by “-”.

—Measurement of Tensile Permanent Strain—

The tensile permanent strain of the polymer was measured as follows.

Specifically, 2 cc of a polymer solution or dispersion liquid (concentration of solid contents: 10% by mass) was applied onto a Teflon (registered trade name) sheet and dried at 120° C. for 6 hours to obtain a dried film having a film thickness of about 150 μm. The obtained film was cut into a striped shape having a width of 10 mm and a length of 40 mm and set in a force gauge (manufactured by IMADA Co., Ltd.) so that the distance between the chucks was 30 mm. The film was pulled at a speed of 10 mm/min until a target elongation of 100% (that is, a total length after extension of 200%) was reached, and then returned immediately to the original chuck position at the same speed (pulling and restoration were carried out once). The displacement magnitude and the load at that time were measured, a stress-strain curve was created, and the tensile permanent strain was calculated from the following expression.

Tensile permanent strain (%)=(L_{S}/L₀)×100={1−((L₁/L₀)×100}

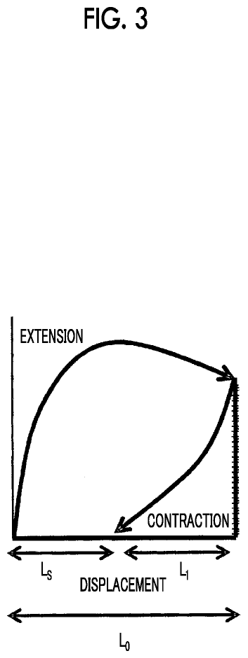

In the expression, L_{S} indicates the displacement magnitude (mm) after restoration, L₀ indicates the displacement magnitude after application of tension (length at time of extension: 60 mm), and L₁ indicates the difference (mm) between the displacement magnitude later after application of tension and the displacement magnitude after restoration, as shown in FIG. 3.

—Measurement of Breaking Elongation—

The breaking elongation of the polymer was measured according to the following method.

(Preparation of Test Piece)

2 cc of a solution or dispersion liquid (concentration of solid contents: 1000 by mass) of each of the synthesized polymers was applied onto a Teflon (registered trade name) sheet and dried at 120° C. for 6 hours to obtain a dried film having a film thickness of 150 μm. The obtained dried film was cut into a striped shape having a width of 10 mm and a length of 40 mm to prepare a test piece.

(Measurement of Breaking Elongation)

Each prepared test piece was set in a force gauge (manufactured by IMADA Co., Ltd.) so that the distance between the chucks was 30 mm. In this state, the test piece was pulled at a speed of 10 mm/min, the displacement magnitude and the stress were measured, and the breaking elongation was calculated from the displacement magnitude at the time when the breaking occurred.

TABLE 1

| | Segment (block) A | | | | | Segment (block) B | | |
|---|---|---|---|---|---|---|---|---|
| | | Content | | Content | | | Content | |
| | Constitutional | (% by | Constitutional | (% by | Tg | Constitutional | (% by | Constitutional |
| No. | component M1 | mass) | component M2 | mass) | (° C.) | component M3 | mass) | component M4 |
| S-1 | MMA | 45 | — | — | 105 | BA | 55 | — |
| S-2 | MMA | 35 | — | — | 105 | BA | 65 | — |
| S-3 | MMA | 20 | — | — | 105 | BA | 80 | — |
| S-4 | MMA | 15 | — | — | 105 | BA | 85 | — |
| S-5 | MMA | 12 | — | — | 105 | BA | 88 | — |
| S-6 | MMA | 20 | — | — | 105 | BA | 75 | HEA |
| S-7 | MMA | 20 | — | — | 105 | BA | 60 | HEA |
| S-8 | MMA | 25 | — | — | 105 | EHA | 75 | — |
| S-9 | MMA | 20 | — | — | 105 | LA | 80 | — |
| S-10 | IBOA | 17 | — | — | 95 | BA | 83 | — |
| S-11 | AdA | 34 | — | — | 150 | — | — | THFA |
| S-12 | MMA | 20 | — | — | 105 | LA | 75 | HEA |
| S-13 | MMA | 20 | — | — | 105 | LA | 75 | HEA |
| S-14 | St | 25 | — | — | 100 | H-BD | 75 | — |
| S-15 | VDF | 55 | — | — | — | HFP | 32 | TFE |
| S-16 | MMA | 22 | AA | 3 | 105 | BA | 75 | — |
| S-17 | tBA | 45 | — | — | 40 | BA | 55 | — |
| S-18 | MMA | 30 | — | — | 105 | BMA | 70 | — |
| S-19 | MMA | 20 | — | — | 105 | BA | 80 | — |
| T-1 | MDI | 44 | — | — | — | PTMG 250 | 18 | PEG 200 |
| T-2 | MMA | 20 | — | — | — | BA | 80 | — |
| T-3 | MMA | 40 | — | — | — | BA | 60 | — |
| T-4 | MMA | 17 | AA | 8 | 105 | BA | 75 | — |
| T-5 | MMA | 50 | — | — | 105 | AA | 50 | — |
| | Segment (block) B | | | | | Tensile | | Mass |
| | Content | | Content | | | permanent | Breaking | average |
| | (% by | Constitutional | (% by | Tg | Bonding | strain | elongation | molecular |
| No. | mass) | component M5 | mass) | (° C.) | mode | (%) | (%) | weight |
| S-1 | — | — | — | −54 | ABA type | 45 | 150 | 50000 |
| S-2 | — | — | — | −54 | ABA type | 25 | 200 | 75000 |
| S-3 | — | — | — | −54 | ABA type | 15 | 400 | 85000 |
| S-4 | — | — | — | −54 | ABA type | 12 | 600 | 150000 |
| S-5 | — | — | — | −54 | ABA type | 10 | 800 | 90000 |
| S-6 | 5 | — | — | −50 | ABA type | 18 | 500 | 90000 |
| S-7 | 20 | — | — | −45 | ABA type | 30 | 450 | 100000 |
| S-8 | — | — | — | −50 | ABA type | 20 | 400 | 60000 |
| S-9 | — | — | — | −30 | ABA type | 15 | 600 | 65000 |
| S-10 | — | — | — | −54 | ABA type | 20 | 400 | 75000 |
| S-11 | 66 | — | — | −12 | ABA type | 15 | 500 | 50000 |
| S-12 | 5 | — | — | −28 | ABA type | 18 | 500 | 80000 |
| S-13 | 4.7 | MA | 0.3 | −28 | ABA type | 20 | 450 | 75000 |
| S-14 | — | — | — | −45 | ABA type | 10 | 900 | 130000 |
| S-15 | 13 | — | — | — | Random | 22 | >1000 | 440000 |
| S-16 | — | — | — | −54 | ABA type | 20 | 430 | 55000 |
| S-17 | — | — | — | −54 | ABA type | 40 | 250 | 45000 |
| S-18 | — | — | — | 20 | ABA type | 46 | 150 | 40000 |
| S-19 | — | — | — | −54 | AB type | 30 | 250 | 50000 |
| T-1 | 18 | GI 1000 | 20 | — | — | 30 | 500 | 50000 |
| T-2 | — | — | — | — | Random | — | — | 70000 |
| T-3 | — | — | — | — | Random | 70 | 500 | 75000 |
| T-4 | — | — | — | −54 | ABA type | 30 | 350 | 50000 |
| T-5 | — | — | — | 106 | AB type | — | — | 60000 |

<Abbreviations in table>
In the table, “—” in the column of the constitutional component indicates that the constitutional component does not have a corresponding constitutional component.

In Table 1, the segment A is a segment that contains a constitutional component derived from a vinyl compound or (meth)acrylic acid ester compound having a glass transition temperature of 50° C. or higher, and the segment B is a segment that contains a constitutional component derived from a (meth)acrylic acid ester compound having a glass transition temperature of 15° C. or lower, where the glass transition temperature of the entire segment is preferably 15° C. or lower.

The compounds from which the respective constitutional components are derived will be described below.

—Constitutional Components M1 and M2—

Constitutional components M1 and M2 are constitutional components that constitute the segment A.
MMA: Methyl methacrylate (glass transition temperature of constitutional component: 105° C.)
IBOA: Isobornyl acrylate (glass transition temperature of constitutional component: 95° C.)
AdA: Adamantyl acrylate (glass transition temperature of constitutional component: 150° C.)
St: Styrene (glass transition temperature of constitutional component: 100° C.)
tBA: Tertiary butyl acrylate (glass transition temperature of constitutional component: 40° C.)
AA: Acrylic acid (glass transition temperature of constitutional component: 106° C.)

—Constitutional Components M3 to M5—

Constitutional components M3 to M5 are constitutional components that constitute the segment B. The constitutional component M4 and the constitutional component M5 are also constitutional components having a functional group selected from the group (a) of functional groups.
BA: Normal butyl acrylate (glass transition temperature of constitutional component: −54° C.)
EHA: 2-ethylhexyl acrylate (glass transition temperature of constitutional component: −50° C.)
LA: Lauryl acrylate (glass transition temperature of constitutional component: −30° C.)
H-BD: Hydrogenated butadiene (glass transition temperature of constitutional component: −45° C.)
BMA: Normal butyl methacrylate (glass transition temperature of constitutional component: 20° C.)
HEA: Hydroxyethyl acrylate (glass transition temperature of constitutional component: −45° C.)
THFA: Tetrahydrofurfuryl acrylate (glass transition temperature of constitutional component: −12° C.)
MA: Maleic acid anhydride (which forms a monomethyl ester constitutional component)
AA: Acrylic acid (glass transition temperature of constitutional component: 106° C.)

It is noted that although the following constitutional components do not correspond to the constitutional components M1 to M5, they are shown in the respective constitutional component columns for convenience.
VDF: Vinylidene fluoride (glass transition temperature of constitutional component: 35° C.)
MDI: Diphenylmethane diisocyanate
HFP: Hexafluoropropylene
PTMG250: polytetrahydrofuran (number average molecular weight: 250)
TFE: Tetrafluoroethylene (glass transition temperature of constitutional component: 126° C.)
PEG200: Polyethylene glycol (number average molecular weight: 200, glass transition temperature of constitutional component: −60° C.)
GI1000: NISSO-PB GI-1000 (product name, manufactured by NIPPON SODA Co., Ltd., glass transition temperature of constitutional component: −44° C.)

### 4. Synthesis of Sulfide-Based Inorganic Solid Electrolyte

### Synthesis Example A

A sulfide-based inorganic solid electrolyte was synthesized with reference to a non-patent document of T. Ohtomo, A. Hayashi, M. Tatsumisago, Y Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box in an argon atmosphere (dew point: −70° C.), lithium sulfide (Li₂S, manufactured by Sigma-Aldrich Co., LLC, purity: >99.98%) (2.42 g) and diphosphorus pentasulfide (P₂S₅, manufactured by Sigma-Aldrich Co., LLC, purity: >99%) (3.90 g) were each weighed, put into an agate mortar, and mixed using an agate pestle for five minutes. The mixing ratio between Li₂S and P₂S₅ (Li₂S:P₂S₅) was set to 75:25 in terms of molar ratio.

Next, 66 g of zirconia beads having a diameter of 5 mm were put into a 45 mL container made of zirconia (manufactured by FRITSCH), the total amount of the mixture of the above lithium sulfide and the diphosphorus pentasulfide was put thereinto, and the container was completely sealed in an argon atmosphere. The container was set in a planetary ball mill P-7 (product name, manufactured by FRITSCH), mechanical milling was carried out at a temperature of 25° C. and a rotation speed of 510 rpm for 20 hours, thereby obtaining yellow powder (6.20 g) of a sulfide-based inorganic solid electrolyte (Li—P—S-based glass, hereinafter, may be referred to as LPS). The average particle diameter of the Li—P—S-based glass was 15 μm.

### Example 1

Each of the compositions shown in Tables 2-1 to 2-3 (collectively referred to as Table 2) was prepared as follows.

<Preparation of Inorganic Solid Electrolyte-Containing Composition>

60 g of zirconia beads having a diameter of 5 mm was put into a 45 mL container made of zirconia (manufactured by FRITSCH), and 8.4 g of the LPS synthesized in the Synthesis Example A or LLT, 0.6 g (in terms of the solid content mass) or 0.3 g (in terms of the solid content mass) of the binder solution or dispersion liquid shown in Table 2-1, additionally 0.3 g (in terms of the solid content mass) of the particulate binder dispersion liquid Lx-1 or chain polymerization binder solutions SA-1 to SA-5 shown in Table 2-1 in a case where 0.3 g of the binder solution was used, and 11 g of the dispersion medium shown in Table 2-1 was put thereinto. Then, this container was set in a planetary ball mill P-7 (product name) manufactured by FRITSCH. Mixing was carried out at a temperature of 25° C. and a rotation speed of 150 rpm for 10 minutes to prepare each of inorganic solid electrolyte-containing compositions (slurries) K-1 to K-24, K-27 to K-30, and Kc1 to Kc5.

In addition, each of inorganic solid electrolyte-containing compositions K-25 and K-26 was prepared in the same manner as in the preparation of the inorganic solid electrolyte-containing composition K-24, except that in the preparation of the inorganic solid electrolyte-containing composition K-24, the contents (in terms of the mixing amount) of the binder solution S-4 and the chain polymerization binder solution SA-1 were changed to be the contents shown in Table 2-1 (the solid content mass was 0.6 g in total).

<Preparation of Positive Electrode Composition>

60 g of zirconia beads having a diameter of 5 mm were put into a 45 mL container made of zirconia (manufactured by FRITSCH), and then 8 g of the LPS synthesized in Synthesis Example A and 13 g (in terms of the total amount) of the dispersion medium shown in Table 2-2 were put thereinto. The container was set in a planetary ball mill P-7 (product name, manufactured by FRITSCH) and the components were stirred for 30 minutes at 25° C. and a rotation speed of 200 rpm. Then, into this container, 27.5 g of NMC (manufactured by Sigma-Aldrich Co., LLC) as the positive electrode active material, 1.0 g of acetylene black (AB) as the conductive auxiliary agent, 0.5 g (in terms of the solid content mass) or 0.25 g (in terms of the solid content mass) of the binder solution shown in Table 2-2, and additionally, 0.25 g (in terms of the solid content mass) of the particulate binder dispersion liquid Lx-1 or chain polymerization binder solutions SA-1 to SA-5 shown in Table 2-2 in a case where 0.25 g of the binder solution or dispersion liquid was used were put. The container was set in a planetary ball mill P-7, and mixing was continued for 30 minutes at a temperature of 25° C. and a rotation speed of 200 rpm to prepare each of positive electrode compositions (slurries) PK-1 to PK-23 and PK-26 to PK-29.

In addition, each of positive electrode compositions PK-24 and PK-25 was prepared in the same manner as in the preparation of the positive electrode composition PK-23, except that in the preparation of the positive electrode composition PK-23, the contents (in terms of the mixing amount) of the binder solution S-4 and the chain polymerization binder solution SA-1 were changed to be the contents shown in Table 2-2 (the solid content mass was 0.5 g in total).

<Preparation of Negative Electrode Composition>

60 g of zirconia beads having a diameter of 5 mm was put into a 45 mL container made of zirconia (manufactured by FRITSCH), and 8.0 g of the LPS synthesized in the Synthesis Example A, 0.4 g (in terms of the solid content mass) or 0.2 g (in terms of the solid content mass) of the binder solution or dispersion liquid shown in Table 2-3, additionally 0.2 g (solid content mass) of the particulate binder dispersion liquid Lx-1 or the chain polymerization binder solutions SA-1 to SA-5 shown in Table 2 in a case where 0.2 g of the binder solution was used, and 17.5 g (total mass) of the dispersion medium shown in Table 2-3 was put thereinto. The container was set in a planetary ball mill P-7 (product name, manufactured by FRITSCH) and the components were mixed for 60 minutes at a temperature of 25° C. and a rotation speed of 300 rpm. Then, 9.5 g of the active material shown in Table 2-3 and 1.0 g of VGCF (manufactured by Showa Denko K.K.) as the conductive auxiliary agent were put into the container. Similarly, the container was subsequently set in a planetary ball mill P-7, and mixing was carried out at a temperature of 25° C. for 10 minutes at a rotation speed of 100 rpm to prepare each of negative electrode compositions (slurries) NK-1 to NK-24, NK-27 to NK-30, and NKc1 to NKc5.

In addition, each of negative electrode compositions NK-25 and NK-26 was prepared in the same manner as in the preparation of the negative electrode composition NK-24, except that in the preparation of the negative electrode composition NK-24, the contents (in terms of the mixing amount) of the binder solution S-4 and the chain polymerization binder solution SA-1 were changed to be the contents shown in Table 2-3 (the solid content mass was 0.4 g in total).

—Measurement of Adsorption Rate—

The adsorption rate A_{SE} with respect to the inorganic solid electrolyte of the binder was measured using the inorganic solid electrolyte, the polymer binder, and the dispersion medium, which had been used in the preparation of each of the compositions shown in Table 2. The results are shown in Table 2.

That is, the polymer binder was dissolved in a dispersion medium to prepare a binder solution or dispersion liquid having a concentration of 1% by mass. The binder solution or dispersion liquid and the inorganic solid electrolyte were put into a 15 mL of vial at a proportion such that the mass ratio of this binder solution or polymer binder in the dispersion liquid to the inorganic solid electrolyte was 35:1, and stirred for 1 hour with a mix rotor at room temperature and a rotation speed of 80 rpm, and then allowed to stand. The supernatant obtained by solid-liquid separation was filtered through a filter having a pore diameter of 1 μm, and the entire amount of the obtained filtrate was dried to be solid, and then the mass of the polymer binder remaining in the filtrate (the mass of the polymer binder that had not adsorbed to the inorganic solid electrolyte) W_{A} was measured. From this mass W_{A} and the mass W_{B} of the binder contained in the binder solution used for the measurement, the adsorption rate of the polymer binder with respect to the inorganic solid electrolyte was calculated according to the following expression.

The adsorption rate A_{SE} of the polymer binder is the average value of the adsorption rates obtained by carrying out the above measurement twice.

Adsorption rate (%)=[(W_{B}−W_{A})/W_{B}]×100

It is noted that as a result of measuring the adsorption rate A_{SE} using the inorganic solid electrolyte and the polymer binder, which had been extracted from the solid electrolyte layer formed into a film, and the dispersion medium which had been used for the preparation of the inorganic solid electrolyte-containing composition, the same value was obtained.

In Table 2, the composition content is the content (% by mass) with respect to the total mass of the composition, and the solid content is the content (% by mass) with respect to 100% by mass of the solid content of the composition. The unit is omitted in the table.

The column of “State” of Table 2 indicates the state of the polymer binder in each composition, where a state in which the polymer binder is dissolved in the dispersion medium is denoted as “Dissolved”, and a state in which the polymer binder is not dissolved in the dispersion medium and is dispersed in the particle shape is denoted as “Particulate”.

It is noted that in Table 2, in a case where the polymer binder PB1 defined in the present invention is used in combination with the particulate binder PB2 or the chain polymerization binder PB3, the value or state of each binder is described together by using “/” in each of the columns of “Content”, “As_{E}”, and “State”.

TABLE 2

| | | Inorganic | | | Binder solution | | | | | | | |
|---|---|---|---|---|---|---|---|---|---|---|---|---|
| | | solid | Composition | Solid | or dispersion | Composition | Solid | A_{SE} | Dispersion | Composition | | |
| | No. | electrolyte | content | content | liquid | content | content | (%) | medium | content | State | Note |
| Inorganic solid | K-1 | LPS | 42 | 93 | S-1 | 3 | 7 | 0 | Butyl | 55 | Dissolved | Present |
| electrolyte- | | | | | | | | | butyrate | | | invention |
| containing | K-2 | LPS | 42 | 93 | S-2 | 3 | 7 | 0 | Butyl | 55 | Dissolved | Present |
| composition | | | | | | | | | butyrate | | | invention |
| | K-3 | LPS | 42 | 93 | S-3 | 3 | 7 | 0 | Butyl | 55 | Dissolved | Present |
| | | | | | | | | | butyrate | | | invention |
| | K-4 | LPS | 42 | 93 | S-4 | 3 | 7 | 0 | Butyl | 55 | Dissolved | Present |
| | | | | | | | | | butyrate | | | invention |
| | K-5 | LPS | 42 | 93 | S-5 | 3 | 7 | 0 | Butyl | 55 | Dissolved | Present |
| | | | | | | | | | butyrate | | | invention |
| | K-6 | LPS | 42 | 93 | S-6 | 3 | 7 | 15 | Butyl | 55 | Dissolved | Present |
| | | | | | | | | | butyrate | | | invention |
| | K-7 | LPS | 42 | 93 | S-7 | 3 | 7 | 58 | Butyl | 55 | Dissolved | Present |
| | | | | | | | | | butyrate | | | invention |
| | K-8 | LPS | 42 | 93 | S-8 | 3 | 7 | 0 | Butyl | 55 | Dissolved | Present |
| | | | | | | | | | butyrate | | | invention |
| | K-9 | LPS | 42 | 93 | S-9 | 3 | 7 | 0 | Butyl | 55 | Dissolved | Present |
| | | | | | | | | | butyrate | | | invention |
| | K-10 | LPS | 42 | 93 | S-10 | 3 | 7 | 5 | Butyl | 55 | Dissolved | Present |
| | | | | | | | | | butyrate | | | invention |
| | K-11 | LPS | 42 | 93 | S-11 | 3 | 7 | 45 | Butyl | 55 | Dissolved | Present |
| | | | | | | | | | butyrate | | | invention |
| | K-12 | LPS | 42 | 93 | S-12 | 3 | 7 | 20 | Butyl | 55 | Dissolved | Present |
| | | | | | | | | | butyrate | | | invention |
| | K-13 | LPS | 42 | 93 | S-13 | 3 | 7 | 25 | Butyl | 55 | Dissolved | Present |
| | | | | | | | | | butyrate | | | invention |
| | K-14 | LPS | 42 | 93 | S-14 | 3 | 7 | 5 | Butyl | 55 | Dissolved | Present |
| | | | | | | | | | butyrate | | | invention |
| | K-15 | LPS | 42 | 93 | S-15 | 3 | 7 | 2 | Butyl | 55 | Dissolved | Present |
| | | | | | | | | | butyrate | | | invention |
| | K-16 | LPS | 42 | 93 | S-16 | 3 | 7 | 45 | Butyl | 55 | Dissolved | Present |
| | | | | | | | | | butyrate | | | invention |
| | K-17 | LPS | 42 | 93 | S-17 | 3 | 7 | 0 | Butyl | 55 | Dissolved | Present |
| | | | | | | | | | butyrate | | | invention |
| | K-18 | LPS | 42 | 93 | S-18 | 3 | 7 | 0 | Butyl | 55 | Dissolved | Present |
| | | | | | | | | | butyrate | | | invention |
| | K-19 | LPS | 42 | 93 | S-19 | 3 | 7 | 0 | Butyl | 55 | Dissolved | Present |
| | | | | | | | | | butyrate | | | invention |
| | K-20 | LPS | 42 | 93 | S-12/Lx-1 | 1.5/1.5 | 3.5/3.5 | 20/86 | Butyl | 55 | Dissolved/ | Present |
| | | | | | | | | | butyrate | | particulate | invention |
| | K-21 | LPS | 42 | 93 | S-12 | 3 | 7 | 20 | Xylene | 55 | Dissolved | Present |
| | | | | | | | | | | | | invention |
| | K-22 | LPS | 42 | 93 | S-13 | 3 | 7 | 25 | Butyl | 55 | Dissolved | Present |
| | | | | | | | | | butyrate | | | invention |
| | K-23 | LPS | 42 | 93 | S-4/SA-1 | 1.5/1.5 | 3.5/3.5 | 0/5 | Butyl | 55 | Dissolved/ | Present |
| | | | | | | | | | butyrate | | dissolved | invention |
| | K-24 | LPS | 42 | 93 | S-4/SA-1 | 1.5/1.5 | 3.5/3.5 | 0/12 | Xylene | 55 | Dissolved/ | Present |
| | | | | | | | | | | | dissolved | invention |
| | K-25 | LPS | 42 | 93 | S-4/SA-1 | 0.7/2.3 | 1.6/5.4 | 0/12 | Xylene | 55 | Dissolved/ | Present |
| | | | | | | | | | | | dissolved | invention |
| | K-26 | LPS | 42 | 93 | S-4/SA-1 | 0.3/2.7 | 0.7/6.3 | 0/12 | Xylene | 55 | Dissolved/ | Present |
| | | | | | | | | | | | dissolved | invention |
| | K-27 | LPS | 42 | 93 | S-14/SA-2 | 1.5/1.5 | 3.5/3.5 | 5/2 | Butyl | 55 | Dissolved/ | Present |
| | | | | | | | | | butyrate | | dissolved | invention |
| | K-28 | LPS | 42 | 93 | S-14/SA-3 | 1.5/1.5 | 3.5/3.5 | 5/3 | Butyl | 55 | Dissolved/ | Present |
| | | | | | | | | | butyrate | | dissolved | invention |
| | K-29 | LPS | 42 | 93 | S-14/SA-4 | 1.5/1.5 | 3.5/3.5 | 5/8 | Butyl | 55 | Dissolved/ | Present |
| | | | | | | | | | butyrate | | dissolved | invention |
| | K-30 | LPS | 42 | 93 | S-14/SA-5 | 1.5/1.5 | 3.5/3.5 | 5/4 | Butyl | 55 | Dissolved/ | Present |
| | | | | | | | | | butyrate | | dissolved | invention |
| | Kc1 | LPS | 42 | 93 | T-1 | 3 | 7 | 100 | Butyl | 55 | Particulate | Comparative |
| | | | | | | | | | butyrate | | | Example |
| | Kc2 | LPS | 42 | 93 | T-2 | 3 | 7 | 0 | Butyl | 55 | Dissolved | Comparative |
| | | | | | | | | | butyrate | | | Example |
| | Kc3 | LPS | 42 | 93 | T-3 | 3 | 7 | 0 | Butyl | 55 | Dissolved | Comparative |
| | | | | | | | | | butyrate | | | Example |
| | Kc4 | LPS | 42 | 93 | T-4 | 3 | 7 | 70 | Butyl | 55 | Dissolved | Comparative |
| | | | | | | | | | butyrate | | | Example |
| | Kc5 | LPS | 42 | 93 | T-5 | 3 | 7 | 100 | Butyl | 55 | Particulate | Comparative |
| | | | | | | | | | butyrate | | | Example |

| | | Inorganic | | | Binder solution | | | | | |
|---|---|---|---|---|---|---|---|---|---|---|
| | | solid | Composition | Solid | or dispersion | Composition | Solid | A_{SE} | Dispersion | Composition |
| | No. | electrolyte | content | content | liquid | content | content | (%) | medium | content |
| Positive | PK-1 | LPS | 16 | 22 | S-1 | 1 | 1 | 0 | Butyl butyrate | 26 |
| electrode | PK-2 | LPS | 16 | 22 | S-2 | 1 | 1 | 0 | Butyl butyrate | 26 |
| composition | PK-3 | LPS | 16 | 22 | S-3 | 1 | 1 | 0 | Butyl butyrate | 26 |
| | PK-4 | LPS | 16 | 22 | S-4 | 1 | 1 | 0 | Butyl butyrate | 26 |
| | PK-5 | LPS | 16 | 22 | S-5 | 1 | 1 | 0 | Butyl butyrate | 26 |
| | PK-6 | LPS | 16 | 22 | S-6 | 1 | 1 | 15 | Butyl butyrate | 26 |
| | PK-7 | LPS | 16 | 22 | S-7 | 1 | 1 | 58 | Butyl butyrate | 26 |
| | PK-8 | LPS | 16 | 22 | S-8 | 1 | 1 | 0 | Butyl butyrate | 26 |
| | PK-9 | LPS | 16 | 22 | S-9 | 1 | 1 | 0 | Butyl butyrate | 26 |
| | PK-10 | LPS | 16 | 22 | S-10 | 1 | 1 | 5 | Butyl butyrate | 26 |
| | PK-11 | LPS | 16 | 22 | S-11 | 1 | 1 | 45 | Butyl butyrate | 26 |
| | PK-12 | LPS | 16 | 22 | S-12 | 1 | 1 | 20 | Butyl butyrate | 26 |
| | PK-13 | LPS | 16 | 22 | S-13 | 1 | 1 | 25 | Butyl butyrate | 26 |
| | PK-14 | LPS | 16 | 22 | S-14 | 1 | 1 | 5 | Butyl butyrate | 26 |
| | PK-15 | LPS | 16 | 22 | S-15 | 1 | 1 | 2 | Butyl butyrate | 26 |
| | PK-16 | LPS | 16 | 22 | S-16 | 1 | 1 | 45 | Butyl butyrate | 26 |
| | PK-17 | LPS | 16 | 22 | S-17 | 1 | 1 | 0 | Butyl butyrate | 26 |
| | PK-18 | LPS | 16 | 22 | S-18 | 1 | 1 | 0 | Butyl butyrate | 26 |
| | PK-19 | LPS | 16 | 22 | S-19 | 1 | 1 | 0 | Butyl butyrate | 26 |
| | PR-20 | LPS | 16 | 22 | S-12/Lx-1 | 0.5/0.5 | 0.5/0.5 | 20/86 | Butyl butyrate | 26 |
| | PK-21 | LPS | 16 | 22 | S-12 | 1 | 1 | 20 | Xylene | 26 |
| | PK-22 | LPS | 16 | 22 | S-4/SA-1 | 0.5/0.5 | 0.5/0.5 | 0/5 | Butyl butyrate | 26 |
| | PK-23 | LPS | 16 | 22 | S-4/SA-1 | 0.5/0.5 | 0.5/0.5 | 0/12 | Xylene | 26 |
| | PK-24 | LPS | 16 | 22 | S-4/SA-1 | 0.25/0.75 | 0.25/0.75 | 0/12 | Xylene | 26 |
| | PK-25 | LPS | 16 | 22 | S-4/SA-1 | 0.1/0.9 | 0.1/0.9 | 0/12 | Xylene | 26 |
| | PK-26 | LPS | 16 | 22 | S-14/S4-2 | 0.5/0.5 | 8.501.5 | 5/2 | Butyl butyrate | 26 |
| | PK-27 | LPS | 16 | 22 | S-14/SA-3 | 0.5/0.5 | 0.5/0.5 | 5/3 | Butyl butyrate | 26 |
| | PK-28 | LPS | 16 | 22 | S-14/SA-4 | 0.5/0.5 | 0.5/0.5 | 5/8 | Butyl butyrate | 26 |
| | PK-29 | LPS | 16 | 22 | S-14/SA-3 | 0.5/0.5 | 0.5/0.5 | 5/4 | Butyl butyrate | 26 |
| Negative | NK-1 | LPS | 22 | 42 | S-1 | 1 | 2 | 0 | Butyl butyrate | 48 |
| electrode | NK-2 | LPS | 22 | 42 | S-2 | 1 | 2 | 0 | Butyl butyrate | 48 |
| composition | NK-3 | LPS | 22 | 42 | S-3 | 1 | 2 | 0 | Butyl butyrate | 48 |
| | NK-4 | LPS | 22 | 42 | S-4 | 1 | 2 | 0 | Butyl butyrate | 48 |
| | NK-5 | LPS | 22 | 42 | S-5 | 1 | 2 | 0 | Butyl butyrate | 48 |
| | NK-6 | LPS | 22 | 42 | S-6 | 1 | 2 | 15 | Butyl butyrate | 48 |
| | NK-7 | LPS | 22 | 42 | S-7 | 1 | 2 | 58 | Butyl butyrate | 48 |
| | NK-8 | LPS | 22 | 42 | S-8 | 1 | 2 | 0 | Butyl butyrate | 48 |
| | NK-9 | LPS | 22 | 42 | S-9 | 1 | 2 | 0 | Butyl butyrate | 48 |
| | NK-10 | LPS | 22 | 42 | S-10 | 1 | 2 | 5 | Butyl butyrate | 48 |
| | NK-11 | LPS | 22 | 42 | S-11 | 1 | 2 | 45 | Butyl butyrate | 48 |
| | NK-12 | LPS | 22 | 42 | S-12 | 1 | 2 | 20 | Butyl butyrate | 48 |
| | NK-13 | LPS | 22 | 42 | S-13 | 1 | 2 | 25 | Butyl butyrate | 48 |
| | NK-14 | LPS | 22 | 42 | S-14 | 1 | 2 | 5 | Butyl butyrate | 48 |
| | NK-15 | LPS | 22 | 42 | S-15 | 1 | 2 | 2 | Butyl butyrate | 48 |
| | NK-14 | LPS | 22 | 42 | S-16 | 1 | 2 | 45 | Butyl butyrate | 48 |
| | NK-32 | LPS | 22 | 42 | S-17 | 1 | 2 | 0 | Butyl butyrate | 48 |
| | NK-38 | LPS | 22 | 42 | S-18 | 1 | 2 | 0 | Butyl butyrate | 48 |
| | NK-19 | LPS | 22 | 42 | S-19 | 1 | 2 | 0 | Butyl butyrate | 48 |
| | NK-20 | LPS | 22 | 42 | S-12/Lx-1 | 0.5/0.5 | 1/1 | 20/86 | Butyl butyrate | 48 |
| | NK-21 | LPS | 22 | 42 | S-12 | 1 | 2 | 20 | Xylene | 48 |
| | NK 22 | LPS | 22 | 42 | S-12 | 1 | 2 | 20 | Xylene | 48 |
| | NK-23 | LPS | 22 | 42 | S-4/SA-1 | 0.5/0.5 | 1/1 | 0/5 | Butyl butyrate | 48 |
| | NK-24 | LPS | 22 | 43 | S-4/SA-1 | 0.5/0.5 | 1/1 | 0/12 | Xylene | 48 |
| | NK-25 | LPS | 22 | 42 | S-4/SA-1 | 0.25/0.75 | 0.5/1.5 | 0/12 | Xylene | 48 |
| | NK-26 | LPS | 22 | 42 | S-4/SA-1 | 0.1/0.9 | 0.2/1.5 | 0/12 | Xylene | 48 |
| | NK-27 | LPS | 22 | 42 | S-14/SA-2 | 0.5/0.5 | 1/1 | 5/2 | Butyl butyrate | 48 |
| | NK-28 | LPS | 22 | 42 | S-14/SA-3 | 0.5/0.5 | 1/1 | 5/3 | Butyl butyrate | 48 |
| | NK-29 | LPS | 22 | 42 | S-14/SA-4 | 0.5/0.5 | 1/1 | 5/8 | Butyl butyrate | 48 |
| | NK-30 | LPS | 22 | 42 | S-14/SA-5 | 0.5/0.5 | 1/1 | 5/4 | Butyl butyrate | 48 |
| | NKc1 | LPS | 22 | 42 | T-1 | 1 | 2 | 100 | Butyl butyrate | 48 |
| | NKc2 | LPS | 22 | 42 | T-2 | 1 | 2 | 0 | Butyl butyrate | 48 |
| | NKc3 | LPS | 22 | 42 | T-3 | 1 | 2 | 0 | Butyl butyrate | 48 |
| | NKc4 | LPS | 22 | 42 | T-4 | 1 | 2 | 70 | Butyl butyrate | 48 |
| | NKc5 | LPS | 22 | 42 | T-5 | 1 | 2 | 100 | Butyl butyrate | 48 |

| | | | | | Conductive | | | | |
|---|---|---|---|---|---|---|---|---|---|
| | | Active | Composition | Solid | auxiliary | Composition | Solid | | |
| | No. | material | content | content | agent | content | content | State | Note |
| Positive | PK-1 | NMC | 55 | 74 | AB | 2 | 3 | Dissolved | Present invention |
| electrode | PK-2 | NMC | 55 | 74 | AB | 2 | 3 | Dissolved | Present invention |
| composition | PK-3 | NMC | 55 | 74 | AB | 2 | 3 | Dissolved | Present invention |
| | PK-4 | NMC | 55 | 74 | AB | 2 | 3 | Dissolved | Present invention |
| | PK-5 | NMC | 55 | 74 | AB | 2 | 3 | Dissolved | Present invention |
| | PK-6 | NMC | 55 | 74 | AB | 2 | 3 | Dissolved | Present invention |
| | PK-7 | NMC | 55 | 74 | AB | 2 | 3 | Dissolved | Present invention |
| | PK-8 | NMC | 55 | 74 | AB | 2 | 3 | Dissolved | Present invention |
| | PK-9 | NMC | 55 | 74 | AB | 2 | 3 | Dissolved | Present invention |
| | PK-10 | NMC | 55 | 74 | AB | 2 | 3 | Dissolved | Present invention |
| | PK-11 | NMC | 55 | 74 | AB | 2 | 3 | Dissolved | Present invention |
| | PK-12 | NMC | 55 | 74 | AB | 2 | 3 | Dissolved | Present invention |
| | PK-13 | NMC | 55 | 74 | AB | 2 | 3 | Dissolved | Present invention |
| | PK-14 | NMC | 55 | 74 | AB | 2 | 3 | Dissolved | Present invention |
| | PK-15 | NMC | 55 | 74 | AB | 2 | 3 | Dissolved | Present invention |
| | PK-16 | NMC | 55 | 74 | AB | 2 | 3 | Dissolved | Present invention |
| | PK-17 | NMC | 55 | 74 | AB | 2 | 3 | Dissolved | Present invention |
| | PK-18 | NMC | 55 | 74 | AB | 2 | 3 | Dissolved | Present invention |
| | PK-19 | NMC | 55 | 74 | AB | 2 | 3 | Dissolved | Present invention |
| | PR-20 | NMC | 55 | 74 | AB | 2 | 3 | Dissolved/ | Present invention |
| | | | | | | | | particulate | |
| | PK-21 | NMC | 55 | 74 | AB | 2 | 3 | Dissolved | Present invention |
| | PK-22 | NMC | 55 | 74 | AB | 2 | 3 | Dissolved/ | Present invention |
| | | | | | | | | dissolved | |
| | PK-23 | NMC | 55 | 74 | AB | 2 | 3 | Dissolved/ | Present invention |
| | | | | | | | | dissolved | |
| | PK-24 | NMC | 55 | 74 | AB | 2 | 3 | Dissolved/ | Present invention |
| | | | | | | | | dissolved | |
| | PK-25 | NMC | 55 | 74 | AB | 2 | 3 | Dissolved/ | Present invention |
| | | | | | | | | dissolved | |
| | PK-26 | NMC | 55 | 74 | AB | 2 | 3 | Dissolved/ | Present invention |
| | | | | | | | | dissolved | |
| | PK-27 | NMC | 55 | 74 | AB | 2 | 3 | Dissolved/ | Present invention |
| | | | | | | | | dissolved | |
| | PK-28 | NMC | 55 | 74 | AB | 2 | 3 | Dissolved/ | Present invention |
| | | | | | | | | dissolved | |
| | PK-29 | NMC | 55 | 74 | AB | 2 | 3 | Dissolved/ | Present invention |
| | | | | | | | | dissolved | |
| Negative | NK-1 | Si | 26 | 50 | VGCF | 3 | 6 | Dissolved | Present invention |
| electrode | NK-2 | Si | 26 | 50 | VGCF | 3 | 6 | Dissolved | Present invention |
| composition | NK-3 | Si | 26 | 50 | VGCF | 3 | 6 | Dissolved | Present invention |
| | NK-4 | Si | 26 | 50 | VGCF | 3 | 6 | Dissolved | Present invention |
| | NK-5 | Si | 26 | 50 | VGCF | 3 | 6 | Dissoived | Present invention |
| | NK-6 | Si | 26 | 50 | VGCF | 3 | 6 | Dissolved | Present invention |
| | NK-7 | Si | 26 | 50 | VGCF | 3 | 6 | Dissolved | Present invention |
| | NK-8 | Si | 26 | 50 | VGCF | 3 | 6 | Dissolved | Present invention |
| | NK-9 | Si | 26 | 50 | VGCF | 3 | 6 | Dissolved | Present invention |
| | NK-10 | Si | 26 | 50 | VGCF | 3 | 6 | Dissolved | Present invention |
| | NK-11 | Si | 26 | 50 | VGCF | 3 | 6 | Dissolved | Present invention |
| | NK-12 | Si | 26 | 50 | VGCF | 3 | 6 | Dissolved | Present invention |
| | NK-13 | Si | 26 | 50 | VGCF | 3 | 6 | Dissolved | Present invention |
| | NK-14 | Si | 26 | 50 | VGCF | 3 | 6 | Dissolved | Present invention |
| | NK-15 | Si | 26 | 50 | VGCF | 3 | 6 | Dissolved | Present invention |
| | NK-14 | Si | 26 | 50 | VGCF | 3 | 6 | Dissolved | Present invention |
| | NK-32 | Si | 26 | 50 | VGCF | 3 | 6 | Dissolved | Present invention |
| | NK-38 | Si | 26 | 50 | VGCF | 3 | 6 | Dissolved | Present invention |
| | NK-19 | Si | 26 | 50 | VGCF | 3 | 6 | Dissolved | Present invention |
| | NK-20 | Si | 26 | 50 | VGCF | 3 | 6 | Dissolved/ | Present invention |
| | | | | | | | | particulate | |
| | NK-21 | Si | 26 | 50 | VGCF | 3 | 6 | Dissolved | Present invention |
| | NK 22 | Graphite | 26 | 50 | VGCF | 3 | 6 | Dissolved | Present invention |
| | NK-23 | Si | 26 | 50 | VGCF | 3 | 6 | Dissolved/ | Present invention |
| | | | | | | | | dissolved | |
| | NK-24 | Si | 26 | 50 | VGCF | 3 | 6 | Dissolved/ | Present invention |
| | | | | | | | | dissolved | |
| | NK-25 | Si | 26 | 50 | VGCF | 3 | 6 | Dissolved/ | Present invention |
| | | | | | | | | dissolved | |
| | NK-26 | Si | 26 | 50 | VGCF | 3 | 6 | Dissolved/ | Present invention |
| | | | | | | | | dissolved | |
| | NK-27 | Si | 26 | 50 | VGCF | 3 | 6 | Dissolved/ | Present invention |
| | | | | | | | | dissolved | |
| | NK-28 | Si | 26 | 50 | VGCF | 3 | 6 | Dissolved/ | Present invention |
| | | | | | | | | dissolved | |
| | NK-29 | Si | 26 | 50 | VGCF | 3 | 6 | Dissolved/ | Present invention |
| | | | | | | | | dissolved | |
| | NK-30 | Si | 26 | 50 | VGCF | 3 | 6 | Dissolved/ | Present invention |
| | | | | | | | | dissolved | |
| | NKc1 | Si | 26 | 50 | VGCF | 3 | 6 | Particulate | Comparative Example |
| | NKc2 | Si | 26 | 50 | VGCF | 3 | 6 | Dissolved | Comparative Example |
| | NKc3 | Si | 26 | 50 | VGCF | 3 | 6 | Dissolved | Comparative Example |
| | NKc4 | Si | 26 | 50 | VGCF | 3 | 6 | Dissolved | Comparative Example |
| | NKc5 | Si | 26 | 50 | VGCF | 3 | 6 | Particulate | Comparative Example |

<Abbreviations in table>
LPS: LPS synthesized in Synthesis Example A
LLT: Li_{0.33}La_{0.55}TiO₃ (average particle diameter: 3.25 μm, manufactured by TOSHIMA manufacturing Co., Ltd.)
NMC: LiNi_{1/3}Co_{1/3}Mn_{1/3}O₂
Si: Silicon (Si, manufactured by Sigma-Aldrich Co., LLC)
Graphite: Graphite (manufactured by Sigma-Aldrich Co., LLC)
AB: Acetylene black
VGCF: Carbon nanotube (manufactured by Showa Denko K.K.)

<Production of Solid Electrolyte Sheet for all-Solid State Secondary Battery>

Each of the inorganic solid electrolyte-containing compositions shown in the column of “Composition No.” of Table 3-1 obtained as above was applied onto an aluminum foil having a thickness of 20 μm using a baker type applicator (product name: SA-201, manufactured by Tester Sangyo Co., Ltd.) and heated at 80° C. for 2 hours to dry (to remove the dispersion medium) the inorganic solid electrolyte-containing composition. Then, using a heat press machine, the dried inorganic solid electrolyte-containing composition was heated and pressurized at a temperature of 120° C. and a pressure of 40 MPa for 10 seconds to produce each of solid electrolyte sheets 101 to 122, 166 to 169, 178 to 181, and c11 to c15 for an all-solid state secondary battery (in Table 3-1, it is denoted as “Solid electrolyte sheet”). The film thickness of the solid electrolyte layer was 50 μm.

<Production of Positive Electrode Sheet for all-Solid State Secondary Battery>

Each of the positive electrode compositions obtained as described above, which is shown in the column of “Composition No.” in Table 3-2, was applied onto an aluminum foil having a thickness of 20 μm by using a baker type applicator (product name: SA-201), heating was carried out at 80° C. for 1 hour, and then heating was further carried out at 110° C. for 1 hour to dry (to remove the dispersion medium) the positive electrode composition. Then, using a heat press machine, the dried positive electrode composition was pressurized (10 MPa, 1 minute) at 25° C. to produce each of positive electrode sheets 123 to 143, 170 to 173, and 182 to 185 for an all-solid state secondary battery, having a positive electrode active material layer having a film thickness of 80 μm (in Table 3-2, it is denoted as “Positive electrode sheet”).

<Production of Negative Electrode Sheet for all-Solid State Secondary Battery>

Each of the negative electrode compositions obtained as above, which is shown in the column of “Composition No.” in Table 3-3, was applied onto a copper foil having a thickness of 20 μm by using a baker type applicator (product name: SA-201), heating was carried out at 80° C. for 1 hour, and then heating was further carried out at 110° C. for 1 hour to dry (to remove the dispersion medium) the negative electrode composition. Then, using a heat press machine, the dried negative electrode composition was pressurized (10 MPa, 1 minute) at 25° C. to produce each of negative electrode sheets 144 to 165, 174 to 177, 186 to 189, and c16 to c20 for an all-solid state secondary battery, having a negative electrode active material layer having a film thickness of 70 μm (in Table 3-3, it is denoted as “Negative electrode sheet”).

<Evaluation 1: Dispersion Stability (Sedimentary Property of Slurry)>

Each of the prepared compositions (slurries) was put into a glass test tube having a diameter of 10 mm and a height of 4 cm up to a height of 4 cm and allowed to stand at 25° C. for 36 hours. The solid content ratio between the solid contents before and after allowing the standing was calculated regarding the slurry within 1 cm from the slurry liquid surface. Specifically, immediately after allowing the standing, the liquid down to 1 cm below the slurry liquid surface was taken out and dried by heating in an aluminum cup at 120° C. for 2 hours. Then, the mass of the solid content in the cup was measured to determine the solid content before and after allowing standing. The solid content obtained in this manner was used to determine the solid content ratio [WA/WB] of the solid content WA after allowing standing to the solid content WB before allowing standing.

The ease of sedimentation (sedimentary property) of the inorganic solid electrolyte was evaluated as the dispersion stability of the solid electrolyte composition by determining where the above solid content ratio is included in any of the following evaluation standards. In this test, it is indicated that the closer the solid content ratio is to 1, the better the dispersion stability is, and the evaluation standard “D” or higher is the pass level. The results are shown in Table 3-1 to Table 3-3 (collectively referred to as Table 3).

—Evaluation Standards—
A: 0.9≤solid content ratio≤1.0
B: 0.7≤solid content ratio<0.9
C: 0.5≤solid content ratio<0.7
D: 0.3≤solid content ratio<0.5
E: 0.1≤solid content ratio<0.3
F: solid content ratio<0.1

<Evaluation 2: Handleability>

In the same manner as in each of the prepared compositions, the same mixing ratio was used except for the dispersion medium, and the amount of the dispersion medium was reduced, whereby a slurry having a concentration of solid contents of 75% by mass was prepared. A 2 mL poly dropper (manufactured by atect Corporation) was arranged vertically so that 10 mm of the tip thereof was positioned below the slurry interface, and the slurry was aspirated at 25° C. for 10 seconds, and the mass W of the poly dropper containing the aspirated slurry was measured. In a case where the tare weight (the empty weight) of the poly dropper is denoted by W₀, it was determined that the slurry cannot be aspirated by the dropper in a case where the slurry mass W—W₀ is less than 0.1 g. In a case where the slurry could not be aspirated with a dropper, the upper limit of the concentration of solid contents at which the slurry can be aspirated with a dropper was estimated while gradually adding the dispersion medium. The handleability (the extent to which an appropriate viscosity suitable for forming a flat constitutional layer having a good surface property can be obtained) of the composition was evaluated by determining where the obtained upper limit of concentration of solid contents is included in any one of the following evaluation standards. 0.30 g of the prepared slurry was placed on an aluminum cup and heated at 120° C. for 2 hours to distill off the dispersion medium, and the concentration of solid contents was calculated.
In this test, it is indicated that the higher the upper limit of concentration of solid contents is, the better the handleability is, and the evaluation standard “D” or higher is the pass level. The results are shown in Table 3.

—Evaluation Standards—
A: Upper limit of concentration of solid contents >70%
B: 70%>upper limit of concentration of solid contents ≥60%
C: 60%>upper limit of concentration of solid contents ≥50%
D: 50%>upper limit of concentration of solid contents ≥40%
E: 40%>upper limit of concentration of solid contents ≥30%
F: 30%>upper limit of concentration of solid contents

<Evaluation 3: Adhesiveness>

The adhesiveness of the solid particles in the solid electrolyte layer or active material layer of each produced sheet and the adhesiveness between the active material layer and the collector were evaluated.

The produced sheet was cut out into a rectangle having a width of 3 cm and a length of 14 cm. Using a cylindrical mandrel tester (product code: 056, mandrel diameter: 10 mm, manufactured by Allgood Co., Ltd.), one end part of the cut-out sheet test piece in the length direction was fixed to the tester and disposed so that the cylindrical mandrel touched to the central portion of the sheet test piece, and then the sheet test piece was bent by 1800 along the peripheral surface of the mandrel (with the mandrel as an axis) while pulling the other end part of the sheet test piece in the length direction with a force of 5N along the length direction. It is noted that the sheet test piece was set so that the solid electrolyte layer or active material layer thereof was placed on a side opposite to the mandrel (the base material or the collector was placed on the side of the mandrel) and the width direction was parallel to the axis line of the mandrel. The test was carried out by gradually reducing the diameter of the mandrel from 32 mm.

In a state of being wound around the mandrel and a state of being restored to a sheet shape by releasing the winding, the occurrence of defects (cracking, breakage, chipping, and the like) due to the disintegration of binding of solid particles in the solid electrolyte layer or the active material layer and for the active material layer, the minimum diameter at which the peeling between the active material layer and the collector could not be confirmed were measured, and the evaluation was carried out by determining which evaluation standard below is satisfied by the minimum diameter.

In this test, it is indicated that the smaller the minimum diameter is, the firmer the binding force of the solid particles that constitute the solid electrolyte layer or active material layer is, and the firmer the adhesive force between the active material layer and the collector is, and an evaluation standard “D” or higher is the pass level.

—Evaluation Standards—
A: Minimum diameter <5 mm
B: 5 mm≤minimum diameter <6 mm
C: 6 mm≤minimum diameter <8 mm
D: 8 mm≤minimum diameter <10 mm
E: 10 mm≤minimum diameter <14 mm
F: 14 mm≤minimum diameter <25 mm
G: 25 mm≤minimum diameter

TABLE 3

| | Sheet | Composition | Binder solution | Dispersion | | | |
|---|---|---|---|---|---|---|---|
| | No. | No. | or like No. | stability | Handleability | Adhesiveness | Note |
| Solid | 101 | K-1 | S-1 | B | B | B | Present invention |
| electrolyte | 102 | K-2 | S-2 | B | B | B | Present invention |
| sheet | 103 | K-3 | S-3 | B | B | A | Present invention |
| | 104 | K-4 | S-4 | B | B | A | Present invention |
| | 105 | K-5 | S-5 | B | B | A | Present invention |
| | 106 | K-6 | S-6 | A | A | A | Present invention |
| | 107 | K-7 | S-7 | A | A | B | Present invention |
| | 108 | K-8 | S-8 | B | B | A | Present invention |
| | 109 | K-9 | S-9 | B | B | A | Present invention |
| | 110 | K-10 | S-10 | B | B | A | Present invention |
| | 111 | K-11 | S-11 | B | B | B | Present invention |
| | 112 | K-12 | S-12 | A | A | A | Present invention |
| | 113 | K-13 | S-13 | A | A | A | Present invention |
| | 114 | K-14 | S-14 | C | B | A | Present invention |
| | 115 | K-15 | S-15 | C | C | A | Present invention |
| | 116 | K-16 | S-16 | B | B | B | Present invention |
| | 117 | K-17 | S-17 | C | B | B | Present invention |
| | 118 | K-18 | S-18 | B | C | C | Present invention |
| | 119 | K-19 | S-19 | B | B | B | Present invention |
| | 120 | K-20 | S-12/Lx-1 | B | B | A | Present invention |
| | 121 | K-21 | S-12 | A | A | A | Present invention |
| | 122 | K-22 | S-13 | A | A | A | Present invention |
| | 166 | K-23 | S-4/SA-1 | A | A | A | Present invention |
| | 167 | K-24 | S-4/SA-1 | A | A | A | Present invention |
| | 168 | K-25 | S-4/SA-1 | A | A | A | Present invention |
| | 169 | K-26 | S-4/SA-1 | A | A | A | Present invention |
| | 178 | K-27 | S-14/SA-2 | A | A | A | Present invention |
| | 179 | K-28 | S-14/SA-3 | A | A | A | Present invention |
| | 180 | K-29 | S-14/SA-4 | A | A | A | Present invention |
| | 181 | K-30 | S-14/SA-5 | A | A | A | Present invention |
| | c11 | Kc1 | T-1 | E | E | D | Comparative |
| | | | | | | | Example |
| | c12 | Kc2 | T-2 | B | B | D | Comparative |
| | | | | | | | Example |
| | c13 | Kc3 | T-3 | B | B | D | Comparative |
| | | | | | | | Example |
| | c14 | Kc4 | T-4 | E | E | D | Comparative |
| | | | | | | | Example |
| | c15 | Kc5 | T-5 | F | F | E | Comparative |
| | | | | | | | Example |
| Positive | 123 | PK-1 | S-1 | B | B | C | Present invention |
| electrode | 124 | PK-2 | S-2 | B | B | B | Present invention |
| sheet | 125 | PK-3 | S-3 | B | B | A | Present invention |
| | 126 | PK-4 | S-4 | B | B | A | Present invention |
| | 127 | PK-5 | S-5 | B | B | A | Present invention |
| | 128 | PK-6 | S-6 | A | A | A | Present invention |
| | 129 | PK-7 | S-7 | A | A | C | Present invention |
| | 130 | PK-8 | S-8 | B | B | A | Present invention |
| | 131 | PK-9 | S-9 | B | B | A | Present invention |
| | 132 | PK-10 | S-10 | B | B | A | Present invention |
| | 133 | PK-11 | S-11 | B | B | B | Present invention |
| | 134 | PK-12 | S-12 | A | A | A | Present invention |
| | 135 | PK-13 | S-13 | A | A | A | Present invention |
| | 136 | PK-14 | S-14 | C | B | A | Present invention |
| | 137 | PK-15 | S-15 | C | C | A | Present invention |
| | 138 | PK-16 | S-16 | B | B | C | Present invention |
| | 139 | PK-17 | S-17 | C | B | C | Present invention |
| | 140 | PK-18 | S-18 | B | C | D | Present invention |
| | 141 | PK-19 | S-19 | B | B | B | Present invention |
| | 142 | PK-20 | S-12/Lx-1 | B | B | A | Present invention |
| | 143 | PK-21 | S-12 | A | A | A | Present invention |
| | 170 | PK-22 | S-4/SA-1 | A | A | A | Present invention |
| | 171 | PK-23 | S-4/SA-1 | A | A | A | Present invention |
| | 172 | PK-24 | S-4/SA-1 | A | A | A | Present invention |
| | 173 | PK-25 | S-4/SA-1 | A | A | A | Present invention |
| | 182 | PK-26 | S-14/SA-2 | A | A | A | Present invention |
| | 183 | PK-27 | S-14/SA-3 | A | A | A | Present invention |
| | 184 | PK-28 | S-14/SA-4 | A | A | A | Present invention |
| | 185 | PK-29 | S-14/SA-5 | A | A | A | Present invention |
| | Sheet | Composition | Binder solution | Dispersion | | | Sheet |
| | No. | No. | or like No. | stability | Handleability | Adhesiveness | No. |
| Negative | 144 | NK-1 | S-1 | B | B | C | Present invention |
| electrode | 145 | NK-2 | S-2 | B | B | B | Present invention |
| sheet | 146 | NK-3 | S-3 | B | B | A | Present invention |
| | 147 | NK-4 | S-4 | B | B | A | Present invention |
| | 148 | NK-5 | S-5 | B | B | A | Present invention |
| | 149 | NK-6 | S-6 | A | A | A | Present invention |
| | 150 | NK-7 | S-7 | A | A | C | Present invention |
| | 151 | NK-8 | S-8 | B | B | A | Present invention |
| | 152 | NK-9 | S-9 | B | B | A | Present invention |
| | 153 | NK-10 | S-10 | B | B | A | Present invention |
| | 154 | NK-11 | S-11 | B | B | C | Present invention |
| | 155 | NK-12 | S-12 | A | A | A | Present invention |
| | 156 | NK-13 | S-13 | A | A | A | Present invention |
| | 157 | NK-14 | S-14 | C | B | A | Present invention |
| | 158 | NK-15 | S-15 | C | C | A | Present invention |
| | 159 | NK-16 | S-16 | B | B | C | Present invention |
| | 160 | NK-17 | S-17 | C | B | C | Present invention |
| | 161 | NK-18 | S-18 | B | C | D | Present invention |
| | 162 | NK-19 | S-19 | B | B | B | Present invention |
| | 163 | NK-20 | S-12/Lx-1 | B | B | A | Present invention |
| | 164 | NK-21 | S-12 | A | A | A | Present invention |
| | 165 | NK-22 | S-12 | A | A | A | Present invention |
| | 174 | NK-23 | S-4/SA-1 | A | A | A | Present invention |
| | 175 | NK-24 | S-4/SA-1 | A | A | A | Present invention |
| | 176 | NK-25 | S-4/SA-1 | A | A | A | Present invention |
| | 177 | NK-26 | S-4/SA-1 | A | A | A | Present invention |
| | 186 | NK-27 | S-14/SA-2 | A | A | A | Present invention |
| | 187 | NK-28 | S-14/SA-3 | A | A | A | Present invention |
| | 188 | NK-29 | S-14/SA-4 | A | A | A | Present invention |
| | 189 | NK-30 | S-14/SA-5 | A | A | A | Present invention |
| | c16 | NKc1 | T-1 | E | E | E | Comparative |
| | | | | | | | Example |
| | c17 | NKc2 | T-2 | B | B | E | Comparative |
| | | | | | | | Example |
| | c18 | NKc3 | T-3 | B | B | E | Comparative |
| | | | | | | | Example |
| | c19 | NKc4 | T-4 | E | E | E | Comparative |
| | | | | | | | Example |
| | c20 | NKc5 | T-5 | F | F | F | Comparative |
| | | | | | | | Example |

In Table 3, in a case where the polymer binder PB defined in the present invention is used in combination with the particulate binder PB32 or the chain polymerization binder PB3, it is described together by using “/” in the column of “No. of binder solution or like” in Table 3.

<Manufacture of all-Solid State Secondary Battery>

First, an electrode sheet for an all-solid state secondary battery including a solid electrolyte layer was produced as follows.

(Production of Positive Electrode Sheet for all-Solid State Secondary Battery, which Includes Solid Electrolyte Layer)

The solid electrolyte sheet shown in the column of “Solid electrolyte layer (sheet No.)” of Table 4-1, produced as described above, was overlaid on the positive electrode active material layer of each of the positive electrode sheets for an all-solid state secondary battery shown in the column of “Electrode active material layer (sheet No.)” of Table 4-1 so that it came into contact with the positive electrode active material layer, transferred (laminated) by being pressurized at 50 MPa and 25° C. using a press machine, and then pressurized at 600 MPa and at 25° C., whereby each of positive electrode sheets 123 to 143, 170 to 173, and 182 to 185 for an all-solid state secondary battery including a solid electrolyte layer having a film thickness of 30 μm (film thickness of positive electrode active material layer: 60 μm) was produced.

It is noted that as shown in Table 4-1, two kinds (No. 113 and 122) in which the solid electrolyte layers 113 or 122 were laminated were produced as a positive electrode sheet 135 for an all-solid state secondary battery including a solid electrolyte layer.

<Production of Negative Electrode Sheet for all-Solid State Secondary Battery, which Includes Solid Electrolyte Layer>

Next, the solid electrolyte sheet shown in the column of “Solid electrolyte layer (sheet No.)” of Table 4-2, produced as described above, was overlaid on the negative electrode active material layer of each of the negative electrode sheets for an all-solid state secondary battery shown in the column of “Electrode active material layer (sheet No.)” of Table 4-2 so that it came into contact with the negative electrode active material layer, transferred (laminated) by being pressurized at 50 MPa and 25° C. using a press machine, and then pressurized at 600 MPa and at 25° C., whereby each of negative electrode sheets 144 to 165, 174 to 177, 186 to 189, and c16 to c20 for an all-solid state secondary battery including a solid electrolyte layer having a film thickness of 30 μm (film thickness of negative electrode active material layer: 50 μm) was produced.

(Manufacture of all-Solid State Secondary Battery)

Next, an all-solid state secondary battery having a layer configuration illustrated in FIG. 1 was manufactured as follows.

1. Manufacture of all-Solid State Secondary Battery No. 101

The positive electrode sheet No. 123 for an all-solid state secondary battery (the aluminum foil of the solid electrolyte-containing sheet had been peeled off), which included the solid electrolyte layer obtained above, was cut out into a disk shape having a diameter of 14.5 mm and placed, as illustrated in FIG. 2, in a stainless 2032-type coin case 11 into which a spacer and a washer (not illustrated in FIG. 2) had been incorporated. Next, a lithium foil cut out in a disk shape having a diameter of 15 mm was overlaid on the solid electrolyte layer. After further overlaying a stainless steel foil thereon, the 2032-type coin case 11 was crimped to manufacture an all-solid state secondary battery 13 (No. 101), illustrated in FIG. 2.

The all-solid state secondary battery manufactured in this manner has a layer configuration illustrated in FIG. 1 (however, the lithium foil corresponds to a negative electrode active material layer 2 and a negative electrode collector 1).

2. Manufacture of all-Solid State Secondary Battery Nos. 102 to 122, 145 to 148, and 153 to 156

Each of all-solid state secondary batteries Nos. 102 to 122, 145 to 148, and 153 to 156 was manufactured in the same manner as in the manufacture of the all-solid state secondary battery No. 101, except that in the manufacture of the all-solid state secondary battery No. 101, a positive electrode sheet for an all-solid state secondary battery, which includes a solid electrolyte layer and is indicated by No. shown in the column of “Electrode active material layer (sheet No.)” of Table 4-1 was used instead of the positive electrode sheet No. 123 for an all-solid state secondary battery, which includes a solid electrolyte layer.

3. Manufacture of all-Solid State Secondary Battery No. 123

The negative electrode sheet No. 144 for an all-solid state secondary battery (the aluminum foil of the solid electrolyte-containing sheet had been peeled off) obtained above, which has the solid electrolyte, was cut out into a disk shape having a diameter of 14.5 mm and placed, as illustrated in FIG. 2, in a stainless 2032-type coin case 11 into which a spacer and a washer (not illustrated in FIG. 2) had been incorporated. Next, a positive electrode sheet (a positive electrode active material layer), which had been punched out from the positive electrode sheet for an all-solid state secondary battery produced below into a diameter of 14.0 mm, was overlaid on the solid electrolyte layer. A stainless steel foil (a positive electrode collector) was further overlaid thereon to form a laminate 12 for an all-solid state secondary battery (a laminate consisting of stainless steel foil—aluminum foil—positive electrode active material layer—solid electrolyte layer—negative electrode active material layer—copper foil). Then, the 2032-type coin case 11 was crimped to manufacture an all-solid state secondary battery No. 123 illustrated in FIG. 2.

A positive electrode sheet for an all solid state secondary battery to be used in the manufacture of the all-solid state secondary battery No. 123 was prepared as follows.

(Preparation of Positive Electrode Composition)

180 beads of zirconia beads having a diameter of 5 mm were put into a 45 mL container made of zirconia (manufactured by FRITSCH), 2.7 g of the LPS synthesized in the above Synthesis Example A, and 0.3 g of KYNAR FLEX 2500-20 (product name, PVdF-HFP: polyvinylidene fluoride-hexafluoropropylene copolymer, manufactured by Arkema S.A.) in terms of a solid content mass and 22 g of butyl butyrate were put into the above container. The container was set in a planetary ball mill P-7 (product name, manufactured by FRITSCH) and the components were stirred for 60 minutes at 25° C. and a rotation speed of 300 rpm. Then, 7.0 g of LiNi_{1/3}Co_{1/3}Mn_{1/3}O₂(NMC) was put into the container as the positive electrode active material, and similarly, the container was set in a planetary ball mill P-7, mixing was continued at 25° C. and a rotation speed of 100 rpm for 5 minutes to prepare a positive electrode composition.

(Production of Positive Electrode Sheet for all Solid State Secondary Battery)

The positive electrode composition obtained as described above was applied onto an aluminum foil (a positive electrode collector) having a thickness of 20 μm with a baker type applicator (product name: SA-201, manufactured by Tester Sangyo Co., Ltd.), heating was carried out at 100° C. for 2 hours to dry (to remove the dispersion medium) the positive electrode composition. Then, using a heat press machine, the dried positive electrode composition was pressurized (10 MPa, 1 minute) at 25° C. to produce each of positive electrode sheets for an all-solid state secondary battery, having a positive electrode active material layer having a film thickness of 80 μm.

4. Manufacture of all-Solid State Secondary Battery Nos. 124 to 144, 149 to 152, 157 to 160, and c101 to c105

Each of all-solid state secondary batteries Nos. 124 to 144, 149 to 152, 157 to 160, and c101 to c105 was manufactured in the same manner as in the manufacture of the all-solid state secondary battery No. 123, except that in the manufacture of the all-solid state secondary battery No. 123, a negative electrode sheet for an all-solid state secondary battery, which includes a solid electrolyte layer and is indicated by No. shown in the column of “Electrode active material layer (sheet No.)” of Table 4 was used instead of the negative electrode sheet No. 144 for an all-solid state secondary battery, which includes a solid electrolyte layer.

<Evaluation 4: Measurement of Ion Conductivity>

The ion conductivity of each of the manufactured all-solid state secondary batteries was measured. Specifically, the alternating-current impedance of each of the all-solid state secondary batteries was measured in a constant-temperature tank (30° C.) using a 1255B FREQUENCY RESPONSE ANALYZER (product name, manufactured by SOLARTRON Analytical) at a voltage magnitude of 5 mV and a frequency of 1 MHz to 1 Hz. From the measurement result, the resistance of the sample for measuring ion conductivity in the layer thickness direction was determined, and the ion conductivity was determined by the calculation according to Expression (1).

Ion conductivity σ (mS/cm)=1,000×sample layer thickness (cm)/[resistance (Ω)×sample area (cm²)] Expression (1):

In Expression (1), the sample layer thickness is a value obtained by measuring the thickness before placing the laminate 12 in the 2032-type coin case 11 and subtracting the thickness of the collector (the total layer thickness of the solid electrolyte layer and the electrode active material layer). The sample area is the area of the disk-shaped sheet having a diameter of 14.5 mm.

It was determined where the obtained ion conductivity a was included in any of the following evaluation standards.

In this test, in a case where the evaluation standard is “C” or higher, the ion conductivity a is the pass level.

—Evaluation Standards—
A: 0.60≤σ
B: 0.50≤σ<0.60
C: 0.40≤σ<0.50
D: 0.30≤σ<0.40
E: 0.20≤σ<0.30
F: σ<0.20

<Evaluation 5: Cycle Characteristics (Discharge Capacity Retention Rate) Test>

The discharge capacity retention rate of each of the manufactured all-solid state secondary batteries was measured using a charging and discharging evaluation device TOSCAT-3000 (product name, manufactured by Toyo System Corporation).

Specifically, each of the all-solid state secondary batteries was charged in an environment of 30° C. at a current density of 0.1 mA/cm² until the battery voltage reached 3.6 V. Then, the battery was discharged at a current density of 0.1 mA/cm² until the battery voltage reached 2.5 V. One charging operation and one discharging operation were set as one cycle of charging and discharging, and 3 cycles of charging and discharging were repeated under the same conditions to carry out initialization. Then, the high-speed charging at a current density of 3.0 mA/cm² until the battery voltage reaches 3.6 V and the high-speed discharging at a current density of 3.0 mA/cm² until the battery voltage reaches 2.5 V was set as one cycle, and this high-speed charging and discharging cycle was repeatedly carried out 500 cycles. The discharge capacity of each all-solid state secondary battery at the first cycle of the high-speed charging and discharging and the discharge capacity at the 500th cycle of the high-speed charging and discharging were measured with a charging and discharging evaluation device: TOSCAT-3000 (product name). The discharge capacity retention rate was calculated according to the following expression, and this discharge capacity retention rate was applied to the following evaluation standards to evaluate the cycle characteristics of the all-solid state secondary battery. In this test, an evaluation standard of “C” or higher is the pass level. The results are shown in Table 4.

Discharge capacity retention rate (%)=(discharge capacity at 500th cycle/discharge capacity at first cycle)×100

In this test, the higher the evaluation standard is, the better the battery performance (the cycle characteristics) is, and the initial battery performance can be maintained even in a case where a plurality of times of high-speed charging and discharging are repeated (even in a case of the long-term use).

All of the all-solid state secondary batteries for evaluation according to the embodiment of the present invention exhibited the discharge capacity values at the first cycle which are sufficient for functioning as an all-solid state secondary battery. Moreover, the all-solid state secondary battery for evaluation according to the embodiment of the present invention maintained excellent cycle characteristics even in a case where the general charging and discharging cycle was repeatedly carried out under the same conditions as those in the above-described initialization instead of those in the high-speed charging and discharging.

—Evaluation Standards—
A: 90%≤discharge capacity retention rate
B: 85%≤discharge capacity retention rate <90%
C: 80%≤discharge capacity retention rate <85%
D: 75%≤discharge capacity retention rate <80%
E: 70%≤discharge capacity retention rate <75%
F: 60%≤discharge capacity retention rate <70%
G: Discharge capacity retention rate <60%

TABLE 4-1

| | Layer configuration | | | | |
|---|---|---|---|---|---|
| | Electrode active | Solid electrolyte | | | |
| | material layer | layer | Cycle | Ion | |
| No. | (sheet No.) | (sheet No.) | characteristics | conductivity | Note |
| 101 | 123 | 101 | C | B | Present invention |
| 102 | 124 | 102 | C | B | Present invention |
| 103 | 125 | 103 | C | B | Present invention |
| 104 | 126 | 104 | C | B | Present invention |
| 105 | 127 | 105 | C | B | Present invention |
| 106 | 128 | 106 | A | A | Present invention |
| 107 | 129 | 107 | A | A | Present invention |
| 108 | 130 | 108 | B | B | Present invention |
| 109 | 131 | 109 | B | B | Present invention |
| 110 | 132 | 110 | B | B | Present invention |
| 111 | 133 | 111 | B | B | Present invention |
| 112 | 134 | 112 | A | A | Present invention |
| 113 | 135 | 113 | A | A | Present invention |
| 114 | 136 | 114 | C | B | Present invention |
| 115 | 137 | 115 | A | A | Present invention |
| 116 | 138 | 116 | B | B | Present invention |
| 117 | 139 | 117 | C | B | Present invention |
| 118 | 140 | 118 | C | B | Present invention |
| 119 | 141 | 119 | B | C | Present invention |
| 120 | 142 | 120 | A | A | Present invention |
| 121 | 143 | 121 | A | A | Present invention |
| 122 | 135 | 122 | A | A | Present invention |
| 145 | 170 | 166 | B | B | Present invention |
| 146 | 171 | 167 | B | B | Present invention |
| 147 | 172 | 168 | B | A | Present invention |
| 148 | 173 | 169 | A | A | Present invention |
| 153 | 182 | 178 | A | B | Present invention |
| 154 | 183 | 179 | A | B | Present invention |
| 155 | 184 | 180 | A | B | Present invention |
| 156 | 185 | 181 | A | B | Present invention |
| 123 | 144 | 101 | C | B | Present invention |
| 124 | 145 | 102 | C | B | Present invention |
| 125 | 146 | 103 | C | B | Present invention |
| 126 | 147 | 104 | C | B | Present invention |
| 127 | 148 | 105 | C | B | Present invention |
| 128 | 149 | 106 | A | A | Present invention |
| 129 | 150 | 107 | A | A | Present invention |
| 130 | 151 | 108 | B | B | Present invention |
| 131 | 152 | 109 | B | B | Present invention |
| 132 | 153 | 110 | B | B | Present invention |
| 133 | 154 | 111 | B | B | Present invention |
| 134 | 155 | 112 | A | A | Present invention |
| 135 | 156 | 113 | A | A | Present invention |
| 136 | 157 | 114 | C | B | Present invention |
| 137 | 158 | 115 | A | A | Present invention |
| 138 | 159 | 116 | B | B | Present invention |
| 139 | 160 | 117 | C | C | Present invention |
| 140 | 161 | 118 | C | C | Present invention |
| 141 | 162 | 119 | C | C | Present invention |
| 142 | 163 | 120 | A | A | Present invention |
| 143 | 164 | 121 | A | A | Present invention |
| 144 | 165 | 121 | A | A | Present invention |
| 149 | 174 | 166 | B | B | Present invention |
| 150 | 175 | 167 | B | B | Present invention |
| 151 | 176 | 168 | B | A | Present invention |
| 152 | 177 | 169 | A | A | Present invention |
| 157 | 186 | 178 | A | B | Present invention |
| 158 | 187 | 179 | A | B | Present invention |
| 159 | 188 | 180 | A | B | Present invention |
| 160 | 189 | 181 | A | B | Present invention |
| c101 | c16 | c11 | D | D | Comparative Example |
| c102 | c17 | c12 | E | E | Comparative Example |
| c103 | c18 | c13 | E | E | Comparative Example |
| c104 | c19 | c14 | E | E | Comparative Example |
| c105 | c20 | c15 | G | F | Comparative Example |

The following findings can be seen from the results of Table 3 and Table 4.

The inorganic solid electrolyte-containing composition containing each of the polymer binders T-1, T-4, and T-5 is inferior in dispersion stability and handleability. In the constitutional layer formed of the negative electrode composition containing each of these polymer binders, the adhesive force of the solid particles is not sufficient. Therefore, the all-solid state secondary battery having a constitutional layer produced using the composition containing each of the polymer binders T-1, T-4, and T-5 exhibits neither sufficient ion conductivity nor sufficient cycle characteristics. In addition, although the inorganic solid electrolyte-containing composition containing each of the polymer binders T-2 and T-3 which contain a random polymer reaches the pass level for dispersion stability and handleability, the adhesive force of the solid particles is not sufficient in the constitutional layer formed of the negative electrode composition containing each of these polymer binders. Therefore, the all-solid state secondary battery having a constitutional layer produced using this composition exhibits neither sufficient ion conductivity nor sufficient cycle characteristics.

On the other hand, all the inorganic solid electrolyte-containing compositions containing the polymer binder PB1 defined in the present invention have high levels of dispersion stability and handleability, and moreover, the solid particles are bound to each other with a sufficiently firm adhesive force in the constitutional layer formed of each of these compositions. Therefore, the all-solid state secondary battery having a constitutional layer produced by using each of these compositions can realize excellent cycle characteristics and a high ion conductivity.

In addition, in a case where the polymer binder PB1 and the chain polymerization polymer PB3 are used in combination, dispersion stability and handleability can be further improved while maintaining a firm adhesive force, the effect of improving the cycle characteristics is enhanced, and both the ion conductivity and the cycle characteristics can be achieved at a higher level.

The present invention has been described together with the embodiments of the present invention. However, the inventors of the present invention do not intend to limit the present invention in any part of the details of the description unless otherwise designated, and it is conceived that the present invention should be broadly construed without departing from the spirit and scope of the invention shown in the attached “WHAT IS CLAIMED IS”.

The present application claims priority based on JP2020-217232 filed on Dec. 25, 2020 in Japan, JP2021-017430 filed on Feb. 5, 2021 in Japan, and JP2021-185885 filed on Nov. 15, 2021 in Japan, the contents of which are incorporated herein as a part of the present specification by reference.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery
11: 2032-type coin case
12: laminate for all-solid state secondary battery
13: coin-type all-solid state secondary battery

What is claimed is:

1. An inorganic solid electrolyte-containing composition comprising:
an inorganic solid electrolyte having an ion conductivity of a metal belonging to Group 1 or Group 2 in the periodic table;
a polymer binder PB; and
a dispersion medium,
wherein the polymer binder PB includes a polymer P1 having a tensile permanent strain of less than 50% in a stress-strain curve obtained by repeating pulling and restoration once and includes a polymer binder PB1 having an adsorption rate of less than 60% with respect to the inorganic solid electrolyte in the dispersion medium.

2. The inorganic solid electrolyte-containing composition according to claim 1,
wherein the tensile permanent strain is 25% or less.

3. The inorganic solid electrolyte-containing composition according to claim 1,
wherein the polymer P1 has a breaking elongation of 400% or more.

4. The inorganic solid electrolyte-containing composition according to claim 1,
wherein the polymer P1 contains a constitutional component having a functional group selected from the following group (a) of functional groups,
<Group (a) of functional groups>
a hydroxy group, an amino group, a carboxy group, a sulfo group, a phosphate group, a phosphonate group, a sulfanyl group, an ether bond, an imino group, an ester bond, an amide bond, a urethane bond, a thiocarbamate bond, a urea bond, a thiourea bond, a heterocyclic group, an aryl group, a carboxylic acid anhydride group, a fluoroalkyl group, a siloxane group, a carbonate bond, and a ketone bond.

5. The inorganic solid electrolyte-containing composition according to claim 4,
wherein a content of the constitutional component in the polymer P1 is 0.1% to 20% by mass.

6. The inorganic solid electrolyte-containing composition according to claim 1,
wherein the polymer P1 is a block polymer.

7. The inorganic solid electrolyte-containing composition according to claim 1,
wherein the polymer P1 contains a constitutional component derived from a (meth)acrylic acid ester compound.

8. The inorganic solid electrolyte-containing composition according to claim 1,
wherein the polymer P1 is a block polymer having at least a segment A containing a constitutional component derived from a vinyl compound or (meth)acrylic acid ester compound having a glass transition temperature of 50° C. or higher and a segment B containing a constitutional component derived from a (meth)acrylic acid ester compound having a glass transition temperature of 15° C. or lower.

9. The inorganic solid electrolyte-containing composition according to claim 1,
wherein the polymer binder PB further includes a chain polymerization polymer binder PB3 consisting of a (meth)acrylic polymer.

10. The inorganic solid electrolyte-containing composition according to claim 1, further comprising:
an active material.

11. The inorganic solid electrolyte-containing composition according to claim 1, further comprising:
a conductive auxiliary agent.

12. The inorganic solid electrolyte-containing composition according to claim 1,
wherein the inorganic solid electrolyte is a sulfide-based inorganic solid electrolyte.

13. A sheet for an all-solid state secondary battery, comprising a layer formed of the inorganic solid electrolyte-containing composition according to claim 1.

14. An all-solid state secondary battery comprising, in the following order:
a positive electrode active material layer;
a solid electrolyte layer; and
a negative electrode active material layer,
wherein at least one layer of the positive electrode active material layer, the solid electrolyte layer, or the negative electrode active material layer is a layer formed of the inorganic solid electrolyte-containing composition according to claim 1.

15. A manufacturing method for a sheet for an all-solid state secondary battery, the manufacturing method comprising forming a film of the inorganic solid electrolyte-containing composition according to claim 1.

16. A manufacturing method for an all-solid state secondary battery, the manufacturing method comprising manufacturing an all-solid state secondary battery through the manufacturing method according to claim 15.
